(19) United States
(12) Patent Application Publication
(10) Pub. No.: US 2025/0327562 A1
(43) Pub. Date: Oct. 23, 2025

(54) CONTROL DEVICE FOR ILLUMINATION DEVICE

(71) Applicant: Japan Display Inc., Tokyo (JP)

(72) Inventor: Hitoshi SAITO, Tokyo (JP)

(21) Appl. No.: 19/258,390

(22) Filed: Jul. 2, 2025

Related U.S. Application Data
(63) Continuation of application No. PCT/JP2023/040909, filed on Nov. 14, 2023.

(30) Foreign Application Priority Data
Jan. 5, 2023 (JP) 2023-000611

(51) Int. Cl. F21V 14/00

(52) U.S. Cl. CPC F21V 14/003

(57) ABSTRACT

According to an aspect, a control device for an illumination device is configured to control illumination devices and includes: a touch sensor having a detection region; and a display panel provided with a display region and configured to display an adjustment screen. The adjustment screen has an adjustment region for adjusting a diffusion degree of each illumination device. When a difference between a target diffusion degree defined by a touch detection position in the adjustment region and a current diffusion degree of the illumination device is equal to or larger than a first adjustment interval, the diffusion degree of the illumination device is adjusted in steps of the first adjustment interval. When the difference between the target diffusion degree and the current diffusion degree is smaller than the first adjustment interval, the diffusion degree is adjusted in steps of a second adjustment interval smaller than the first adjustment interval.

### CROSS-REFERENCE TO RELATED APPLICATION

This application claims the benefit of priority from Japanese Patent Application No. 2023-000611 filed on Jan. 5, 2023 and International Patent Application No. PCT/JP2023/040909 filed on Nov. 14, 2023, the entire contents of which are incorporated herein by reference.

### BACKGROUND

### 1. Technical Field

What is disclosed herein relates to a control device for an illumination device.

### 2. Description of the Related Art

In a conventional illumination instrument, a light source such as an LED is combined with a thin lens provided with a prism pattern, and the distance between the light source and the thin lens is changed to change a light distribution angle. For example, an illumination instrument is disclosed (refer to Japanese Patent Application Laid-open Publication No. H02-065001, for example) in which the front of a transparent light bulb is covered by a liquid crystal light adjustment element and the transmittance of a liquid crystal layer is changed to switch between directly-reaching light and scattering light.

For example, in an illumination device including a liquid crystal cell for p wave polarization and a liquid crystal cell for s wave polarization, the diffusion degree of light in two directions can be controlled by driving the respective liquid crystal cells. In such an illumination device capable of controlling the diffusion degree of light in two directions, fine adjustment may be difficult due to fluctuations in a touch detection position, for example, with a conventional adjustment method by detecting a touch position on the screen of a smartphone, a tablet, or the like and adjusting the diffusion degree. Thus, a control device capable of easier fine adjustment of the diffusion degree is desired.

For the foregoing reasons, there is a need for a control device for an illumination device capable of easy fine adjustment of the diffusion degree.

### SUMMARY

According to an aspect, a control device for an illumination device is configured to control a plurality of illumination devices each capable of setting a light distribution shape of light emitted onto a virtual plane in two directions of a first direction and a second direction intersecting the first direction, by adjusting a diffusion degree of light emitted from a light source. The control device includes: a touch sensor having a detection region provided with a plurality of detection elements; and a display panel provided with a display region that overlaps the detection region of the touch sensor in a plan view and configured to display, in the display region, an adjustment screen for a diffusion degree of each of the illumination devices. The adjustment screen is provided with an adjustment region for adjusting the diffusion degree of the illumination device. When a difference between a target diffusion degree defined by a touch detection position in the adjustment region and a current diffusion degree of the illumination device is equal to or larger than a first adjustment interval, the diffusion degree of the illumination device is adjusted in steps of the first adjustment interval. When the difference between the target diffusion degree and the current diffusion degree of the illumination device is smaller than the first adjustment interval, the diffusion degree of the illumination device is adjusted in steps of a second adjustment interval smaller than the first adjustment interval.

### BRIEF DESCRIPTION OF THE DRAWINGS

FIG. 1A is a side view illustrating an example of an illumination device according to an embodiment;

FIG. 1B is a perspective view illustrating an example of an optical element according to the embodiment;

FIG. 2 is a schematic plan view of a first substrate when viewed in a Dz direction;

FIG. 3 is a schematic plan view of a second substrate when viewed in the Dz direction;

FIG. 4 is a see-through diagram of a liquid crystal cell in which the first substrate and the second substrate are stacked in the Dz direction;

FIG. 5 is a cross-sectional view along line A-A′ illustrated in FIG. 4;

FIG. 6A is a diagram illustrating the alignment direction of an alignment film of the first substrate;

FIG. 6B is a diagram illustrating the alignment direction of an alignment film of the second substrate;

FIG. 7 is a multilayered structure diagram of the optical element according to the embodiment;

FIG. 8A is a conceptual diagram for description of change in shape of light by the optical element according to the embodiment;

FIG. 8B is a conceptual diagram for description of change in shape of light by the optical element according to the embodiment;

FIG. 8C is a conceptual diagram for description of change in shape of light by the optical element according to the embodiment;

FIG. 8D is a conceptual diagram for description of change in shape of light by the optical element according to the embodiment;

FIG. 9 is a conceptual diagram for conceptually describing control of the light diffusion degree of the illumination device according to the embodiment;

FIG. 10 is a schematic view illustrating an example of the configuration of an illumination system according to the embodiment;

FIG. 11 is an exterior diagram illustrating an example of a control device according to the embodiment;

FIG. 12 is a conceptual diagram illustrating an example of a touch detection region of a touch sensor;

FIG. 13 is a diagram illustrating an example of a control block configuration of the control device according to a first embodiment;

FIG. 14 is a diagram illustrating an example of a control block configuration of the illumination device according to the first embodiment;

FIG. 15 is a conceptual diagram illustrating an example of the display aspect of an illumination control application screen on the control device according to the first embodiment;

FIG. 16 is a diagram for description of the relation between a position on the illumination control application screen on the control device according to the first embodiment and the light diffusion degree;

FIG. 17 is a conceptual diagram illustrating an example of a first storage region of a storage circuit in a control device for an illumination device according to the first embodiment;

FIG. 18 is a conceptual diagram illustrating an example of a second storage region of the storage circuit in the control device for an illumination device according to the first embodiment;

FIG. 19 is a flowchart illustrating an example of initial setting processing by the control device for an illumination device according to the first embodiment;

FIG. 20 is a flowchart illustrating an example of the overall flow of illumination control processing by the control device for an illumination device according to the first embodiment;

FIG. 21 is a flowchart illustrating an example of horizontal diffusion degree adjustment processing by the control device for an illumination device according to the first embodiment;

FIG. 22 is a flowchart illustrating an example of horizontal diffusion degree coarse adjustment processing by the control device for an illumination device according to the first embodiment;

FIG. 23 is a flowchart illustrating an example of horizontal diffusion degree fine adjustment processing by the control device for an illumination device according to the first embodiment;

FIG. 24 is a flowchart illustrating an example of vertical diffusion degree adjustment processing by the control device for an illumination device according to the first embodiment;

FIG. 25 is a flowchart illustrating an example of vertical diffusion degree coarse adjustment processing by the control device for an illumination device according to the first embodiment;

FIG. 26 is a flowchart illustrating an example of vertical diffusion degree fine adjustment processing by the control device for an illumination device according to the first embodiment;

FIG. 27A is a diagram illustrating a specific operation example on the illumination control application screen on the control device according to the first embodiment;

FIG. 27B is a diagram illustrating a specific operation example on the illumination control application screen on the control device according to the first embodiment;

FIG. 27C is a diagram illustrating a specific operation example on the illumination control application screen on the control device according to the first embodiment;

FIG. 27D is a diagram illustrating a specific operation example on the illumination control application screen on the control device according to the first embodiment;

FIG. 27E is a diagram illustrating a specific operation example on the illumination control application screen on the control device according to the first embodiment;

FIG. 27F is a diagram illustrating a specific operation example on the illumination control application screen on the control device according to the first embodiment;

FIG. 27G is a diagram illustrating a specific operation example on the illumination control application screen on the control device according to the first embodiment;

FIG. 27H is a diagram illustrating a specific operation example on the illumination control application screen on the control device according to the first embodiment;

FIG. 28 is a diagram illustrating an example of a control block configuration of a control device according to a second embodiment;

FIG. 29 is a diagram illustrating an example of a control block configuration of an illumination device according to the second embodiment;

FIG. 30 is a conceptual diagram illustrating an example of the display aspect of an illumination control application screen on the control device according to the second embodiment;

FIG. 31 is a conceptual diagram illustrating an example of a first storage region of a storage circuit in a control device for an illumination device according to the second embodiment;

FIG. 32 is a conceptual diagram illustrating an example of a second storage region of the storage circuit in the control device for an illumination device according to the second embodiment;

FIG. 33 is a flowchart illustrating an example of initial setting processing by the control device for an illumination device according to the second embodiment;

FIG. 34 is a flowchart illustrating an example of the overall flow of illumination control processing by the control device for an illumination device according to the second embodiment;

FIG. 35 is a flowchart illustrating an example of diffusion degree adjustment processing by the control device for an illumination device according to the second embodiment;

FIG. 36 is a flowchart illustrating an example of diffusion degree coarse adjustment processing by the control device for an illumination device according to the second embodiment;

FIG. 37 is a flowchart illustrating an example of diffusion degree fine adjustment processing by the control device for an illumination device according to the second embodiment;

FIG. 38A is a diagram illustrating a specific operation example on the illumination control application screen on the control device according to the second embodiment;

FIG. 38B is a diagram illustrating a specific operation example on the illumination control application screen on the control device according to the second embodiment;

FIG. 38C is a diagram illustrating a specific operation example on the illumination control application screen on the control device according to the second embodiment;

FIG. 38D is a diagram illustrating a specific operation example on the illumination control application screen on the control device according to the second embodiment;

FIG. 38E is a diagram illustrating a specific operation example on the illumination control application screen on the control device according to the second embodiment;

FIG. 38F is a diagram illustrating a specific operation example on the illumination control application screen on the control device according to the second embodiment;

FIG. 38G is a diagram illustrating a specific operation example on the illumination control application screen on the control device according to the second embodiment; and

FIG. 38H is a diagram illustrating a specific operation example on the illumination control application screen on the control device according to the second embodiment.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate. What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure In the present specification and drawings, any element same as that already described with reference to an already described drawing is denoted by the same reference sign, and detailed description thereof is omitted as appropriate in some cases.

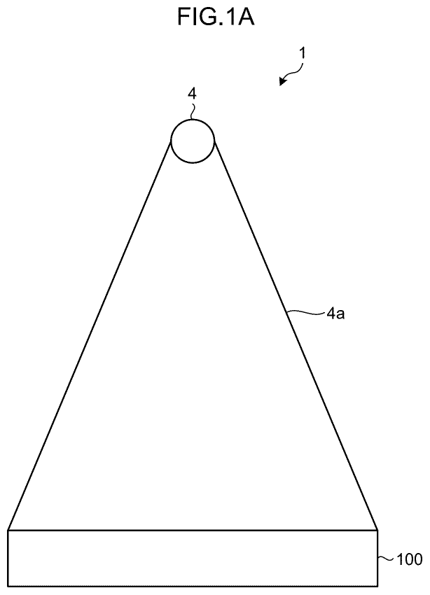

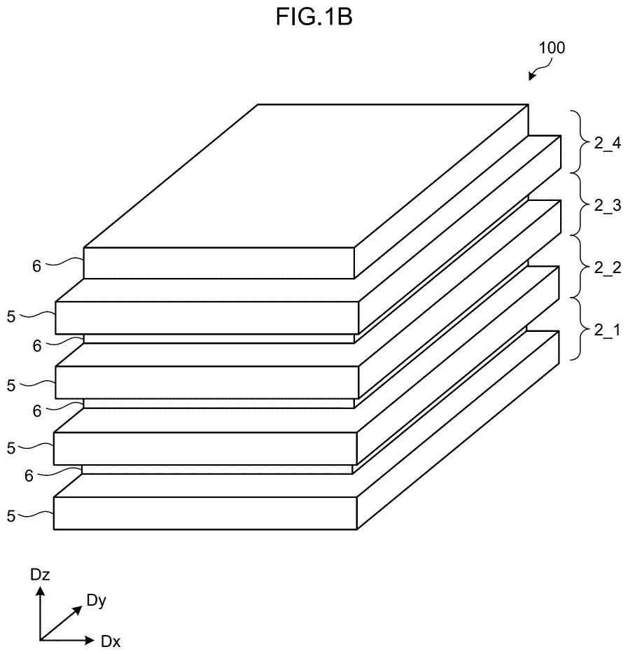

FIG. 1A is a side view illustrating an example of an illumination device 1 according to an embodiment. FIG. 1B is a perspective view illustrating an example of an optical element 100 according to the embodiment. As illustrated in FIG. 1A, the illumination device 1 includes a light source 4, a reflector 4a, and the optical element 100. As illustrated in FIG. 1B, the optical element 100 includes a first liquid crystal cell 2_1, a second liquid crystal cell 2_2, a third liquid crystal cell 2_3, and a fourth liquid crystal cell 2_4. The light source 4 is configured with, for example, a light emitting diode (LED). The reflector 4a is a component that condenses light from the light source 4 to the optical element 100.

In FIG. 1B, a Dz direction indicates the emission direction of light from the light source 4 and the reflector 4a. The optical element 100 has a configuration in which the first liquid crystal cell 2_1, the second liquid crystal cell 2_2, the third liquid crystal cell 2_3, and the fourth liquid crystal cell 2_4 are stacked in the Dz direction. In the present disclosure, the optical element 100 has a configuration in which the first liquid crystal cell 2_1, the second liquid crystal cell 2_2, the third liquid crystal cell 2_3, and the fourth liquid crystal cell 2_4 are sequentially stacked from the light source 4 side (lower side in FIG. 1B). In FIG. 1B, one direction in a plane orthogonal to the Dz direction and parallel to stacking surfaces of the first liquid crystal cell 2_1, the second liquid crystal cell 2_2, the third liquid crystal cell 2_3, and the fourth liquid crystal cell 2_4 is defined as a Dx direction (first direction), and a direction orthogonal to both the Dx direction and the Dz direction is defined as a Dy direction (second direction).

The first liquid crystal cell 2_1, the second liquid crystal cell 2_2, the third liquid crystal cell 2_3, and the fourth liquid crystal cell 2_4 have the same configuration. In the present disclosure, the first liquid crystal cell 2_1 and the fourth liquid crystal cell 2_4 are liquid crystal cells for p-wave polarization. The second liquid crystal cell 2_2 and the third liquid crystal cell 2_3 are liquid crystal cells for s-wave polarization. Hereinafter, the first liquid crystal cell 2_1, the second liquid crystal cell 2_2, the third liquid crystal cell 2_3, and the fourth liquid crystal cell 2_4 are also collectively referred to as “liquid crystal cells 2”.

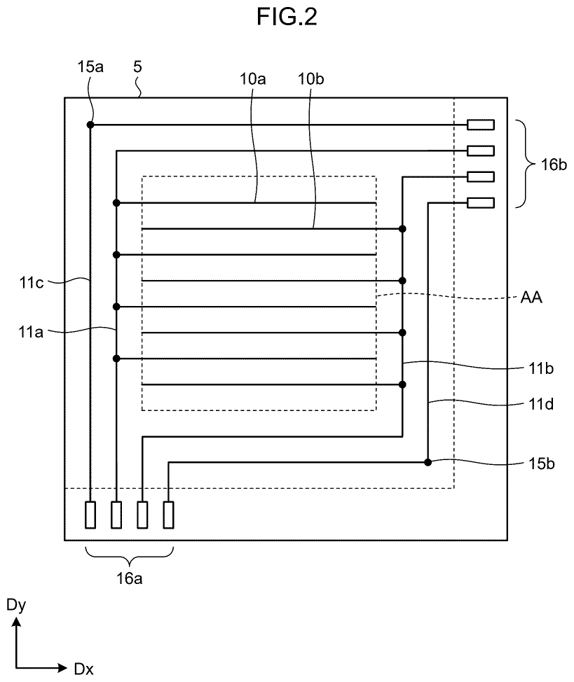

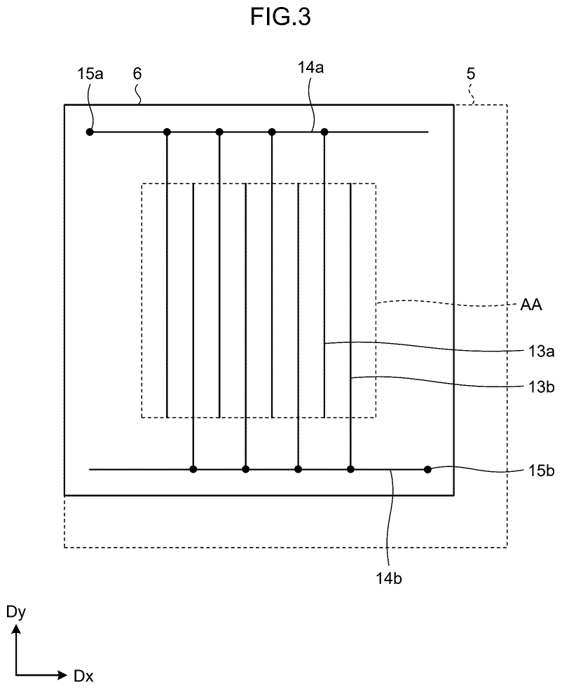

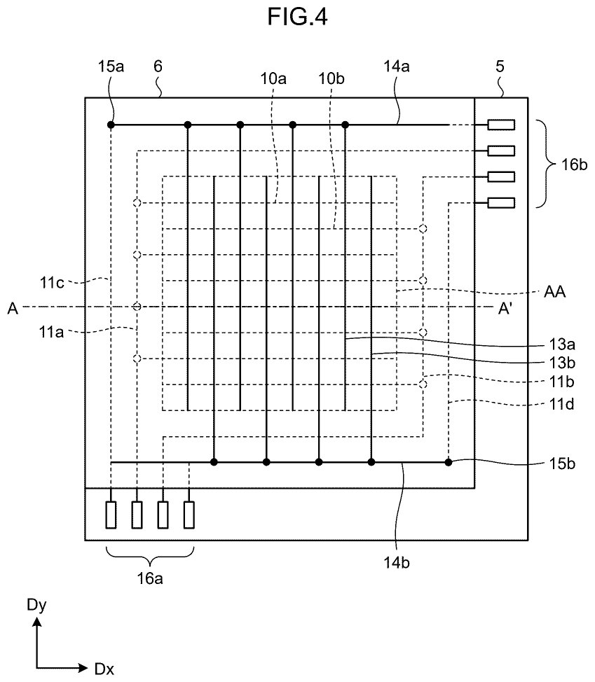

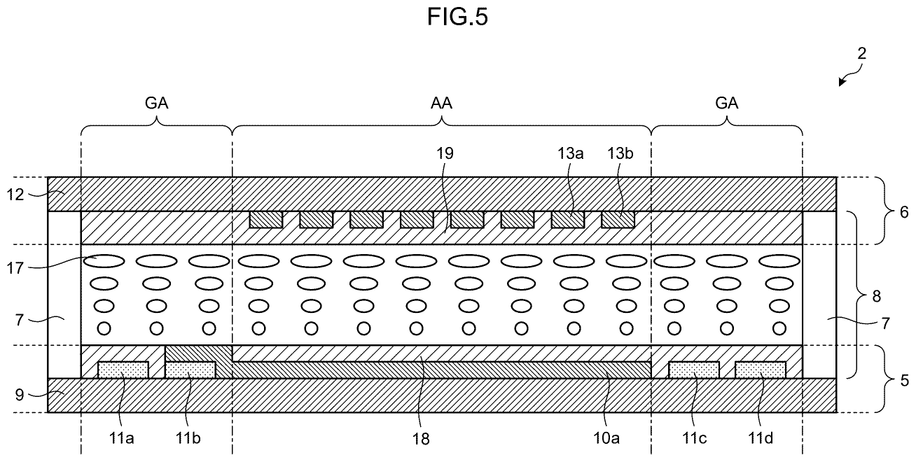

Each liquid crystal cell 2 includes a first substrate 5 and a second substrate 6. FIG. 2 is a schematic plan view of the first substrate 5 when viewed in the Dz direction. FIG. 3 is a schematic plan view of the second substrate 6 when viewed in the Dz direction. In FIG. 3, drive electrodes are visible through the substrates, but for clarity, the drive electrodes and wiring lines are illustrated with solid lines. FIG. 4 is a see-through view of a liquid crystal cell in which the first substrate 5 and the second substrate 6 are stacked in the Dz direction. In FIG. 4 as well, for clarity, the drive electrodes and wiring lines on the second substrate side are illustrated with solid lines, and the drive electrodes and wiring lines on the first substrate side are illustrated with dotted lines. FIG. 5 is a sectional view along line A-A′ illustrated in FIG. 4. FIGS. 2, 3, 4, and 5 exemplarily illustrate the third liquid crystal cell 2_3 and the fourth liquid crystal cell 2_4 in which drive electrodes 10a and 10b of the first substrate 5 extend in the Dx direction and drive electrodes 13a and 13b of the second substrate 6 extend in the Dy direction.

As illustrated in FIG. 5, the liquid crystal cell 2 includes a liquid crystal layer 8 sealed around its periphery by a sealing member 7 between the first substrate 5 and the second substrate 6.

The liquid crystal layer 8 modulates light passing through the liquid crystal layer 8 in accordance with the state of electric field. As liquid crystal molecules, positive-type nematic liquid crystals are used, but other liquid crystals with the same effects may be used.

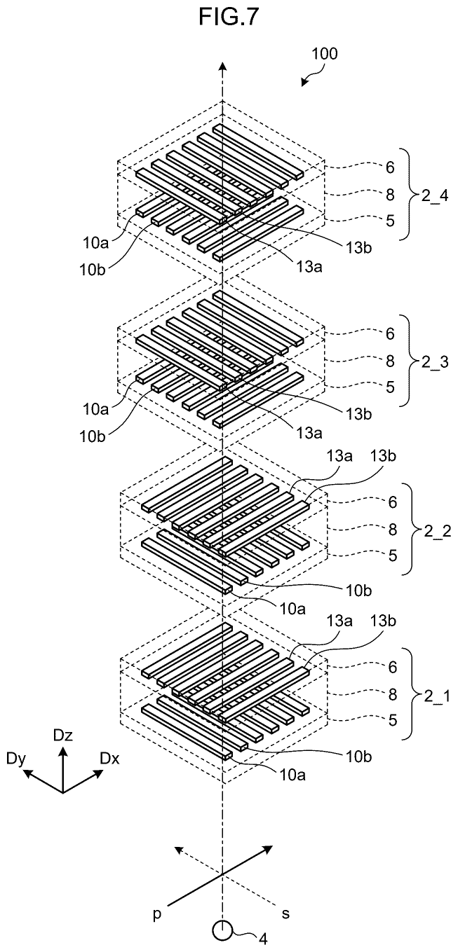

As illustrated in FIG. 2, the drive electrodes 10a and 10b, metal lines 11a and 11b, and metal lines 11c and 11d are provided on the liquid crystal layer 8 side of a base member 9 of the first substrate 5. The metal lines 11a and 11b supply drive voltage that is applied to the drive electrodes 10a and 10b, and the metal lines 11c and 11d supply drive voltage that is applied to the drive electrodes 13a and 13b (refer to FIG. 3) provided on the second substrate 6 to be described later. The metal lines 11a, 11b, 11c, and 11d are provided in a wiring layer of the first substrate 5. The metal lines 11a, 11b, 11c, and 11d are provided to be spaced apart in the wiring layer on the first substrate 5. Hereinafter, the drive electrodes 10a and 10b are simply referred to as “drive electrodes 10” in some cases. The metal lines 11a, 11b, 11c, and 11d are referred to as “first metal lines 11” in some cases. As illustrated in FIGS. 2 and 7, in the third liquid crystal cell 2_3 and the fourth liquid crystal cell 2_4, the drive electrodes 10 on the first substrate 5 extend in the Dx direction. In the first liquid crystal cell 2_1 and the second liquid crystal cell 2_2, the drive electrodes 10 on the first substrate 5 extend in the Dy direction.

As illustrated in FIG. 3, the drive electrodes 13a and 13b, and a plurality of metal lines 14a and 14b that supply drive voltage applied to the drive electrodes 13 are provided on the liquid crystal layer 8 side of a base member 12 of the second substrate 6 illustrated in FIG. 5. The metal lines 14a and 14b are provided in a wiring layer of the second substrate 6. The metal lines 14a and 14b are provided to be spaced apart in the wiring layer on the second substrate 6. Hereinafter, the drive electrodes 13a and 13b are simply referred to as “drive electrodes 13” in some cases. The metal lines 14a and 14b are referred to as “second metal lines 14” in some cases. As illustrated in FIGS. 3 and 7, in the third liquid crystal cell 2_3 and the fourth liquid crystal cell 2_4, the drive electrodes 13 on the second substrate 6 extend in the Dy direction. In the first liquid crystal cell 2_1 and the second liquid crystal cell 2_2, the drive electrodes 13 on the second substrate 6 extend in the Dx direction.

The drive electrodes 10 and the drive electrodes 13 are light-transmitting electrodes formed of a light-transmitting conductive material (light-transmitting conductive oxide) such as indium tin oxide (ITO). The first substrate 5 and the second substrate 6 are light-transmitting substrates such as glass or resin. The first metal lines 11 and the second metal lines 14 are formed of at least one metallic material selected from aluminum (Al), copper (Cu), silver (Ag), molybdenum (Mo), and alloys thereof. The first metal lines 11 and the second metal lines 14 may be stacked bodies of a plurality of layers using one or more of these metallic materials. At least one metallic material selected from aluminum (Al), copper (Cu), silver (Ag), molybdenum (Mo), and alloys thereof has lower resistance than light-transmitting conductive oxide such as ITO.

The metal line 11c of the first substrate 5 and the metal line 14a of the second substrate 6 are coupled by a conduction part 15a made of, for example, conductive paste. The metal line 11d of the first substrate 5 and the metal line 14b of the second substrate 6 are coupled by a conduction part 15b made of, for example, conductive paste.

Coupling (flex-on-board) terminal parts 16a and 16b that are coupled to non-illustrated flexible printed circuits (FPC) are provided in regions on the first substrate 5, which do not overlap the second substrate 6 when viewed in the Dz direction. The coupling terminal parts 16a and 16b each include four coupling terminals corresponding to the metal lines 11a, 11b, 11c, and 11d, respectively.

The coupling terminal parts 16a and 16b are provided in the wiring layer of the first substrate 5. Drive voltage to be applied to the drive electrodes 10a and 10b on the first substrate 5 and the drive electrodes 13a and 13b on the second substrate 6 is supplied to the liquid crystal cell 2 from an FPC coupled to the coupling terminal part 16a or the coupling terminal part 16b. Hereinafter, the coupling terminal parts 16a and 16b are simply referred to as “coupling terminal parts 16” in some cases.

As illustrated in FIG. 4, in the liquid crystal cell 2, the first substrate 5 and the second substrate 6 are stacked in the Dz direction (irradiation direction of light), and the drive electrodes 10 on the first substrate 5 intersect the drive electrodes 13 on the second substrate 6 when viewed in the Dz direction. In the liquid crystal cell 2 thus configured, the alignment direction of liquid crystal molecules 17 in the liquid crystal layer 8 can be controlled by supplying drive voltage to the drive electrodes 10 on the first substrate 5 and the drive electrodes 13 on the second substrate 6. A region in which the alignment direction of the liquid crystal molecules 17 in the liquid crystal layer 8 can be controlled is referred to as an “effective region AA”. The refractive index distribution of the liquid crystal layer 8 is changed in the effective region AA, whereby the diffusion degree of light transmitted through the effective region AA of the liquid crystal cell 2 can be controlled. A region outside the effective region AA, where the liquid crystal layer 8 is sealed by the sealing member 7 is referred to as a “peripheral region GA” (refer to FIG. 5).

As illustrated in FIG. 5, the drive electrodes 10 (in FIG. 5, the drive electrode 10a) in the effective region AA of the first substrate 5 are covered by an alignment film 18. The drive electrodes 13 (in FIG. 5, the drive electrodes 13a and 13b) in the effective region AA of the second substrate 6 are covered by an alignment film 19. The alignment direction of the liquid crystal molecules is different between the alignment film 18 and the alignment film 19.

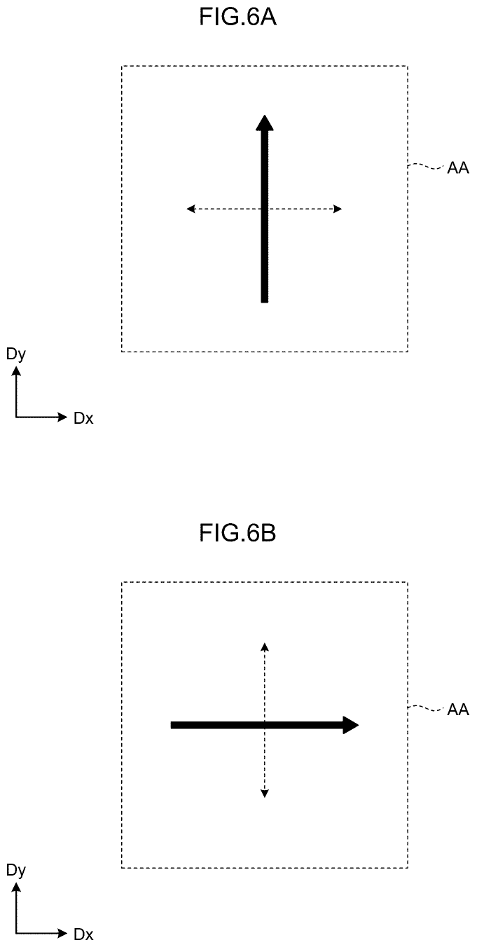

FIG. 6A is a diagram illustrating the alignment direction of the alignment film of the first substrate 5. FIG. 6B is a diagram illustrating the alignment direction of the alignment film of the second substrate 6.

As illustrated in FIGS. 6A and 6B, the alignment direction of the alignment film 18 of the first substrate 5 and the alignment direction of the alignment film 19 of the second substrate 6 are directions intersecting each other in a plan view. Specifically, as illustrated with a solid arrow in FIG. 6A, the alignment direction of the alignment film 18 of the first substrate 5 is orthogonal to the extending direction of the drive electrodes 10a and 10b, which is illustrated with a dashed arrow in FIG. 6A. As illustrated with a solid arrow in FIG. 6B, the alignment direction of the alignment film 19 of the second substrate 6 is orthogonal to the extending direction of the drive electrodes 13a and 13b, which is illustrated with a dashed arrow in FIG. 6B. In the following description, the extending directions of the drive electrodes 10 and 13 are orthogonal to the alignment directions of the alignment films 18 and 19 covering them, but these may intersect at an angle other than being orthogonal, for example, in the angle range of 85° to 90°. The drive electrodes 10 on the first substrate 5 side and the drive electrodes 13 on the second substrate 6 side are preferably orthogonal to each other but may intersect, for example, in the angle range of 85° to 90°. The alignment directions of the alignment films 18 and 19 are formed by rubbing processing or light alignment processing.

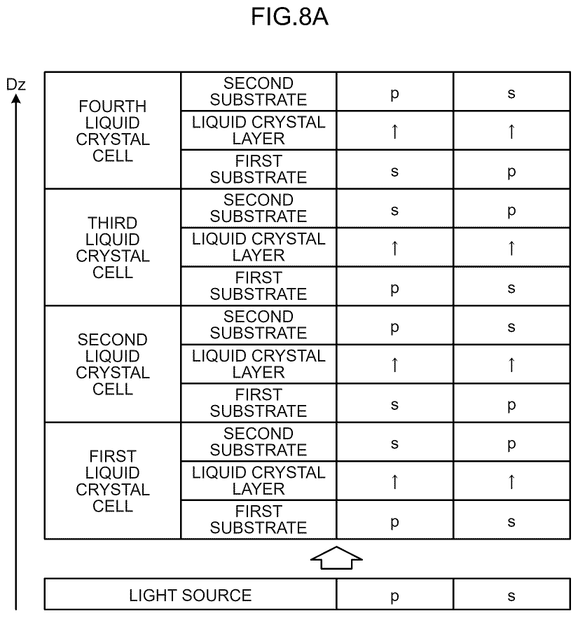

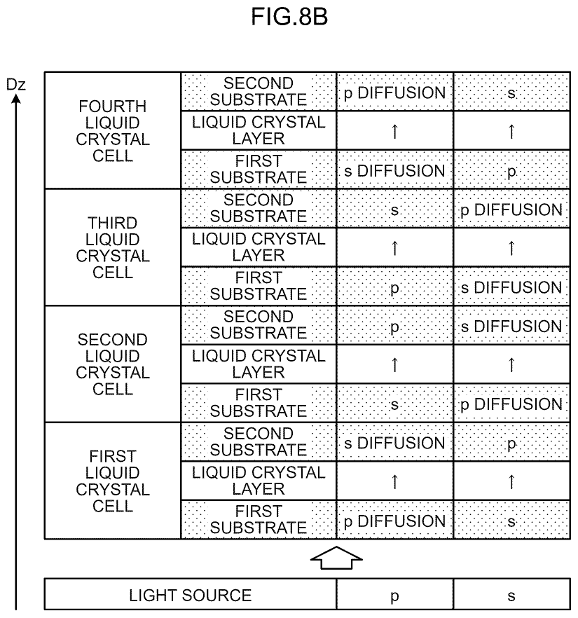

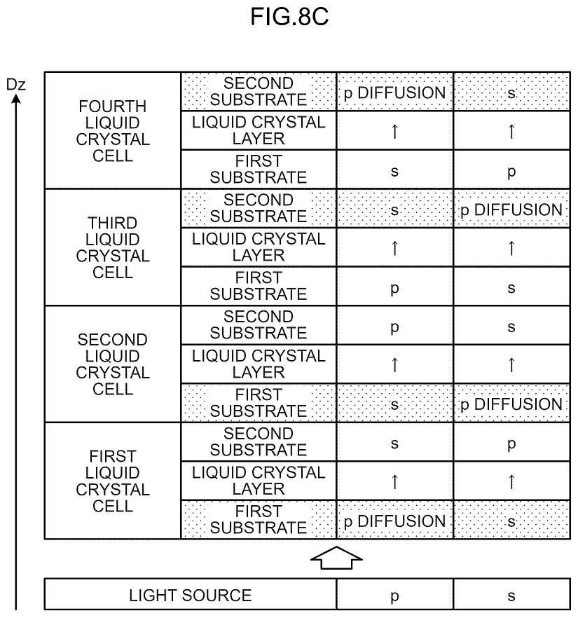

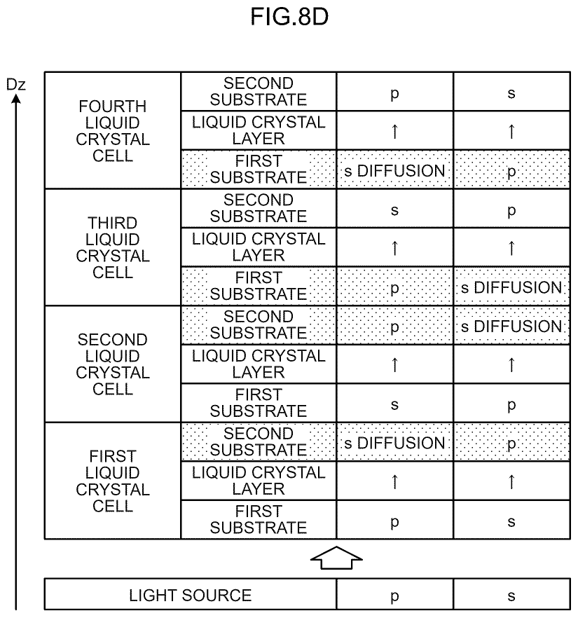

A mechanism for changing the shape of light by using the liquid crystal cells 2 (the first liquid crystal cell 2_1, the second liquid crystal cell 2_2, the third liquid crystal cell 2_3, and the fourth liquid crystal cell 2_4) will be described below. FIG. 7 is a multilayered structure diagram of the optical element 100 according to the embodiment. FIGS. 8A, 8B, 8C, and 8D are conceptual diagrams for description of change in shape of light by the optical element 100 according to the embodiment. FIGS. 8A, 8B, 8C, and 8D illustrate examples in which potential difference is generated between the drive electrodes of hatched substrates of the liquid crystal cells 2.

As illustrated in FIG. 7, the optical element 100 is provided on the optical axis of the light source 4, which is illustrated with a dashed and single-dotted line, and as described above, the first liquid crystal cell 2_1, the second liquid crystal cell 2_2, the third liquid crystal cell 2_3, and the fourth liquid crystal cell 2_4 are sequentially stacked from the light source 4 side (lower side in FIG. 7). The third liquid crystal cell 2_3 and the fourth liquid crystal cell 2_4 are stacked in a state of being rotated by 90° relative to the first liquid crystal cell 2_1 and the second liquid crystal cell 2_2.

In each liquid crystal cell 2, the alignment direction of the alignment film on the first substrate 5 side and the second substrate 6 side intersect each other as illustrated in FIGS. 6A and 6B. Accordingly, from the first substrate 5 side toward the second substrate 6 side, the orientation of the liquid crystal molecules in the liquid crystal layer 8 gradually changes from the Dx direction to the Dy direction (or from the Dy direction to the Dx direction), and the polarized light component of transmitted light rotates along with the change. Specifically, in the liquid crystal cell 2, the polarized light component, which is a p-polarized component on the first substrate 5 side, changes to an s-polarized light component as distance from the second substrate 6 decreases; and the polarized light component, which is an s-polarized light component on the first substrate 5 side, changes to a p-polarized component as distance from the second substrate 6 decreases. This rotation of the polarized light component may be referred to as optical rotation.

FIG. 8A illustrates a state in which no potential is generated between adjacent electrodes in each liquid crystal cell 2. In this case, only optical rotation occurs in each liquid crystal cell 2 and no polarized light component is diffused.

As illustrated in FIG. 8B, for example, when potential difference is generated between the drive electrodes 10a and 10b on the first substrate 5 in the first liquid crystal cell 2_1 to induce a horizontal electric field, the liquid crystal molecules between the electrodes are aligned in a circular arc shape, and thus, refractive index distribution is formed in the Dx direction in the liquid crystal layer 8. As light from the light source 4 is transmitted in this state, the above-described refractive index distribution acts on the polarized light component (in FIG. 8B, p-polarized component) parallel to the Dx direction, and therefore, the p-polarized component diffuses in the Dx direction.

In addition, when potential difference is generated between the drive electrodes 13a and 13b on the second substrate 6 side in the first liquid crystal cell 2_1, refractive index distribution is formed in the Dy direction on the second substrate 6 side, and accordingly, the s-polarized light component diffuses in the Dy direction on the second substrate 6 side. Specifically, the polarized light component having changed from a p-polarized component to an s-polarized light component during passing through the liquid crystal layer 8 in the first liquid crystal cell 2_1 diffuses in the Dy direction as well. However, the s-polarized light component at incidence on the first liquid crystal cell 2_1 optically rotates during passing through the liquid crystal layer 8 but intersects each refractive index distribution, and accordingly, only optically rotates without diffusing and passes through the first liquid crystal cell 2_1.

The s-polarized light component at incidence on the first liquid crystal cell 2_1 changes to a p-polarized component after passing through the first liquid crystal cell 2_1, and the second liquid crystal cell 2_2 acts on this p-polarized component. Specifically, as illustrated in FIGS. 8A and 8B, the first liquid crystal cell 2_1 acts on the p-polarized component of light incident on the optical element 100, and the second liquid crystal cell 2_2 acts on the s-polarized light component thereof. Since the third liquid crystal cell 2_3 and the fourth liquid crystal cell 2_4 are provided with rotation by 90° relative to the first liquid crystal cell 2_1 and the second liquid crystal cell 2_2, polarized light components on which they act are switched by 90°. Specifically, the third liquid crystal cell 2_3 acts on the s-polarized light component at incidence on the optical element 100, and the fourth liquid crystal cell 2_4 acts on the p-polarized component at incidence on the optical element 100.

As illustrated in FIG. 8C, in the optical element, it is possible to act on the p-polarized component by providing potential difference between drive electrodes extending in the Dy direction in each liquid crystal cell 2 (between the drive electrodes 10a and 10b of the first substrate 5 in the first liquid crystal cell 2_1 and the second liquid crystal cell 2_2 and between the drive electrodes 13a and 13b of the second substrate 6 in the third liquid crystal cell 2_3 and the fourth liquid crystal cell 2_4), thereby increasing the shape of light mainly in the Dx direction. This effect may be referred to as horizontal diffusion.

As illustrated in FIG. 8D, it is possible to act on the s-polarized light component by providing potential difference between drive electrodes extending in the Dx direction in each liquid crystal cell 2 (between the drive electrodes 13a and 13b of the second substrate 6 in the first liquid crystal cell 2_1 and the second liquid crystal cell 2_2 and between the drive electrodes 10a and 10b of the first substrate 5 in the third liquid crystal cell 2_3 and the fourth liquid crystal cell 2_4), thereby increasing the shape of light mainly in the Dy direction. This effect may be referred to as vertical diffusion.

The diffusion degree of light in each direction depends on the potential difference between the drive electrodes 10a and 10b (or between the drive electrodes 13a and 13b) adjacent to each other. The spread of light in the direction is maximum (100(%)) in a case where the potential difference between the drive electrodes 10a and 10b (or between the drive electrodes 13a and 13b) is maximum potential difference (for example, 30 (V)) defined in advance, and no spread of light (0(%)) occurs in the direction in a case where no potential difference is generated. Alternatively, the spread of light in the direction is 50(%) in a case where the potential difference between the drive electrodes 10a and 10b (or between the drive electrodes 13a and 13b) is 50(%) (for example, 15 (V)) of the above-described maximum potential difference. In a case where the relation between voltage difference and light spread is not linear, it is possible to set another potential difference instead of 15 (V).

In each liquid crystal cell 2, the interval (also referred to as a cell gap) between its substrates (between the first substrate 5 and the second substrate 6) is large and is 10 μm to 50 μm approximately, more preferably 15 μm to 35 μm approximately, and thus, influence of an electric field formed in one of the substrates on the other substrate side is reduced as much as possible. Drive voltage that generates potential difference between the drive electrodes 10a and 10b (or between the drive electrodes 13a and 13b) adjacent to each other is what is called an alternating-current square wave, thereby preventing burn-in of the liquid crystal molecules.

The alignment directions of the alignment films, the extending directions of the drive electrodes on the substrates, and the angle between them may be modified as appropriate for the entire optical element 100 or each liquid crystal cell 2 in accordance with the characteristics of liquid crystals to be employed and optical characteristics to be intentionally obtained.

In the present embodiment, description is made on the configuration of the optical element 100 in which the four liquid crystal cells of the first liquid crystal cell 2_1, the second liquid crystal cell 2_2, the third liquid crystal cell 2_3, and the fourth liquid crystal cell 2_4 are stacked, but the optical element 100 is not limited to this configuration and may employ, for example, a configuration in which two or three liquid crystal cells 2 are stacked or a configuration in which a plurality of liquid crystal cells 2, five or more liquid crystal cells 2, are stacked.

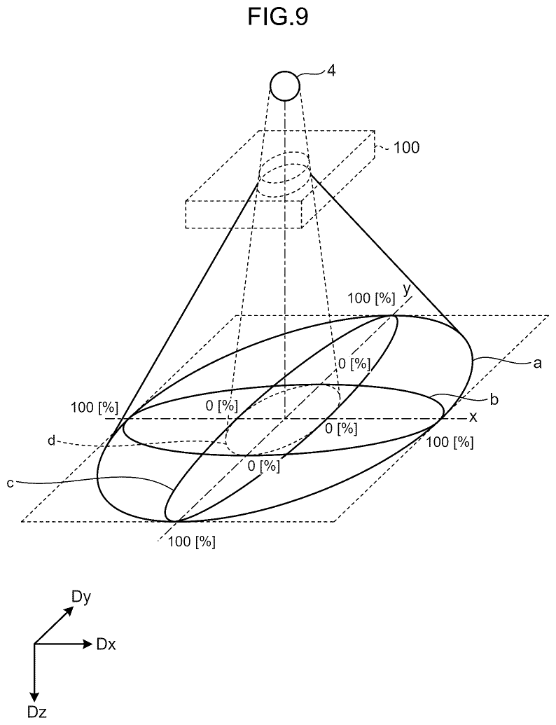

In the present disclosure, in the illumination device 1 with the above-described configuration, light incident on the optical element from the light source 4 is controlled in the two directions of the Dx direction (direction of horizontal diffusion) and the Dy direction (direction of vertical diffusion) by controlling drive voltage of each liquid crystal cell 2. The above-described vertical diffusion and horizontal diffusion may be collectively referred to as light diffusion. Accordingly, the shape of light emitted from the optical element is changed. The shape of light is a light shape that appears on a plane parallel to an emission surface of the optical element, and this may be referred to as a light distribution shape. The following describes control of the light diffusion degree in the present disclosure with reference to FIG. 9.

FIG. 9 is a conceptual diagram for conceptually describing control of the light diffusion degree of the illumination device 1 according to the embodiment. FIG. 9 illustrates an irradiation area of light on a virtual plane xy orthogonal to the Dz direction. The outline of the actual irradiation area is slightly unclear depending on the distance from the light source 4, a light diffraction phenomenon, and the like.

As described above, the drive voltage is supplied to the drive electrodes 10 and 13 of each liquid crystal cell 2 of the optical element 100 provided on the optical axis of the light source 4, whereby the alignment direction of the liquid crystal molecules 17 in the liquid crystal layer 8 is controlled. With this control, the light distribution shape of light emitted from the optical element 100 is controlled.

Specifically, for example, the light distribution shape in the Dx direction changes in accordance with the drive voltage applied to the drive electrodes 10 or drive electrodes 13 extending in the Dy direction in each liquid crystal cell 2 as described above (horizontal diffusion). The light distribution shape in the Dy direction changes in accordance with the drive voltage applied to the drive electrodes 10 or drive electrodes 13 extending in the Dx direction in the first to fourth liquid crystal cells (vertical diffusion).

In the present disclosure, the minimum diffusion degrees of the horizontal diffusion and the vertical diffusion are 0(%) and the maximum diffusion degrees thereof are 100(%). More specifically, in a case where the horizontal diffusion degree is 0(%), drive electrodes (for example, the drive electrodes 10 extending in the Dy direction on the first substrate 5 in the first liquid crystal cell 2_1) functioning to expand the light distribution state in the Dx direction do not act on the refractive index distribution of the liquid crystal layer 8. In this case, no potential difference is present between the adjacent drive electrodes 10a and 10b or no potential is supplied to the electrodes. On the other hand, in a case where the horizontal diffusion degree is 100(%), drive electrodes (for example, the drive electrodes 10 extending in the Dy direction on the first substrate 5 in the first liquid crystal cell 2_1) functioning to expand the light distribution state in the Dx direction maximumly act on the refractive index distribution of the liquid crystal layer 8. In this case, the potential difference between the adjacent drive electrodes 10a and 10b is set to the maximum potential difference (for example, 30 (V)) in the optical element 100. In a case where the horizontal diffusion degree is larger than 0(%) and smaller than 100(%), potential adjusted such that the potential difference between the adjacent drive electrodes 10a and 10b is larger than 0 (V) and smaller than the maximum potential difference (for example, 30 (V)) is applied to the electrodes. The same applies to the vertical diffusion.

Outline “a” illustrated in FIG. 9 exemplarily indicates the irradiation area on the virtual plane xy in a case where the horizontal diffusion degree and the vertical diffusion degree are both 100(%). Outline “b” illustrated in FIG. 9 exemplarily indicates the irradiation area on the virtual plane xy in a case where the horizontal diffusion degree is 100(%) and the vertical diffusion degree is 0(%). Outline “c” illustrated in FIG. 9 exemplarily indicates the irradiation area in a case where the horizontal diffusion degree is 0(%) and the vertical diffusion degree is 100(%). Outline “d” illustrated in FIG. 9 exemplarily indicates the irradiation area on the virtual plane xy in a case where the horizontal diffusion degree and the vertical diffusion degree are both 0(%). In other words, outline “d” indicates the light distribution state when light from the light source 4 is emitted without being controlled by the optical element 100 (or simply transmitted through the optical element 100).

In this manner, in the illumination device 1 with the above-described configuration, it is possible to control the horizontal and vertical diffusion degrees of emission light from the optical element 100 by performing drive voltage control of each liquid crystal cell 2. Accordingly, it is possible to change, on the virtual plane xy, the light distribution shape of emission light from the illumination device 1. Hereinafter, control that changes the light distribution shape of light applied onto the virtual plane xy by adjusting the horizontal and vertical diffusion degrees of emission light from the illumination device 1 is also referred to as “light distribution control”.

In the present disclosure, the illumination device 1 capable of light distribution control in the two directions of the Dx and Dy directions is exemplarily described, but the controllable parameters of the illumination device 1 are not limited to light distribution (light spread). For example, the illumination device 1 may be capable of light adjustment control. In this case, the controllable parameters of the illumination device 1 may include light adjustment (brightness).

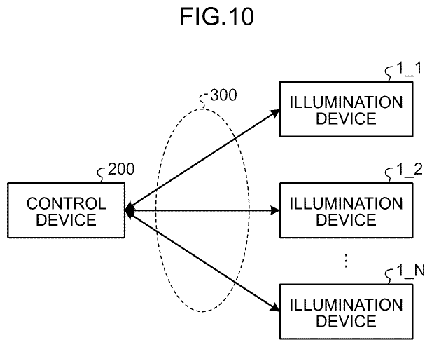

FIG. 10 is a schematic view illustrating an example of the configuration of an illumination system according to the embodiment. The illumination system according to the embodiment includes a plurality of illumination devices 1_1, 1_2, . . . , and 1_N and a control device 200. The control device 200 is, for example, a portable communication terminal device such as a smartphone or a tablet. The illumination devices 1_1, 1_2, . . . , and 1_N are each registered in the control device 200 in advance as a control target device having a light diffusion degree controllable by the control device 200.

Data and various command signals are transmitted bidirectionally between the control device 200 and each of the illumination devices 1_1, 1_2, . . . , and 1_N through a communication means 300. In the present disclosure, the communication means 300 is a wireless communication means of, for example, Bluetooth (registered trademark) or WiFi (registered trademark). Wireless communication may be performed between the control device 200 and each of the illumination devices 1_1, 1_2, . . . , and 1_N through, for example, a predetermined network such as a mobile communication network. Alternatively, each of the illumination devices 1_1, 1_2, . . . , and 1_N and the control device 200 may be coupled in a wired manner to perform wired communication therebetween.

As illustrated in FIG. 10, N (N is a natural number equal to or larger than one) illumination devices 1_n (n is a natural number of 1 to N) are control target devices of the control device 200 in the present disclosure, but the present disclosure is not limited by the number of control target devices (illumination devices 1_n) of the control device 200. Furthermore, in the present disclosure, an aspect in which the light diffusion degree of each illumination device 1_n is controlled as a setting parameter of a control target device (illumination device 1_n) will be described below, but the setting parameter is not limited to the light diffusion degree. Examples of setting parameters of a control target device (illumination device 1_n) may include the light quantity and color temperature of the illumination device 1_n.

In the present disclosure, it is sufficient that at least one illumination device 1 is registered as a control target device. Hereinafter, for sake of simplicity, processing between the control device 200 and one illumination device 1 will be described.

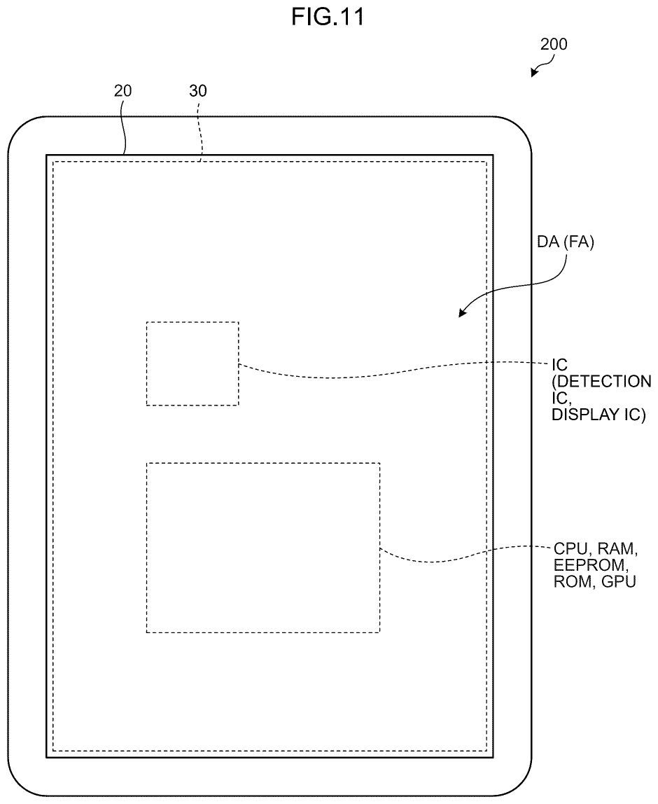

FIG. 11 is an exterior diagram illustrating an example of the control device 200 according to the embodiment. The control device 200 is a display device (touch screen) with a touch detection function in which a display panel 20 and a touch sensor 30 are integrated. The control device 200 includes, as internal constituent components, for example, various ICs such as a detection IC and a display IC, and a central processing unit (CPU), a random access memory (RAN), an electrically erasable programmable read only memory (EEPROM), a read only memory (ROM), and a graphics processing unit (GPU) of a smartphone, a tablet, or the like constituting the control device 200.

The display panel 20 is what is called an in-cell or hybrid device in which the touch sensor 30 is built and integrated. Building and integrating the touch sensor 30 in the display panel 20 includes, for example, sharing some members such as substrates and electrodes used as the display panel 20 and some members such as substrates and electrodes used as the touch sensor 30. The display panel 20 may be what is called an on-cell type device in which the touch sensor 30 is mounted on a display device.

The display panel 20 is, for example, a liquid crystal display panel including a liquid crystal display element. The display panel 20 is not limited thereto but may be, for example, an organic EL display panel (organic light emitting diode (OLED)) or an inorganic EL display panel (micro LED or mini LED).

The touch sensor 30 is, for example, a capacitive touch sensor. The touch sensor 30 is not limited thereto but may be, for example, a touch sensor of a resistance film scheme or a touch sensor of an ultrasonic wave scheme or an optical scheme.

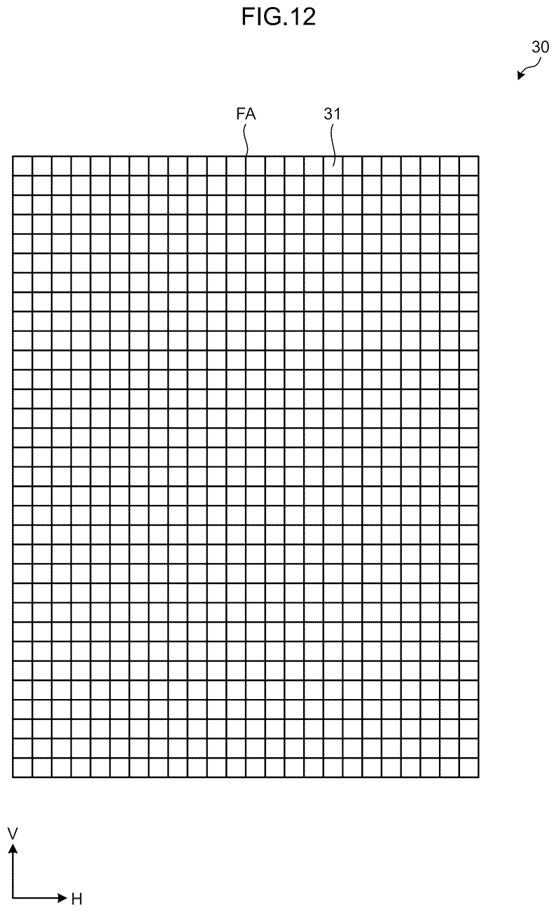

FIG. 12 is a conceptual diagram illustrating an example of a touch detection region of the touch sensor 30. A plurality of detection elements 31 are provided in a detection region FA of the touch sensor 30. The detection elements 31 in the detection region FA of the touch sensor 30 are arranged in an X direction and a Y direction orthogonal to the X direction and provided in a matrix of a row-column configuration. In other words, the touch sensor 30 has the detection region FA overlapping the detection elements 31 arranged in the X direction and the Y direction.

### First Embodiment

Configurations and operation for controlling the light diffusion degree of the illumination device 1 in the control device 200 of an illumination system according to a first embodiment will be described below.

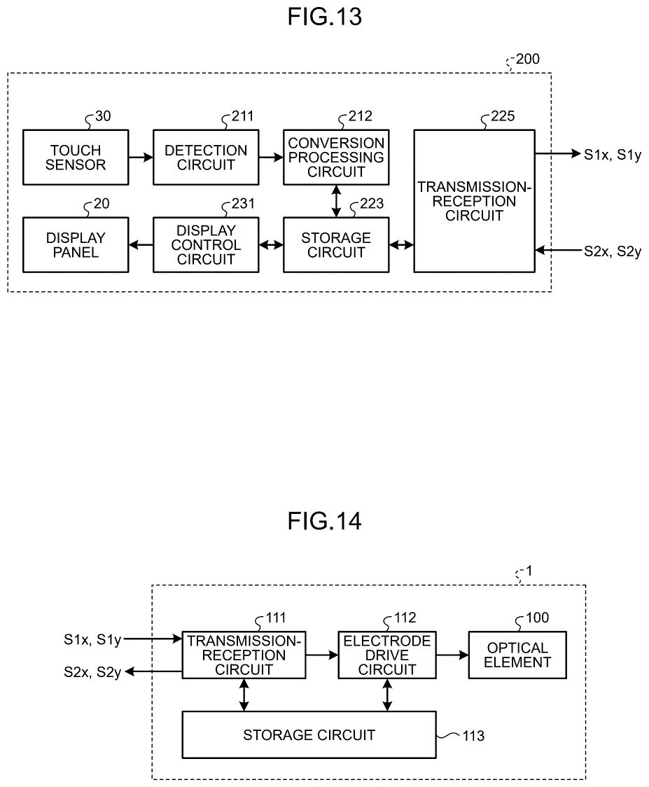

FIG. 13 is a diagram illustrating an example of a control block configuration of the control device 200 according to the first embodiment. The following describes, first, a control block configuration for executing each processing to be described later.

As illustrated in FIG. 13, the control device 200 according to the first embodiment includes the display panel 20, the touch sensor 30, a detection circuit 211, a conversion processing circuit 212, a storage circuit (first storage circuit) 223, a transmission-reception circuit 225, and a display control circuit 231. The detection circuit 211 is configured with, for example, a detection IC. Alternatively, the detection circuit 211 and the display control circuit 231 may be mounted as one display IC on the display panel 20 or on an FPC coupled to the display panel 20. The conversion processing circuit 212 and the storage circuit 223 are each configured with, for example, the CPU, RAM, EEPROM, and ROM of a smartphone, a tablet, or the like constituting the control device 200. The display control circuit 231 may be a display IC mounted on the display panel 20 as described above, and moreover, may include, for example, the GPU of a smartphone, a tablet, or the like constituting the control device 200. The transmission-reception circuit 225 is configured with, for example, a wireless communication module of a smartphone, a tablet, or the like constituting the control device 200.

The detection circuit 211 is a circuit that detects existence of a touch on the touch sensor 30 based on a detection signal output from each detection element 31 of the touch sensor 30.

The conversion processing circuit 212 is a circuit that executes conversion processing of the position of touch detection by the detection circuit 211 into various setting values (in the present disclosure, light diffusion degrees) of the illumination device 1. In the present disclosure, the conversion processing circuit 212 has a function to execute conversion processing of the position of touch detection by the detection circuit 211, that is, a touched object (pictorial image) into operation states on various screens. The conversion processing circuit 212 is a component achieved by, for example, the CPU of a smartphone, a tablet, or the like constituting the control device 200.

The storage circuit 223 is configured with, for example, the RAM, EEPROM, and ROM of a smartphone, a tablet, or the like constituting the control device 200. In the present disclosure, various parameter values and various setting values that are necessary for operation of an illumination control application according to the first embodiment to be described later, are stored in a storage region of the storage circuit 223. The various parameter values and various setting values that are necessary for operation of the illumination control application according to the first embodiment will be described later.

The transmission-reception circuit 225 transmits and receives setting information to and from the illumination device 1. Specifically, the transmission-reception circuit 225 transmits a Dx-direction light diffusion degree S1x and a Dy-direction light diffusion degree Sly to the illumination device 1 as first setting information in each processing to be described later. The transmission-reception circuit 225 receives second light diffusion degree information (a Dx-direction light diffusion degree S2x and a Dy-direction light diffusion degree S2y) transmitted from the illumination device 1.

The display control circuit 231 executes display control processing for displaying a coarse adjustment mode screen or a fine adjustment mode screen to be described later on the display panel 20. The display control circuit 231 in the present disclosure performs display control of the display panel 20 based on various kinds of setting information stored in a storage region of the storage circuit 223 and position information of pictorial images.

FIG. 14 is a diagram illustrating an example of a control block configuration of the illumination device 1 according to the first embodiment. As illustrated in FIG. 14, the illumination device 1 according to the first embodiment includes a transmission-reception circuit 111, an electrode drive circuit 112, and a storage circuit (second storage circuit) 113 as control blocks for controlling the optical element 100 described above. The storage circuit 113 is configured with, for example, a RAM, an EEPROM, or a ROM.

The transmission-reception circuit 111 transmits and receives the light diffusion degree information to and from the control device 200. Specifically, the transmission-reception circuit 111 receives the first light diffusion degree information (the Dx-direction light diffusion degree S1x and the Dy-direction light diffusion degree Sly) transmitted from the control device 200. The transmission-reception circuit 111 transmits, to the control device 200, the Dx-direction light diffusion degree S2x and the Dy-direction light diffusion degree S2y stored in the storage circuit 113 as the second light diffusion degree information.

In the present disclosure, upon activation of the illumination device 1, the transmission-reception circuit 111 transmits the Dx-direction light diffusion degree S2x and the Dy-direction light diffusion degree S2y stored in the storage circuit 113 to the control device 200 as the second light diffusion degree information and stores, in the storage circuit 113 as the new Dx-direction light diffusion degree S2x and the new Dy-direction light diffusion degree S2y, the first light diffusion degree information (the Dx-direction light diffusion degree S1x and the Dy-direction light diffusion degree Sly) transmitted from the control device 200 by each processing of the control device 200 to be described later. In other words, when the first light diffusion degree information is transmitted from the control device 200 to the illumination device 1, the second light diffusion degree information is updated to the first light diffusion degree information. The illumination device 1 initially does not store the second light diffusion degree information (0(%) for the vertical diffusion and the horizontal diffusion). In this case, the first light diffusion degree information is transmitted from the control device 200, whereby the second light diffusion degree information is stored.

The electrode drive circuit 112 supplies drive voltage in accordance with the Dx-direction light diffusion degree S2x and the Dy-direction light diffusion degree S2y stored in the storage circuit 113 to the drive electrodes 10 and 13 of each liquid crystal cell 2 of the optical element 100.

Specifically, upon activation of the illumination device 1, the electrode drive circuit 112 supplies drive voltage corresponding to the second setting information stored in the storage circuit 113 to the drive electrodes 10 and 13 of each liquid crystal cell 2 of the optical element 100.

The electrode drive circuit 112 also supplies, to the drive electrodes 10 and 13 of each liquid crystal cell 2 of the optical element 100, drive voltage corresponding to the second setting information updated based on the first setting information transmitted from the control device 200.

Processing of the illumination system in the present disclosure is executed by application software (hereinafter also referred to as “illumination control application”) operating on the control device 200. The following describes specific examples of processing and display aspects of the illumination control application that operates on the control device 200 according to the first embodiment in detail.

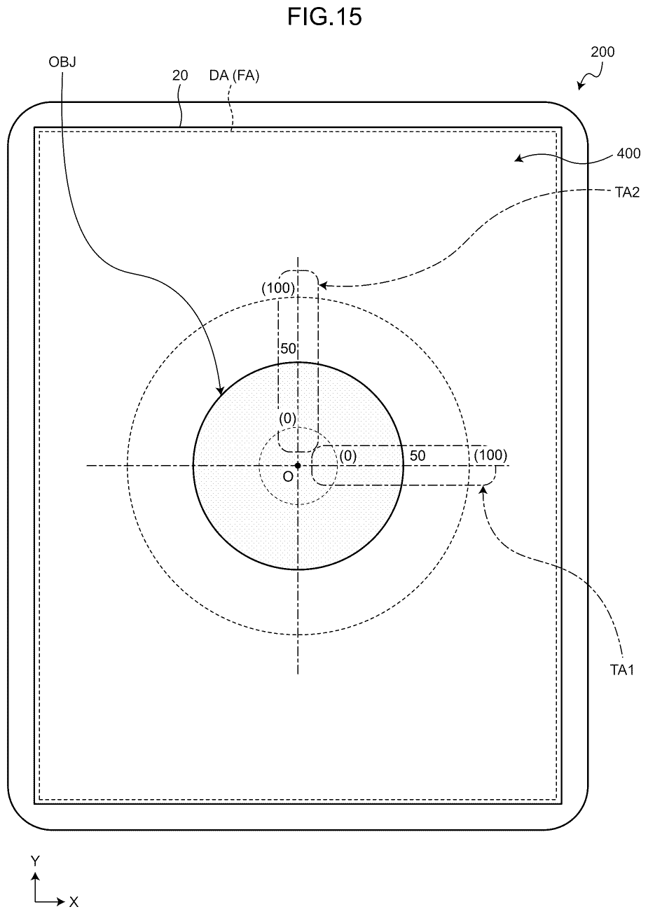

FIG. 15 is a conceptual diagram illustrating an example of the display aspect of an illumination control application screen 400 on the control device 200 according to the first embodiment.

In description of the present disclosure, it is assumed that the illumination control application is installed on the control device 200 in advance.

When the illumination control application is activated, the illumination control application screen 400 (adjustment screen) illustrated in FIG. 15 is displayed and pairing processing is executed between the control device 200 and the illumination device 1 registered as a control target device of the control device 200 in advance. A pairing button (not illustrated) may be displayed on the illumination control application screen 400, and pairing processing may be executed between the control device 200 and the illumination device 1 when the pairing button is touched by a user. At initial activation of the illumination control application, for example, the illumination device 1 activated in a space where pairing is possible may be registered as a control target device.

On the illumination control application screen 400 illustrated in FIG. 15, the X direction is defined as the Dx direction (first direction) in light diffusion degree control of the illumination device 1, and the Y direction is defined as the Dy direction (second direction) in light diffusion degree control of the illumination device 1. An XY plane with an origin O(0, 0) at a predetermined position in a display region DA is defined on the illumination control application screen 400.

The display panel 20 is provided with the display region DA overlapping the detection region FA of the touch sensor 30 in a plan view. In the example illustrated in FIG. 15, a light distribution shape object OBJ having a center point at the origin O(0, 0) of the XY plane on the illumination control application screen 400 is displayed.

The light distribution shape object OBJ is a pictorial image on the illumination control application screen 400, corresponding to the light distribution state of light emitted from the illumination device 1.

In the configuration according to the first embodiment, the shape of the light distribution shape object OBJ on the illumination control application screen 400 changes into a circular or elliptical shape in accordance with the horizontal and vertical diffusion degrees.

As illustrated in FIG. 9, in the illumination device 1 as a control target in the present disclosure, a predetermined substantially circular area corresponding to outline “d” is irradiated with light even in a case where the horizontal and vertical diffusion degrees of the illumination device 1 are both 0(%). In the present disclosure, the light distribution shape object OBJ in a small circular shape overlapping the inner dashed line illustrated in FIG. 15 is displayed in a case where the horizontal and vertical diffusion degrees are both 0(%).

The light distribution shape object OBJ in a large circular shape overlapping the outer dashed line illustrated in FIG. 15, which corresponds to outline “a” in FIG. 9, is displayed in a case where the horizontal and vertical diffusion degrees of the illumination device 1 are both 100(%).

In the first embodiment, as illustrated in FIG. 15, a first adjustment region TA1 is provided as a region in which the touch detection position in the X direction for setting the horizontal diffusion degree can be acquired.

The first adjustment region TA1 is set as a region where the light distribution shape in the X direction is adjustable in the entire range of a minimum value (0(%)) to a maximum value (100(%)).

Touch position detection in the X direction is enabled in the first adjustment region TA1 between the position on the outline of the light distribution shape object OBJ in a case where the horizontal diffusion degree is 0(%) and the position on the outline of the light distribution shape object OBJ in a case where the horizontal diffusion degree is 100(%). In the first embodiment, adjustment of the horizontal diffusion degree is enabled by detecting the touch position in the X direction in the first adjustment region TA1.

In the present disclosure, as illustrated in FIG. 15, a second adjustment region TA2 is provided as a region in which the touch detection position in the Y direction for setting the vertical diffusion degree can be acquired. The second adjustment region TA2 is set as a region where the light distribution shape in the Y direction is adjustable in the entire range of a minimum value (0(%)) to a maximum value (100(%)).

Touch position detection in the Y direction is enabled in the second adjustment region TA2 between the position on the outline of the light distribution shape object OBJ in a case where the vertical diffusion degree is 0(%) and the position on the outline of the light distribution shape object OBJ in a case where the vertical diffusion degree is 100(%). In the first embodiment, adjustment of the vertical diffusion degree is enabled by detecting the touch position in the Y direction in the second adjustment region TA2.

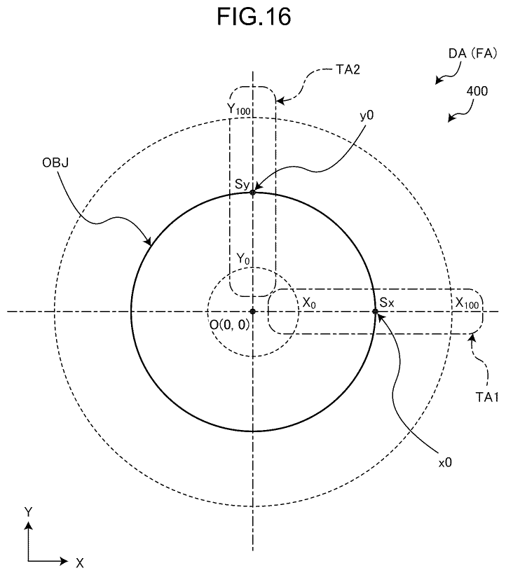

FIG. 16 is a diagram for description of the relation between the position on the illumination control application on the control device 200 according to the first embodiment and the light diffusion degree. In the present disclosure, to facilitate description, the position (coordinate) in the display region DA of the display panel 20 and the position (coordinate) on the detection region FA of the touch sensor 30 are assumed to be equivalent.

On the illumination control application screen 400 of the control device 200 according to the first embodiment, the horizontal diffusion degree of the illumination device 1 can be set based on a position x0 of an intersection point of the X axis of the XY plane and the outline of the light distribution shape object OBJ.

In the first embodiment, the position x0 on the display region DA in the first adjustment region TA1 coincides with the position of the intersection point of the X axis and the outline of the light distribution shape object OBJ and corresponds to the horizontal diffusion degree of the illumination device 1. A pointer (pictorial image such as a slider) indicating the X-direction position of the light distribution shape object OBJ having a center point at the position x0 on the display region DA may be displayed at the position of the intersection point of the X axis and the outline of the light distribution shape object OBJ in the first adjustment region TA1. In FIG. 16, “Sx” displayed near the position x0 on the display region DA indicates the horizontal diffusion degree of the illumination device 1 (for example, “50”(%)). The X-direction shape of the light distribution shape object OBJ changes with movement of the position x0 in the display region DA in the first adjustment region TA1. The relation between the position x0 on the display region DA in the first adjustment region TA1 and the horizontal diffusion degree Sx can be expressed as described below.

A reference movement amount Px in the X direction on the XY plane in a case where the amount of one step change in the horizontal diffusion degree of the illumination device 1 is 1(%) is expressed by Expression (1) below, where X₁₀₀ represents the intersection point of the X axis and the outline of the light distribution shape object OBJ in a case where the horizontal diffusion degree Sx is 100(%), and X₀ represents the intersection point of the X axis and the outline of the light distribution shape object OBJ in a case where the horizontal diffusion degree Sx is 0(%).

$$Px = ( {X}_{100} - {X}_{0} ) / 100 \qquad ( 1 )$$

The relation between the horizontal diffusion degree Sx and the position x0 in the display region DA on the XY plane is expressed by Expressions (2) and (3) below by using Expression (1) described above.

$$Sx = ( x 0 - {X}_{0} ) / Px \qquad ( 2 )$$

$$x 0 = Sx \times Px + {X}_{0} \qquad ( 3 )$$

On the illumination control application screen 400 of the control device 200 according to the first embodiment, the vertical diffusion degree of the illumination device 1 can be set based on a position y0 of the intersection point of the Y axis of the XY plane and the outline of the light distribution shape object OBJ.

In the present disclosure, the position y0 in the display region DA in the second adjustment region TA2 coincides with the position of the intersection point of the Y axis and the outline of the light distribution shape object OBJ and corresponds to the vertical diffusion degree of the illumination device 1. A pointer (pictorial image such as a slider) indicating the Y-direction position of the light distribution shape object OBJ having a center point at the position y0 on the display region DA may be displayed at the position of the intersection point of the Y axis and the outline of the light distribution shape object OBJ in the second adjustment region TA2. In FIG. 16, “Sy” displayed near the position y0 on the display region DA indicates the vertical diffusion degree of the illumination device 1 (for example, “50”(%)). The shape of the light distribution shape object OBJ in the Y direction changes with movement of the position y0 in the display region DA in the second adjustment region TA2. The relation between the position y0 on the display region DA in the second adjustment region TA2 and the vertical diffusion degree Sy can be expressed as described below.

A reference movement amount Py in the Y direction on the XY plane in a case where the amount of one step change in the vertical diffusion degree of the illumination device 1 is 1(%) is expressed by Expression (4) below, where Y₁₀₀ represents the intersection point of the Y axis and the outline of the light distribution shape object OBJ in a case where the vertical diffusion degree Sy is 100(%), and Yo represents the intersection point of the Y axis and the outline of the light distribution shape object OBJ in a case where the vertical diffusion degree Sy is 0(%).

$$Py = ( {Y}_{100} - {Y}_{0} ) / 100 \qquad ( 4 )$$

The relation between the vertical diffusion degree Sy and the position y0 in the display region DA on the XY plane is expressed by Expressions (5) and (6) below by using Expression (4) described above.

$$Sy = ( y 0 - {Y}_{0} ) / Py \qquad ( 5 )$$

$$y 0 = Sy \times Py + {Y}_{0} \qquad ( 6 )$$

In the first embodiment, when having detected continuation of a touch in the first adjustment region TA1 or the second adjustment region TA2 on the illumination control application screen 400 described above, the control device 200 transitions to diffusion degree adjustment processing. Hereinafter, continuation of a touch in the first adjustment region TA1 or the second adjustment region TA2 is also referred to as a “long tap state”.

In the first embodiment, the “long tap state” means a state in which a continuation time T1 of a touch in the first adjustment region TA1 or the second adjustment region TA2 has exceeded a predetermined long tap detection time (first time threshold) T1th (for example, 2 (sec)).

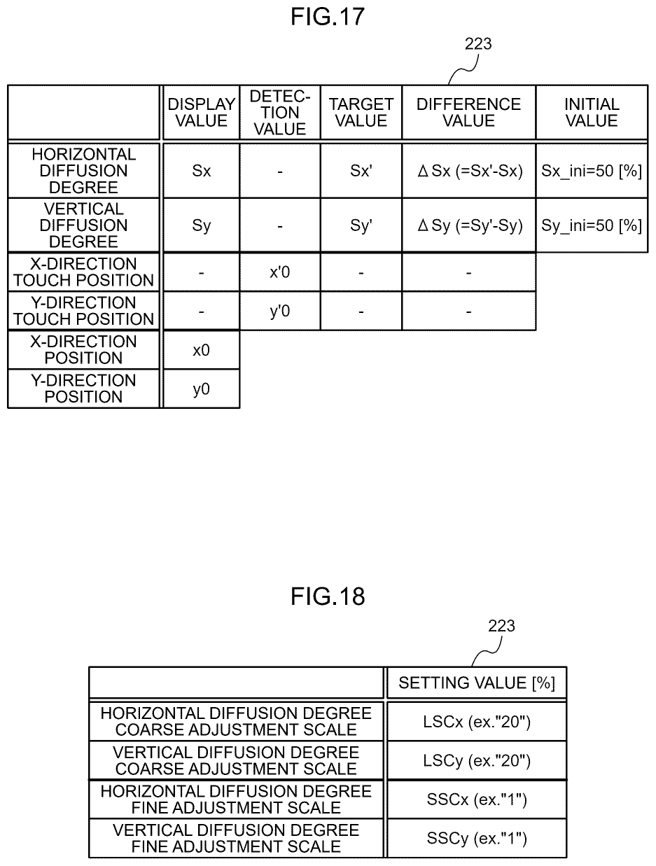

FIG. 17 is a conceptual diagram illustrating an example of a first storage region of the storage circuit 223 in the control device 200 for the illumination device 1 according to the first embodiment. FIG. 18 is a conceptual diagram illustrating an example of a second storage region of the storage circuit 223 in the control device 200 for the illumination device 1 according to the first embodiment. The first storage region stores various parameter values (variables) that are necessary for operation of the illumination control application. The second storage region of the storage circuit 223 stores various setting values of the illumination control application.

In the first embodiment, as illustrated in FIG. 17, the first storage region of the storage circuit 223 stores a horizontal diffusion degree display value Sx, a vertical diffusion degree display value Sy, an X-direction position display value x0 of the light distribution shape object OBJ, and a Y-direction position display value y0 of the light distribution shape object OBJ on the illumination control application screen 400. The horizontal diffusion degree display value Sx indicates a current horizontal diffusion degree of the illumination device 1, which is defined by the X-direction position display value x0 of the light distribution shape object OBJ. The vertical diffusion degree display value Sy indicates a current vertical diffusion degree of the illumination device 1, which is defined by the Y-direction position display value y0 of the light distribution shape object OBJ. The first storage region also stores an X-direction touch position detection value x′0 in the first adjustment region TA1 and a Y-direction touch position detection value y′0 in the second adjustment region TA2, which are detected in illumination control processing according to the first embodiment to be described later, a target horizontal diffusion degree Sx′ calculated based on the X-direction touch position detection value x′0, a target vertical diffusion degree Sy′ calculated based on the Y-direction touch position detection value y′0, a horizontal diffusion degree difference value ΔSx that is the difference value between the target horizontal diffusion degree Sx′ and the horizontal diffusion degree display value Sx, and a vertical diffusion degree difference value ΔSy that is the difference value between the target vertical diffusion degree Sy′ and the vertical diffusion degree display value Sy. The target horizontal diffusion degree Sx′ is a value calculated from the X-direction touch position detection value x′0 in the first adjustment region TA1. In other words, the target horizontal diffusion degree Sx′ is a value defined by the X-direction touch position detection value x′0 in the first adjustment region TA1. The target vertical diffusion degree Sy′ is a value calculated from the Y-direction touch position detection value y′0 in the second adjustment region TA2. In other words, the target vertical diffusion degree Sy′ is a value defined by the Y-direction touch position detection value y′0 in the second adjustment region TA2.

The horizontal diffusion degree of the illumination device 1 is changed at different adjustment scales in accordance with the magnitude of the horizontal diffusion degree difference value ΔSx, which is calculated at intervals of a predetermined setting value change time (second time threshold) T2th (for example, 0.5 (sec)) in the illumination control processing according to the first embodiment to be described later. The vertical diffusion degree of the illumination device 1 is changed at different adjustment scales (change steps) in accordance with the magnitude of the vertical diffusion degree difference value ΔSy, which is calculated at intervals of the predetermined setting value change time (second time threshold) T2th in the illumination control processing according to the first embodiment to be described later.

In the first embodiment, as illustrated in FIG. 18, the second storage region of the storage circuit 223 stores a horizontal diffusion degree coarse adjustment scale setting value LSCx (first adjustment interval), a vertical diffusion degree coarse adjustment scale setting value LSCy (first adjustment interval), a horizontal diffusion degree fine adjustment scale setting value SSCx (second adjustment interval), and a vertical diffusion degree fine adjustment scale setting value SSCy (second adjustment interval).

The horizontal diffusion degree coarse adjustment scale setting value LSCx and the vertical diffusion degree coarse adjustment scale setting value LSCy are set to, for example, 20(%). The horizontal diffusion degree fine adjustment scale setting value SSCx and the vertical diffusion degree fine adjustment scale setting value SSCy are set to, for example, 1(%). These adjustment scales are exemplary and not limited to the above description.

For example, the horizontal diffusion degree coarse adjustment scale setting value LSCx and the vertical diffusion degree coarse adjustment scale setting value LSCy may be set to, for example, 10(%) or 30(%), and the horizontal diffusion degree fine adjustment scale setting value SSCx and the vertical diffusion degree fine adjustment scale setting value SSCy may be set to, for example, 0.5(%) or 2(%). In the first embodiment, the horizontal diffusion degree fine adjustment scale setting value SSCx (second adjustment interval) only needs to be an interval (step size) smaller than the horizontal diffusion degree coarse adjustment scale setting value LSCx (first adjustment interval), and the vertical diffusion degree fine adjustment scale setting value SSCy (second adjustment interval) only needs to be an interval (step size) smaller than the vertical diffusion degree coarse adjustment scale setting value LSCy (first adjustment interval). The horizontal diffusion degree coarse adjustment scale setting value LSCx, the vertical diffusion degree coarse adjustment scale setting value LSCy, the horizontal diffusion degree fine adjustment scale setting value SSCx, and the vertical diffusion degree fine adjustment scale setting value SSCy may be values that the user can set on the illumination control application.

The following describes specific examples of processing by the control device 200 for the illumination device 1 according to the first embodiment described above.

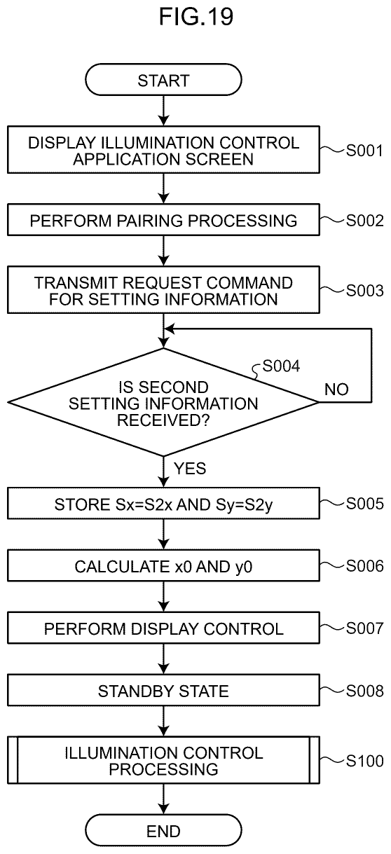

Processing during execution of the above-described illumination control application is achieved by application software executed by, for example, the CPU of a smartphone, a tablet, or the like constituting the control device 200. FIG. 19 is a flowchart illustrating an example of initial setting processing by the control device 200 for the illumination device 1 according to the first embodiment.

When the illumination control application is activated on the control device 200, the illumination control application screen 400 illustrated in FIG. 15 is displayed on the display region DA (step S001).

Before activation of the illumination control application, the illumination device 1 registered in advance in a space where pairing with the control device 200 is possible, is activated.

The transmission-reception circuit 225 of the control device 200 executes pairing processing with the illumination device 1 registered as a control target device in advance and activated in a space where pairing with the control device 200 is possible (step S002), and transmits a request command for the second setting information to the control target device (illumination device 1) (step S003).

The transmission-reception circuit 111 of the illumination device 1 reads the second setting information stored in the storage circuit 113 and transmits the second setting information to the control device 200. The electrode drive circuit 112 of the illumination device 1 supplies drive voltage corresponding to the second setting information to the drive electrodes 10 and 13 of each liquid crystal cell 2 of the optical element 100.

The transmission-reception circuit 225 of the control device 200 determines whether the second setting information is received from the illumination device 1 (step S004). If the second setting information is not received from the illumination device 1 (No at step S004), the processing at step S004 is repeatedly executed.

If the second setting information is received from the illumination device 1 (Yes at step S004), the transmission-reception circuit 225 stores, in the first storage region of the storage circuit 223 illustrated in FIG. 17, the Dx-direction light diffusion degree S2x in the second setting information of the illumination device 1 as the horizontal diffusion degree display value Sx, and the Dy-direction light diffusion degree S2y therein as the vertical diffusion degree display value Sy (step S005).

A horizontal diffusion degree initial value Sx_ini (for example, 50(%)) and a vertical diffusion degree initial value Sy_ini (for example, 50(%)) are stored in the first storage region. For example, after the initial activation of the illumination device 1 or after the illumination device 1 activated in a space where pairing is possible is registered as a control target device, the following processing may be performed in which, in place of the above-described processing at steps S003 to S005, the horizontal diffusion degree initial value Sx_ini (for example, 50(%) illustrated in FIG. 17) is set as the horizontal diffusion degree display value Sx, the vertical diffusion degree initial value Sy_ini (for example, 50(%) illustrated in FIG. 17) is set as the vertical diffusion degree display value Sy, and the horizontal diffusion degree display value Sx and the vertical diffusion degree display value Sy is transmitted as the first setting information (S1x and Sly) to the registered illumination device 1. In this case, the transmission-reception circuit 111 of the illumination device 1 stores, in the storage circuit 113, the first setting information (S1x and Sly) received from the control device 200 as the second setting information (S2x and S2y). In addition, the electrode drive circuit 112 of the illumination device 1 supplies drive voltage corresponding to the second setting information to the drive electrodes 10 and 13 of each liquid crystal cell 2 of the optical element 100.

The control device 200 calculates the X-direction position display value x0 of the light distribution shape object OBJ by using Expression (3) described above based on the horizontal diffusion degree display value Sx stored in the first storage region of the storage circuit 223, calculates the Y-direction position display value y0 of the light distribution shape object OBJ by using Expression (6) described above based on the vertical diffusion degree display value Sy stored in the first storage region (step S006), and stores the display values x0 and y0 in the first storage region.

The display control circuit 231 of the control device 200 reflects the horizontal diffusion degree display value Sx, the X-direction position display value x0 of the light distribution shape object OBJ, the vertical diffusion degree display value Sy, and the Y-direction position display value y0 of the light distribution shape object OBJ, which are acquired in the above-described processing and stored in the first storage region of the storage circuit 223, to display control on the illumination control application screen 400 (step S007).

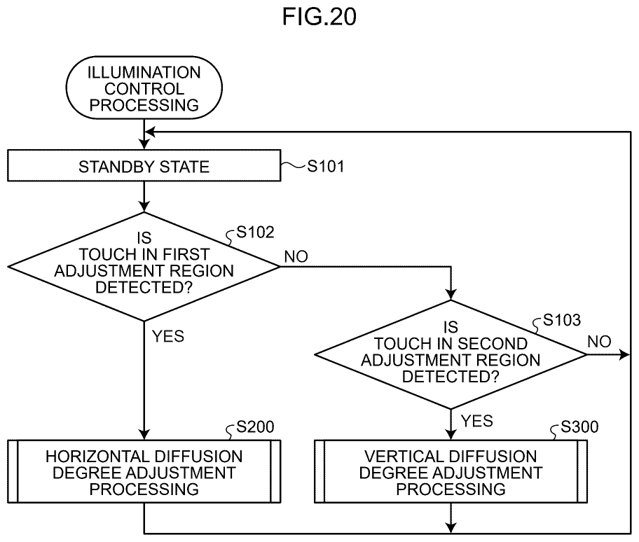

After the processing up to step S007 ends, the process transitions to a standby state (step S008), thereby transitioning to illumination control processing illustrated in FIG. 20 (step S100). FIG. 20 is a flowchart illustrating an example of the overall flow of the illumination control processing by the control device 200 for the illumination device 1 according to the first embodiment.

In the standby state illustrated in FIG. 20 (step S101), the control device 200 executes touch detection processing for the first adjustment region TA1 and the second adjustment region TA2 (steps S102 and S103).

Specifically, for example, if no touch is detected in the first adjustment region TA1 (No at step S102), the control device 200 executes touch detection in the second adjustment region TA2 (step S103). The present disclosure is not limited thereto and the control device 200 may execute touch detection in the first adjustment region TA1 when no touch is detected in the second adjustment region TA2.

If no touch is detected in either the first adjustment region TA1 or the second adjustment region TA2 (No at step S102 or No at step S103), the process returns to the standby state at step S101 to repeatedly execute the processing at steps S101 to S103. The execution interval of the processing at steps S101 to S103 is, for example, 10 (ms).

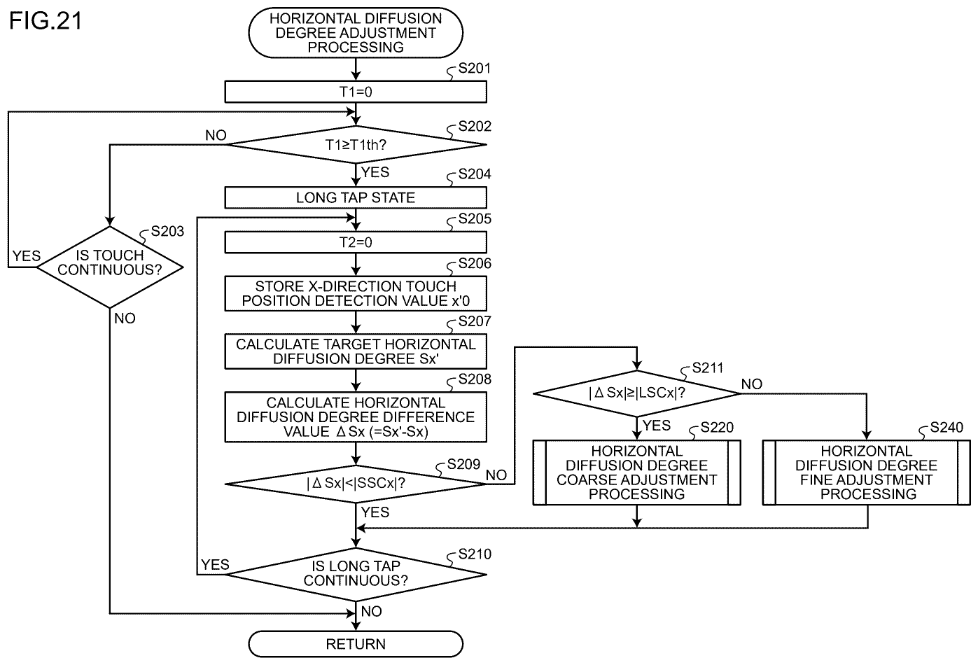

If a touch is detected in the first adjustment region TA1 (Yes at step S102), the process transitions to horizontal diffusion degree adjustment processing illustrated in FIG. 21 (step S200). FIG. 21 is a flowchart illustrating an example of the horizontal diffusion degree adjustment processing by the control device 200 for the illumination device 1 according to the first embodiment.

After having transitioned to the horizontal diffusion degree adjustment processing illustrated in FIG. 21, the control device 200 resets a count value T1 of a first timer that counts the continuation time of a touch in the first adjustment region TA1 (T1=0; step S201).

Subsequently, the control device 200 determines whether the count value T1 of the first timer has exceeded the predetermined long tap detection time (first time threshold) T1th (for example, 2 (sec)) (step S202). The long tap detection time (first time threshold) T1th is set to, for example, 200 counts (T1th=200) when 10 (ms) is defined as one count. The long tap detection time (first time threshold) T1th is not limited to 2 (sec) (=200).

If the count value T1 of the first timer is smaller than the predetermined long tap detection time T1th (T1<T1th; No at step S202), the control device 200 subsequently determines whether the touch state in the first adjustment region TA1 is continuous (step S203). If the touch state in the first adjustment region TA1 is not continuous (No at step S203), in other words, if a user's finger has been released from the screen or if the touch detection position is out of the first adjustment region TA1, the process returns to the illumination control processing illustrated in FIG. 20, thereby transitioning to a standby state without adjustment of the control state of the horizontal diffusion degree of the illumination device 1 (step S101).

If the touch state in the first adjustment region TA1 is continuous (Yes at step S203), the processing at steps S202 to S203 is repeatedly executed until the count value T1 of the first timer exceeds the predetermined long tap detection time T1th (No at step S202).

If the count value T1 of the first timer exceeds the predetermined long tap detection time T1th (Yes at step S202), the control device 200 determines that the touch state is the long tap state (step S204), resets a count value T2 of a second timer that counts the predetermined setting value change time (second time threshold) T2th (T2=0; step S205), detects the touch position in the X direction in the first adjustment region TA1, stores the touch position in the first storage region of the storage circuit 223 illustrated in FIG. 17 as the X-direction touch position detection value x′0 (step S206), calculates the target horizontal diffusion degree Sx′ corresponding to the X-direction touch position detection value x′0 (step S207), and stores the target horizontal diffusion degree Sx′ in the first storage region illustrated in FIG. 17. The X-direction touch position detection value x′0 in the first adjustment region TA1 is different from the X-direction position display value x0 of the light distribution shape object OBJ.

Then, the control device 200 reads the horizontal diffusion degree display value Sx and the target horizontal diffusion degree Sx′ from the first storage region, calculates the horizontal diffusion degree difference value ΔSx (ΔSx=Sx′−Sx; step S208), and determines whether the magnitude |ΔSx| of the horizontal diffusion degree difference value ΔSx is smaller than the magnitude |SSCx| of the horizontal diffusion degree fine adjustment scale setting value SSCx (second adjustment interval) (step S209).

If the magnitude |ΔSx| of the horizontal diffusion degree difference value ΔSx is equal to or larger than the magnitude |SSCx| of the horizontal diffusion degree fine adjustment scale setting value SSCx (No at step S209), the control device 200 subsequently determines whether the magnitude |ΔSx| of the horizontal diffusion degree difference value ΔSx is equal to or larger than the magnitude |LSCx| of the horizontal diffusion degree coarse adjustment scale setting value LSCx (step S211).

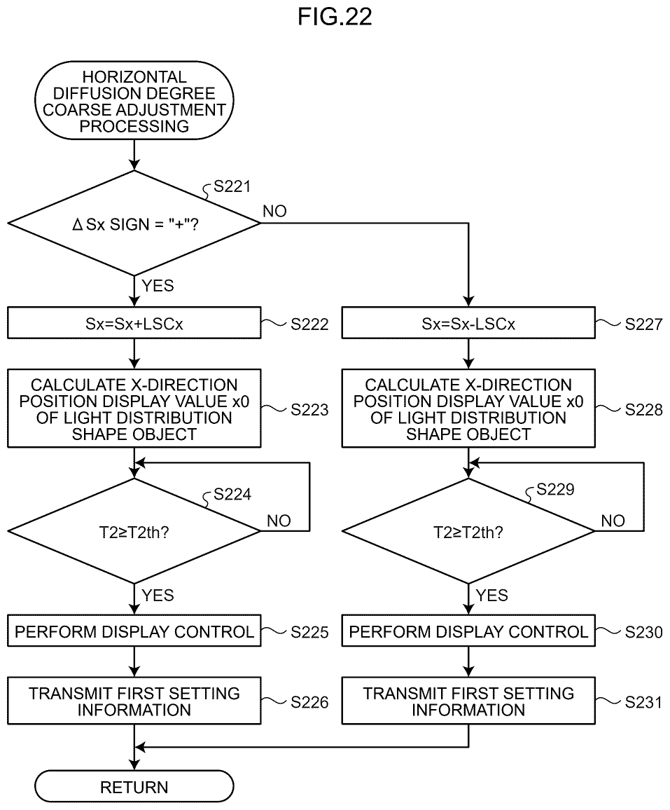

If the magnitude |ΔSx| of the horizontal diffusion degree difference value ΔSx is equal to or larger than the magnitude |LSCx| of the horizontal diffusion degree coarse adjustment scale setting value LSCx (Yes at step S211), horizontal diffusion degree coarse adjustment processing illustrated in FIG. 22 is executed. FIG. 22 is a flowchart illustrating an example of the horizontal diffusion degree coarse adjustment processing by the control device 200 for the illumination device 1 according to the first embodiment.

The control device 200 reads the sign of the horizontal diffusion degree difference value ΔSx and determines the adjustment direction of the horizontal diffusion degree display value Sx with respect to the target horizontal diffusion degree Sx′. Specifically, the control device 200 determines whether the sign of the horizontal diffusion degree difference value ΔSx is “+(positive value)” (step S221).

If the sign of the horizontal diffusion degree difference value ΔSx is “+ (positive value)” (Yes at step S221), it is indicated that the adjustment direction of the horizontal diffusion degree display value Sx with respect to the target horizontal diffusion degree Sx′ is a direction in which the horizontal diffusion degree of the illumination device 1 increases. In this case, the control device 200 adds the horizontal diffusion degree coarse adjustment scale setting value LSCx (first adjustment interval) to the horizontal diffusion degree display value Sx (step S222), thereby updating the horizontal diffusion degree display value Sx. In addition, the control device 200 calculates the X-direction position display value x0 of the light distribution shape object OBJ, which corresponds to the horizontal diffusion degree display value Sx (step S223), and stores the X-direction position display value x0 in the first storage region of the storage circuit 223 illustrated in FIG. 17.

Subsequently, the control device 200 determines whether the count value T2 of the second timer has exceeded the predetermined setting value change time (second time threshold) T2th (for example, 0.5 (sec)) (step S224). The setting value change time (second time threshold) T2th is set to, for example, 50 counts (T2th=50) when 10 (ms) is defined as one count. The setting value change time (second time threshold) T2th is not limited to 0.5 (sec) (=50).

If the count value T2 of the second timer is smaller than the predetermined setting value change time T2th (T2<T2th; No at step S224), the processing at step S224 is repeatedly executed until the count value T2 of the second timer becomes equal to or larger than the predetermined setting value change time T2th (T2≥T2th; Yes at step S224). If the count value T2 of the second timer becomes equal to or larger than the predetermined setting value change time T2th (T2≥T2th; Yes at step S224), the display control circuit 231 of the control device 200 reflects the horizontal diffusion degree display value Sx and the X-direction position display value x0 of the light distribution shape object OBJ, which are acquired in the above-described processing and stored in the first storage region of the storage circuit 223, to display control on the illumination control application screen 400 (step S225). In addition, the transmission-reception circuit 225 of the control device 200 reads the horizontal diffusion degree display value Sx stored in the first storage region and transmits the read horizontal diffusion degree display value Sx as the first setting information (S1x=Sx) to the illumination device 1 (step S226).

The transmission-reception circuit 111 of the illumination device 1 stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

Referring back to FIG. 21, the control device 200 determines whether the long tap state is continuous (step S210). If the long tap state is not continuous (No at step S210), in other words, if a user's finger has been released from the screen or if the touch detection position is out of the first adjustment region TA1, the process returns to the illumination control processing illustrated in FIG. 20, thereby transitioning to a standby state (step S101). Accordingly, the current horizontal diffusion degree display value Sx is finalized with the current horizontal diffusion degree display value Sx being reflected in the control state of the horizontal diffusion degree of the illumination device 1.

If the long tap state is continuous (Yes at step S210), the process returns to the processing at step S205. When the following conditions are satisfied: the long tap state is continuous (Yes at step S210), the magnitude |ΔSx| of the horizontal diffusion degree difference value ΔSx is equal to or larger than the magnitude |LSCx| of the horizontal diffusion degree coarse adjustment scale setting value LSCx (Yes at step S211), and the sign of the horizontal diffusion degree difference value ΔSx is “+(positive value)” (Yes at step S221 in FIG. 22), the processing at steps S205 to S210 including the above-described horizontal diffusion degree coarse adjustment processing (step S220; FIG. 22) is repeatedly executed at intervals of the predetermined setting value change time (second time threshold) T2th until the magnitude |ΔSx| of the horizontal diffusion degree difference value ΔSx becomes smaller than the magnitude |LSCx| of the horizontal diffusion degree coarse adjustment scale setting value LSCx (No at step S211). Accordingly, the horizontal diffusion degree display value Sx is coarsely adjusted in steps of the horizontal diffusion degree coarse adjustment scale setting value LSCx (first adjustment interval) in a direction in which the horizontal diffusion degree display value Sx increases.

Referring back to FIG. 22, if the sign of the horizontal diffusion degree difference value ΔSx is “−(negative value)” (No at step S221), it is indicated that the adjustment direction of the horizontal diffusion degree display value Sx with respect to the target horizontal diffusion degree Sx′ is a direction in which the horizontal diffusion degree of the illumination device 1 decreases. In this case, the control device 200 subtracts the horizontal diffusion degree coarse adjustment scale setting value LSCx (first adjustment interval) from the horizontal diffusion degree display value Sx (step S227), thereby updating the horizontal diffusion degree display value Sx. In addition, the control device 200 calculates the X-direction position display value x0 of the light distribution shape object OBJ, which corresponds to the horizontal diffusion degree display value Sx (step S228), and stores the X-direction position display value x0 in the first storage region of the storage circuit 223 illustrated in FIG. 17.

Subsequently, the control device 200 determines whether the count value T2 of the second timer has exceeded the predetermined setting value change time (second time threshold) T2th (for example, 0.5 (sec)) (step S229).

If the count value T2 of the second timer is smaller than the predetermined setting value change time T2th (T2<T2th; No at step S229), the processing at step S229 is repeatedly executed until the count value T2 of the second timer becomes equal to or larger than the predetermined setting value change time T2th (T2≥T2th; Yes at step S229). If the count value T2 of the second timer becomes equal to or larger than the predetermined setting value change time T2th (T2≥T2th; Yes at step S229), the display control circuit 231 of the control device 200 reflects the horizontal diffusion degree display value Sx and the X-direction position display value x0 of the light distribution shape object OBJ, which are acquired in the above-described processing and stored in the first storage region of the storage circuit 223, to display control on the illumination control application screen 400 (step S230). In addition, the transmission-reception circuit 225 of the control device 200 reads the horizontal diffusion degree display value Sx stored in the first storage region and transmits the read horizontal diffusion degree display value Sx as the first setting information (S1x=Sx) to the illumination device 1 (step S231).

The transmission-reception circuit 111 of the illumination device 1 stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

Referring back to FIG. 21, the control device 200 determines whether the long tap state is continuous (step S210). If the long tap state is not continuous (No at step S210), in other words, if a user's finger has been released from the screen or if the touch detection position is out of the first adjustment region TA1, the process returns to the illumination control processing illustrated in FIG. 20, thereby transitioning to a standby state (step S101). Accordingly, the current horizontal diffusion degree display value Sx is finalized with the current horizontal diffusion degree display value Sx being reflected in the control state of the horizontal diffusion degree of the illumination device 1.

If the long tap state is continuous (Yes at step S210), the process returns to the processing at step S205. When the following conditions are satisfied: the long tap state is continuous (Yes at step S210), the magnitude |ΔSx| of the horizontal diffusion degree difference value ΔSx is equal to or larger than the magnitude |LSCx| of the horizontal diffusion degree coarse adjustment scale setting value LSCx (Yes at step S211), and the sign of the horizontal diffusion degree difference value ΔSx is “− (negative value)” (No at step S221 in FIG. 22), the processing at steps S205 to S210 including the above-described horizontal diffusion degree coarse adjustment processing (step S220; FIG. 22) is repeatedly executed at intervals of the predetermined setting value change time (second time threshold) T2th until the magnitude |ΔSx| of the horizontal diffusion degree difference value ΔSx becomes smaller than the magnitude |LSCx| of the horizontal diffusion degree coarse adjustment scale setting value LSCx (No at step S211). Accordingly, the horizontal diffusion degree display value Sx is coarsely adjusted in steps of the horizontal diffusion degree coarse adjustment scale setting value LSCx (first adjustment interval) in a direction in which the horizontal diffusion degree display value Sx decreases.

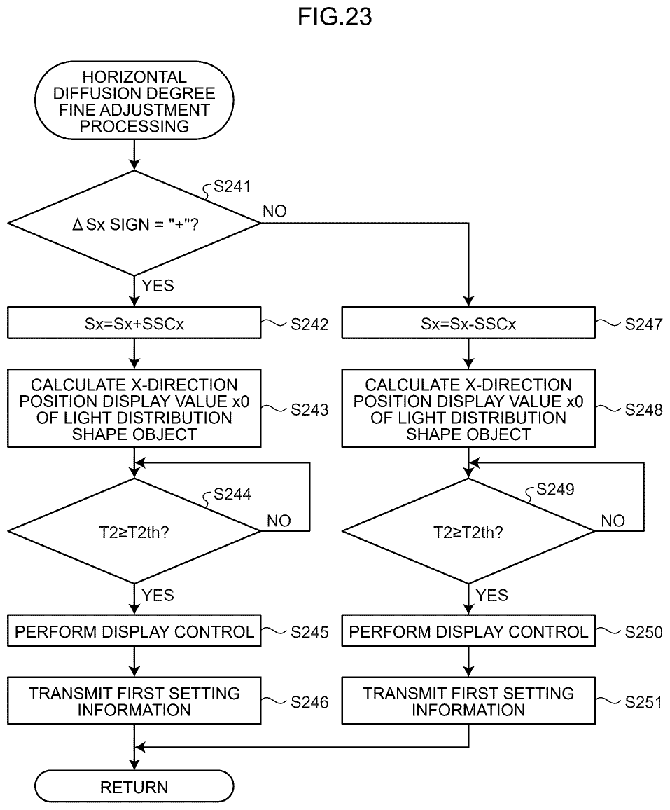

If the magnitude |ΔSx| of the horizontal diffusion degree difference value ΔSx is smaller than the magnitude |LSCx| of the horizontal diffusion degree coarse adjustment scale setting value LSCx (No at step S211), horizontal diffusion degree fine adjustment processing illustrated in FIG. 23 is executed. FIG. 23 is a flowchart illustrating an example of the horizontal diffusion degree fine adjustment processing by the control device 200 for the illumination device 1 according to the first embodiment.

The control device 200 reads the sign of the horizontal diffusion degree difference value ΔSx and determines the adjustment direction of the horizontal diffusion degree display value Sx with respect to the target horizontal diffusion degree Sx′. Specifically, the control device 200 determines whether the sign of the horizontal diffusion degree difference value ΔSx is “+(positive value)” (step S241).

If the sign of the horizontal diffusion degree difference value ΔSx is “+(positive value)” (Yes at step S241), it is indicated that the adjustment direction of the horizontal diffusion degree display value Sx with respect to the target horizontal diffusion degree Sx′ is a direction in which the horizontal diffusion degree of the illumination device 1 increases. In this case, the control device 200 adds the horizontal diffusion degree fine adjustment scale setting value SSCx (second adjustment interval) to the horizontal diffusion degree display value Sx (step S242), thereby updating the horizontal diffusion degree display value Sx. In addition, the control device 200 calculates the X-direction position display value x0 of the light distribution shape object OBJ, which corresponds to the horizontal diffusion degree display value Sx (step S243), and stores the X-direction position display value x0 in the first storage region of the storage circuit 223 illustrated in FIG. 17.

Subsequently, the control device 200 determines whether the count value T2 of the second timer has exceeded the predetermined setting value change time (second time threshold) T2th (for example, 0.5 (sec)) (step S244).

If the count value T2 of the second timer is smaller than the predetermined setting value change time T2th (T2<T2th; No at step S244), the processing at step S244 is repeatedly executed until the count value T2 of the second timer becomes equal to or larger than the predetermined setting value change time T2th (T2≥T2th; Yes at step S244). If the count value T2 of the second timer becomes equal to or larger than the predetermined setting value change time T2th (T2≥T2th; Yes at step S244), the display control circuit 231 of the control device 200 reflects the horizontal diffusion degree display value Sx and the X-direction position display value x0 of the light distribution shape object OBJ, which are acquired in the above-described processing and stored in the first storage region of the storage circuit 223, to display control on the illumination control application screen 400 (step S245). In addition, the transmission-reception circuit 225 of the control device 200 reads the horizontal diffusion degree display value Sx stored in the first storage region and transmits the read horizontal diffusion degree display value Sx as the first setting information (S1x=Sx) to the illumination device 1 (step S246).

The transmission-reception circuit 111 of the illumination device 1 stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

Referring back to FIG. 21, the control device 200 determines whether the long tap state is continuous (step S210). If the long tap state is not continuous (No at step S210), in other words, if a user's finger has been released from the screen or if the touch detection position is out of the first adjustment region TA1, the process returns to the illumination control processing illustrated in FIG. 20, thereby transitioning to a standby state (step S101). Accordingly, the current horizontal diffusion degree display value Sx is finalized with the current horizontal diffusion degree display value Sx being reflected in the control state of the horizontal diffusion degree of the illumination device 1.

If the long tap state is continuous (Yes at step S210), the process returns to the processing at step S205. When the following conditions are satisfied: the long tap state is continuous (Yes at step S210), the magnitude |ΔSx| of the horizontal diffusion degree difference value ΔSx is smaller than the magnitude |LSCx| of the horizontal diffusion degree coarse adjustment scale setting value LSCx (No at step S211), and the sign of the horizontal diffusion degree difference value ΔSx is “+(positive value)” (Yes at step S241 in FIG. 23), the processing at steps S205 to S210 including the above-described horizontal diffusion degree fine adjustment processing (step S240; FIG. 23) is repeatedly executed at intervals of the predetermined setting value change time (second time threshold) T2th. Accordingly, the horizontal diffusion degree display value Sx is finely adjusted in steps of the horizontal diffusion degree fine adjustment scale setting value SSCx (second adjustment interval) in a direction in which the horizontal diffusion degree display value Sx increases.

Thereafter, if the magnitude |ΔSx| of the horizontal diffusion degree difference value ΔSx becomes smaller than the magnitude |SSCx| of the horizontal diffusion degree fine adjustment scale setting value SSCx (Yes at step S209) and the long tap state is canceled (No at step S210), the current horizontal diffusion degree display value Sx is finalized with the current horizontal diffusion degree display value Sx being reflected in the control state of the horizontal diffusion degree of the illumination device 1 in a state in which the X-direction touch position detection value x′0 in the first adjustment region TA1 substantially matches the X-direction position display value x0 of the light distribution shape object OBJ (x′0≈x0).

Referring back to FIG. 23, if the sign of the horizontal diffusion degree difference value ΔSx is “− (negative value)” (No at step S241), it is indicated that the adjustment direction of the horizontal diffusion degree display value Sx with respect to the target horizontal diffusion degree Sx′ is a direction in which the horizontal diffusion degree of the illumination device 1 decreases. In this case, the control device 200 subtracts the horizontal diffusion degree fine adjustment scale setting value SSCx (second adjustment interval) from the horizontal diffusion degree display value Sx (step S247), thereby updating the horizontal diffusion degree display value Sx. In addition, the control device 200 calculates the X-direction position display value x0 of the light distribution shape object OBJ, which corresponds to the horizontal diffusion degree display value Sx (step S248), and stores the X-direction position display value x0 in the first storage region of the storage circuit 223 illustrated in FIG. 17.

Subsequently, the control device 200 determines whether the count value T2 of the second timer has exceeded the predetermined setting value change time (second time threshold) T2th (for example, 0.5 (sec)) (step S249).

If the count value T2 of the second timer is smaller than the predetermined setting value change time T2th (T2<T2th; No at step S249), the processing at step S249 is repeatedly executed until the count value T2 of the second timer becomes equal to or larger than the predetermined setting value change time T2th (T2≥T2th; Yes at step S249). If the count value T2 of the second timer becomes equal to or larger than the predetermined setting value change time T2th (T2≥T2th; Yes at step S249), the display control circuit 231 of the control device 200 reflects the horizontal diffusion degree display value Sx and the X-direction position display value x0 of the light distribution shape object OBJ, which are acquired in the above-described processing and stored in the first storage region of the storage circuit 223, to display control on the illumination control application screen 400 (step S250). In addition, the transmission-reception circuit 225 of the control device 200 reads the horizontal diffusion degree display value Sx stored in the first storage region and transmits the read horizontal diffusion degree display value Sx as the first setting information (S1x=Sx) to the illumination device 1 (step S251).

The transmission-reception circuit 111 of the illumination device 1 stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

Referring back to FIG. 21, the control device 200 determines whether the long tap state is continuous (step S210). If the long tap state is not continuous (No at step S210), in other words, if a user's finger has been released from the screen or if the touch detection position is out of the first adjustment region TA1, the process returns to the illumination control processing illustrated in FIG. 20, thereby transitioning to a standby state (step S101). Accordingly, the current horizontal diffusion degree display value Sx is finalized with the current horizontal diffusion degree display value Sx being reflected in the control state of the horizontal diffusion degree of the illumination device 1.

If the long tap state is continuous (Yes at step S210), the process returns to the processing at step S205. When the following conditions are satisfied: the long tap state is continuous (Yes at step S210), the magnitude |ΔSx| of the horizontal diffusion degree difference value ΔSx is smaller than the magnitude |LSCx| of the horizontal diffusion degree coarse adjustment scale setting value LSCx (No at step S211), and the sign of the horizontal diffusion degree difference value ΔSx is “−(negative value)” (No at step S241 in FIG. 23), the processing at steps S205 to S210 including the above-described horizontal diffusion degree fine adjustment processing (step S240; FIG. 23) is repeatedly executed at intervals of the predetermined setting value change time (second time threshold) T2th. Accordingly, the horizontal diffusion degree display value Sx is finely adjusted in steps of the horizontal diffusion degree fine adjustment scale setting value SSCx (second adjustment interval) in a direction in which the horizontal diffusion degree display value Sx decreases.

Thereafter, if the magnitude |ΔSx| of the horizontal diffusion degree difference value ΔSx becomes smaller than the magnitude |SSCx| of the horizontal diffusion degree fine adjustment scale setting value SSCx (Yes at step S209) and the long tap state is canceled (No at step S210), the current horizontal diffusion degree display value Sx is finalized with the current horizontal diffusion degree display value Sx being reflected in the control state of the horizontal diffusion degree of the illumination device 1 in a state in which the X-direction touch position detection value x′0 in the first adjustment region TA1 matches or substantially matches the X-direction position display value x0 of the light distribution shape object OBJ (x′0≈x0).

Through the above-described horizontal diffusion degree adjustment processing according to the first embodiment, the horizontal diffusion degree coarse adjustment processing (FIG. 22) of performing adjustment by a horizontal diffusion degree coarse adjustment scale (first adjustment interval) or the horizontal diffusion degree fine adjustment processing (FIG. 23) of performing adjustment by a horizontal diffusion degree fine adjustment scale (second adjustment interval) is executed in accordance with the touch detection position in the X direction detected while the user maintains the long tap state in the first adjustment region TA1 on the illumination control application screen 400. Specifically, when the difference (horizontal diffusion degree difference value ΔSx) between the target horizontal diffusion degree Sx′ and the horizontal diffusion degree display value Sx is equal to or larger than the horizontal diffusion degree coarse adjustment scale (first adjustment interval) (Yes at step S211 in FIG. 21), the horizontal diffusion degree coarse adjustment processing (FIG. 22) is executed. When the difference (horizontal diffusion degree difference value ΔSx) between the target horizontal diffusion degree Sx′ and the horizontal diffusion degree display value Sx is smaller than the horizontal diffusion degree coarse adjustment scale (first adjustment interval) (No at step S211 in FIG. 21), the horizontal diffusion degree fine adjustment processing (FIG. 23) is executed. For example, when the difference (horizontal diffusion degree difference value ΔSx) between the target horizontal diffusion degree Sx′ and the horizontal diffusion degree display value Sx becomes smaller than the horizontal diffusion degree coarse adjustment scale (first adjustment interval) through the horizontal diffusion degree coarse adjustment processing (FIG. 22) (No at step S211 in FIG. 21), the process seamlessly transitions to the horizontal diffusion degree fine adjustment processing (FIG. 23).

When the user performs a swipe operation (operation in which a finger is slid while touching the screen) while maintaining the long tap state in the first adjustment region TA1 on the illumination control application screen 400, the horizontal diffusion degree coarse adjustment processing (FIG. 22) and the horizontal diffusion degree fine adjustment processing (FIG. 23) seamlessly transition to each other. For example, when the difference (horizontal diffusion degree difference value ΔSx) between the target horizontal diffusion degree Sx′ and the horizontal diffusion degree display value Sx becomes equal to or larger than the horizontal diffusion degree coarse adjustment scale (first adjustment interval) through a swipe operation after the horizontal diffusion degree fine adjustment processing (FIG. 23) is executed (Yes at step S211 in FIG. 21), the process seamlessly transitions to the horizontal diffusion degree coarse adjustment processing (FIG. 22). For example, when the difference (horizontal diffusion degree difference value ΔSx) between the target horizontal diffusion degree Sx′ and the horizontal diffusion degree display value Sx becomes smaller than the horizontal diffusion degree coarse adjustment scale (first adjustment interval) through a swipe operation after the horizontal diffusion degree coarse adjustment processing (FIG. 22) is executed (No at step S211 in FIG. 21), the process seamlessly transitions to the horizontal diffusion degree fine adjustment processing (FIG. 23).

More specifically, when the magnitude |ΔSx| of the horizontal diffusion degree difference value ΔSx becomes equal to or larger than the magnitude |LSCx| of the horizontal diffusion degree coarse adjustment scale setting value LSCx (|ΔSx|≥|LSCx|; Yes at step S211 in FIG. 21), the horizontal diffusion degree display value Sx corresponding to the X-direction position display value x0 of the light distribution shape object OBJ is coarsely adjusted in a direction in which the horizontal diffusion degree display value Sx approaches the target horizontal diffusion degree Sx′ corresponding to the X-direction touch position detection value x′0. When the magnitude |ΔSx| of the horizontal diffusion degree difference value ΔSx becomes smaller than the magnitude |LSCx| of the horizontal diffusion degree coarse adjustment scale setting value LSCx (|ΔSx|<|LSCx|; No at step S211 in FIG. 21), the horizontal diffusion degree display value Sx corresponding to the X-direction position display value x0 of the light distribution shape object OBJ is finely adjusted in a direction in which the horizontal diffusion degree display value Sx approaches the target horizontal diffusion degree Sx′ corresponding to the X-direction touch position detection value x′0.

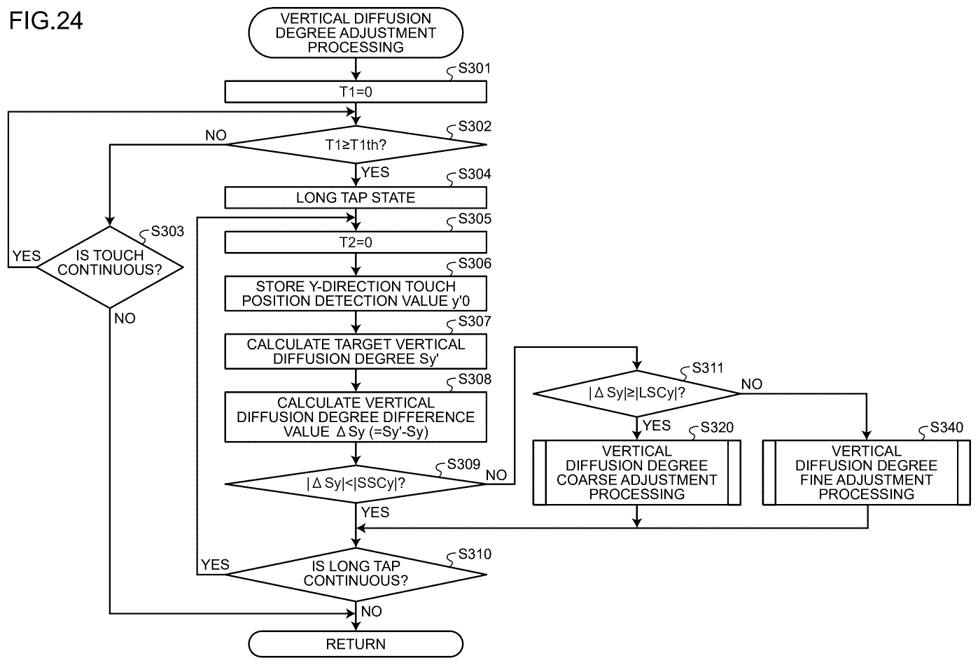

Referring back to FIG. 20, if a touch is detected in the second adjustment region TA2 (Yes at step S103), the process transitions to vertical diffusion degree adjustment processing illustrated in FIG. 24 (step S300). FIG. 24 is a flowchart illustrating an example of the vertical diffusion degree adjustment processing by the control device 200 for the illumination device 1 according to the first embodiment.

After having transitioned to the vertical diffusion degree adjustment processing illustrated in FIG. 24, the control device 200 resets a count value T1 of a first timer that counts the continuation time of a touch in the second adjustment region TA2 (T1=0; step S301).

Subsequently, the control device 200 determines whether the count value T1 of the first timer has exceeded the predetermined long tap detection time (first time threshold) T1th (for example, 2 (sec)) (step S302). The long tap detection time (first time threshold) T1th is set to, for example, 200 counts (T1th=200) when 10 (ms) is defined as one count. The long tap detection time (first time threshold) T1th is not limited to 2 (sec) (=200).

If the count value T1 of the first timer is smaller than the predetermined long tap detection time T1th (T1<T1th; No at step S302), the control device 200 subsequently determines whether the touch state in the second adjustment region TA2 is continuous (step S303). If the touch state in the second adjustment region TA2 is not continuous (No at step S303), in other words, if a user's finger has been released from the screen or if the touch detection position is out of the second adjustment region TA2, the process returns to the illumination control processing illustrated in FIG. 20, thereby transitioning to a standby state without adjustment of the control state of the vertical diffusion degree of the illumination device 1 (step S101).

If the touch state in the second adjustment region TA2 is continuous (Yes at step S303), the processing at steps S302 to S303 is repeatedly executed until the count value T1 of the first timer exceeds the predetermined long tap detection time T1th (Yes at step S302).

If the count value T1 of the first timer exceeds the predetermined long tap detection time T1th (Yes at step S302), the control device 200 determines that the touch state is the long tap state (step S304), resets a count value T2 of a second timer that counts the predetermined setting value change time (second time threshold) T2th (T2=0; step S305), detects the touch position in the Y direction in the second adjustment region TA2, stores the touch position in the first storage region of the storage circuit 223 illustrated in FIG. 17 as the Y-direction touch position detection value y′0 (step S306), calculates the target vertical diffusion degree Sy′ corresponding to the Y-direction touch position detection value y′0 (step S307), and stores the target vertical diffusion degree Sy′ in the first storage region illustrated in FIG. 17. The Y-direction touch position detection value y′0 in the second adjustment region TA2 is different from the Y-direction position display value y0 of the light distribution shape object OBJ.

Then, the control device 200 reads the vertical diffusion degree display value Sy and the target vertical diffusion degree Sy′ from the first storage region, calculates the vertical diffusion degree difference value ΔSy (ΔSy=Sy′−Sy; step S308), and determines whether the magnitude |ΔSy| of the vertical diffusion degree difference value ΔSy is smaller than the magnitude |SSCy| of the vertical diffusion degree fine adjustment scale setting value SSCy (second adjustment interval) (step S309).

If the magnitude |ΔSy| of the vertical diffusion degree difference value ΔSy is equal to or larger than the magnitude |SSCy| of the vertical diffusion degree fine adjustment scale setting value SSCy (No at step S309), the control device 200 subsequently determines whether the magnitude |ΔSy| of the vertical diffusion degree difference value ΔSy is equal to or larger than the magnitude |LSCy| of the vertical diffusion degree coarse adjustment scale setting value LSCy (step S311).

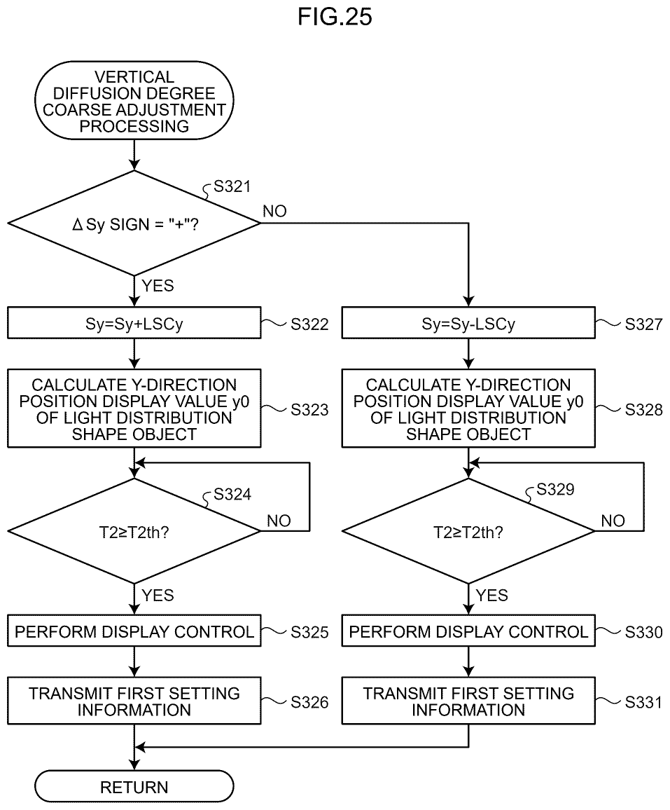

If the magnitude |ΔSy| of the vertical diffusion degree difference value ΔSy is equal to or larger than the magnitude |LSCy| of the vertical diffusion degree coarse adjustment scale setting value LSCy (Yes at step S311), vertical diffusion degree coarse adjustment processing illustrated in FIG. 25 is executed. FIG. 25 is a flowchart illustrating an example of the vertical diffusion degree coarse adjustment processing by the control device 200 for the illumination device 1 according to the first embodiment.

The control device 200 reads the sign of the vertical diffusion degree difference value ΔSy and determines the adjustment direction of the vertical diffusion degree display value Sy with respect to the target vertical diffusion degree Sy′. Specifically, the control device 200 determines whether the sign of the vertical diffusion degree difference value ΔSy is “+ (positive value)” (step S321).

If the sign of the vertical diffusion degree difference value ΔSy is “+ (positive value)” (Yes at step S321), it is indicated that the adjustment direction of the vertical diffusion degree display value Sy with respect to the target vertical diffusion degree Sy′ is a direction in which the vertical diffusion degree of the illumination device 1 increases. In this case, the control device 200 adds the vertical diffusion degree coarse adjustment scale setting value LSCy (first adjustment interval) to the vertical diffusion degree display value Sy (step S322), thereby updating the vertical diffusion degree display value Sy. In addition, the control device 200 calculates the Y-direction position display value y0 of the light distribution shape object OBJ, which corresponds to the vertical diffusion degree display value Sy (step S323), and stores the Y-direction position display value y0 in the first storage region of the storage circuit 223 illustrated in FIG. 17.

Subsequently, the control device 200 determines whether the count value T2 of the second timer has exceeded the predetermined setting value change time (second time threshold) T2th (for example, 0.5 (sec)) (step S324). The setting value change time (second time threshold) T2th is set to, for example, 50 counts (T2th=50) when 10 (ms) is defined as one count. The setting value change time (second time threshold) T2th is not limited to 0.5 (sec) (=50).

If the count value T2 of the second timer is smaller than the predetermined setting value change time T2th (T2<T2th; No at step S324), the processing at step S324 is repeatedly executed until the count value T2 of the second timer becomes equal to or larger than the predetermined setting value change time T2th (T2≥T2th; Yes at step S324). If the count value T2 of the second timer becomes equal to or larger than the predetermined setting value change time T2th (T2≥T2th; Yes at step S324), the display control circuit 231 of the control device 200 reflects the vertical diffusion degree display value Sy and the Y-direction position display value y0 of the light distribution shape object OBJ, which are acquired in the above-described processing and stored in the first storage region of the storage circuit 223, to display control on the illumination control application screen 400 (step S325). In addition, the transmission-reception circuit 225 of the control device 200 reads the vertical diffusion degree display value Sy stored in the first storage region and transmits the read vertical diffusion degree display value Sy as the first setting information (Sly=Sy) to the illumination device 1 (step S326).

The transmission-reception circuit 111 of the illumination device 1 stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

Referring back to FIG. 24, the control device 200 determines whether the long tap state is continuous (step S310). If the long tap state is not continuous (No at step S310), in other words, if a user's finger has been released from the screen or if the touch detection position is out of the second adjustment region TA2, the process returns to the illumination control processing illustrated in FIG. 20, thereby transitioning to a standby state (step S101). Accordingly, the current vertical diffusion degree display value Sy is finalized with the current vertical diffusion degree display value Sy being reflected in the control state of the vertical diffusion degree of the illumination device 1.

If the long tap state is continuous (Yes at step S310), the process returns to the processing at step S305. When the following conditions are satisfied: the long tap state is continuous (Yes at step S310), the magnitude |ΔSy| of the vertical diffusion degree difference value ΔSy is equal to or larger than the magnitude |LSCy| of the vertical diffusion degree coarse adjustment scale setting value LSCy (Yes at step S311), and the sign of the vertical diffusion degree difference value ΔSy is “+(positive value)” (Yes at step S321), the processing at steps S305 to S310 including the above-described vertical diffusion degree coarse adjustment processing (step S320; FIG. 25) is repeatedly executed at intervals of the predetermined setting value change time (second time threshold) T2th until the magnitude |ΔSy| of the vertical diffusion degree difference value ΔSy becomes smaller than the magnitude |LSCy| of the vertical diffusion degree coarse adjustment scale setting value LSCy (No at step S311). Accordingly, the vertical diffusion degree display value Sy is coarsely adjusted in steps of the vertical diffusion degree coarse adjustment scale setting value LSCy (first adjustment interval) in a direction in which the vertical diffusion degree display value Sy increases.

Referring back to FIG. 25, if the sign of the vertical diffusion degree difference value ΔSy is “−(negative value)” (No at step S321), it is indicated that the adjustment direction of the vertical diffusion degree display value Sy with respect to the target vertical diffusion degree Sy′ is a direction in which the vertical diffusion degree of the illumination device 1 decreases. In this case, the control device 200 subtracts the vertical diffusion degree coarse adjustment scale setting value LSCy (first adjustment interval) from the vertical diffusion degree display value Sy (step S327), thereby updating the vertical diffusion degree display value Sy. In addition, the control device 200 calculates the Y-direction position display value y0 of the light distribution shape object OBJ, which corresponds to the vertical diffusion degree display value Sy (step S328), and stores the Y-direction position display value y0 in the first storage region of the storage circuit 223 illustrated in FIG. 17.

Subsequently, the control device 200 determines whether the count value T2 of the second timer has exceeded the predetermined setting value change time (second time threshold) T2th (for example, 0.5 (sec)) (step S329).

If the count value T2 of the second timer is smaller than the predetermined setting value change time T2th (T2<T2th; No at step S329), the processing at step S329 is repeatedly executed until the count value T2 of the second timer becomes equal to or larger than the predetermined setting value change time T2th (T2≥T2th; Yes at step S329). If the count value T2 of the second timer becomes equal to or larger than the predetermined setting value change time T2th (T2≥T2th; Yes at step S329), the display control circuit 231 of the control device 200 reflects the vertical diffusion degree display value Sy and the Y-direction position display value y0 of the light distribution shape object OBJ, which are acquired in the above-described processing and stored in the first storage region of the storage circuit 223, to display control on the illumination control application screen 400 (step S330). In addition, the transmission-reception circuit 225 of the control device 200 reads the vertical diffusion degree display value Sy stored in the first storage region and transmits the read vertical diffusion degree display value Sy as the first setting information (Sly=Sy) to the illumination device 1 (step S331).

The transmission-reception circuit 111 of the illumination device 1 stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

Referring back to FIG. 24, the control device 200 determines whether the long tap state is continuous (step S310). If the long tap state is not continuous (No at step S310), in other words, if a user's finger has been released from the screen or if the touch detection position is out of the second adjustment region TA2, the process returns to the illumination control processing illustrated in FIG. 20, thereby transitioning to a standby state (step S101). Accordingly, the current vertical diffusion degree display value Sy is finalized with the current vertical diffusion degree display value Sy being reflected in the control state of the vertical diffusion degree of the illumination device 1.

If the long tap state is continuous (Yes at step S310), the process returns to the processing at step S305. When the following conditions are satisfied: the long tap state is continuous (Yes at step S310), the magnitude |ΔSy| of the vertical diffusion degree difference value ΔSy is equal to or larger than the magnitude |LSCy| of the vertical diffusion degree coarse adjustment scale setting value LSCy (Yes at step S311), and the sign of the vertical diffusion degree difference value ΔSy is “−(negative value)” (No at step S321 in FIG. 25), the processing at steps S305 to S310 including the above-described vertical diffusion degree coarse adjustment processing (step S320; FIG. 25) is repeatedly executed at intervals of the predetermined setting value change time (second time threshold) T2th until the magnitude |ΔSy| of the vertical diffusion degree difference value ΔSy becomes smaller than the magnitude |LSCy| of the vertical diffusion degree coarse adjustment scale setting value LSCy (No at step S311). Accordingly, the vertical diffusion degree display value Sy is coarsely adjusted in steps of the vertical diffusion degree coarse adjustment scale setting value LSCy (first adjustment interval) in a direction in which the vertical diffusion degree display value Sy decreases.

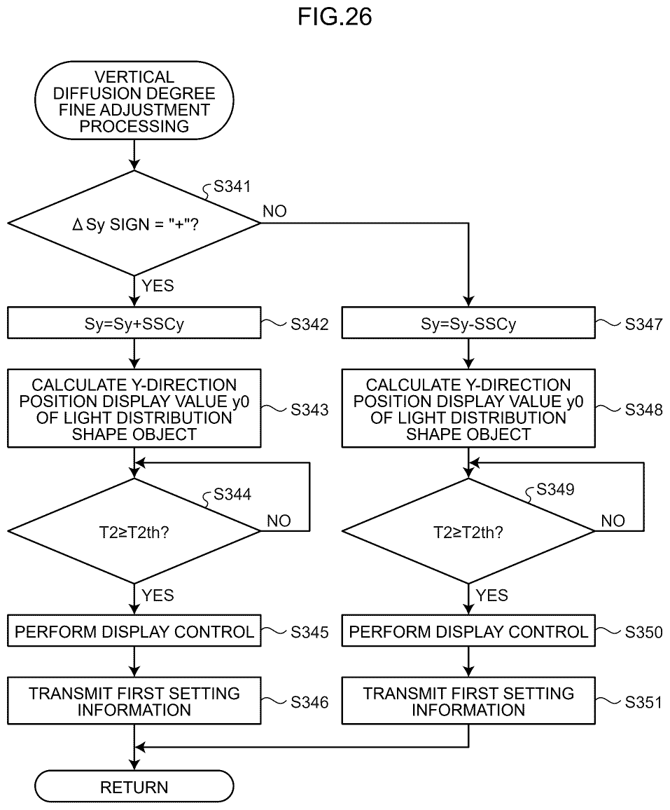

If the magnitude |ΔSy| of the vertical diffusion degree difference value ΔSy becomes smaller than the magnitude |LSCy| of the vertical diffusion degree coarse adjustment scale setting value LSCy (No at step S311), vertical diffusion degree fine adjustment processing illustrated in FIG. 26 is executed. FIG. 26 is a flowchart illustrating an example of the vertical diffusion degree fine adjustment processing by the control device 200 for the illumination device 1 according to the first embodiment.

The control device 200 reads the sign of the vertical diffusion degree difference value ΔSy and determines the adjustment direction of the vertical diffusion degree display value Sy with respect to the target vertical diffusion degree Sy′. Specifically, the control device 200 determines whether the sign of the vertical diffusion degree difference value ΔSy is “+(positive value)” (step S341).

If the sign of the vertical diffusion degree difference value ΔSy is “+(positive value)” (Yes at step S341), it is indicated that the adjustment direction of the vertical diffusion degree display value Sy with respect to the target vertical diffusion degree Sy′ is a direction in which the vertical diffusion degree of the illumination device 1 increases. In this case, the control device 200 adds the vertical diffusion degree fine adjustment scale setting value SSCy (second adjustment interval) to the vertical diffusion degree display value Sy (step S342), thereby updating the vertical diffusion degree display value Sy. In addition, the control device 200 calculates the Y-direction position display value y0 of the light distribution shape object OBJ, which corresponds to the vertical diffusion degree display value Sy (step S343), and stores the Y-direction position display value y0 in the first storage region of the storage circuit 223 illustrated in FIG. 17.

Subsequently, the control device 200 determines whether the count value T2 of the second timer has exceeded the predetermined setting value change time (second time threshold) T2th (for example, 0.5 (sec)) (step S344).

If the count value T2 of the second timer is smaller than the predetermined setting value change time T2th (T2<T2th; No at step S344), the processing at step S344 is repeatedly executed until the count value T2 of the second timer becomes equal to or larger than the predetermined setting value change time T2th (T2≥T2th; Yes at step S344). If the count value T2 of the second timer becomes equal to or larger than the predetermined setting value change time T2th (T2≥T2th; Yes at step S344), the display control circuit 231 of the control device 200 reflects the vertical diffusion degree display value Sy and the Y-direction position display value y0 of the light distribution shape object OBJ, which are acquired in the above-described processing and stored in the first storage region of the storage circuit 223, to display control on the illumination control application screen 400 (step S345). In addition, the transmission-reception circuit 225 of the control device 200 reads the vertical diffusion degree display value Sy stored in the first storage region and transmits the read vertical diffusion degree display value Sy as the first setting information (Sly=Sy) to the illumination device 1 (step S346).

The transmission-reception circuit 111 of the illumination device 1 stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

Referring back to FIG. 24, the control device 200 determines whether the long tap state is continuous (step S310). If the long tap state is not continuous (No at step S310), in other words, if a user's finger has been released from the screen or if the touch detection position is out of the second adjustment region TA2, the process returns to the illumination control processing illustrated in FIG. 20, thereby transitioning to a standby state (step S101). Accordingly, the current vertical diffusion degree display value Sy is finalized with the current vertical diffusion degree display value Sy being reflected in the control state of the vertical diffusion degree of the illumination device 1.

If the long tap state is continuous (Yes at step S310), the process returns to the processing at step S305. When the following conditions are satisfied: the long tap state is continuous (Yes at step S310), the magnitude |ΔSy| of the vertical diffusion degree difference value ΔSy is smaller than the magnitude |LSCy| of the vertical diffusion degree coarse adjustment scale setting value LSCy (No at step S311), and the sign of the vertical diffusion degree difference value ΔSy is “+(positive value)” (Yes at step S341 in FIG. 26), the processing at steps S305 to S310 including the above-described vertical diffusion degree fine adjustment processing (step S340; FIG. 26) is repeatedly executed at intervals of the predetermined setting value change time (second time threshold) T2th. Accordingly, the vertical diffusion degree display value Sy is finely adjusted in steps of the vertical diffusion degree fine adjustment scale setting value SSCy (second adjustment interval) in a direction in which the vertical diffusion degree display value Sy increases.

Thereafter, if the magnitude |ΔSy| of the vertical diffusion degree difference value ΔSy becomes smaller than the magnitude |SSCy| of the vertical diffusion degree fine adjustment scale setting value SSCy (Yes at step S309) and the long tap state is canceled (No at step S310), the current vertical diffusion degree display value Sy is finalized with the current vertical diffusion degree display value Sy being reflected in the control state of the vertical diffusion degree of the illumination device 1 in a state in which the Y-direction touch position detection value y′0 in the second adjustment region TA2 substantially matches the Y-direction position display value y0 of the light distribution shape object OBJ (y′0≈y0).

Referring back to FIG. 26, if the sign of the vertical diffusion degree difference value ΔSy is “−(negative value)” (No at step S341), it is indicated that the adjustment direction of the vertical diffusion degree display value Sy with respect to the target vertical diffusion degree Sy′ is a direction in which the vertical diffusion degree of the illumination device 1 decreases. In this case, the control device 200 subtracts the vertical diffusion degree fine adjustment scale setting value SSCy (second adjustment interval) from the vertical diffusion degree display value Sy (step S347), thereby updating the vertical diffusion degree display value Sy. In addition, the control device 200 calculates the Y-direction position display value y0 of the light distribution shape object OBJ, which corresponds to the vertical diffusion degree display value Sy (step S348), and stores the Y-direction position display value y0 in the first storage region of the storage circuit 223 illustrated in FIG. 17.

Subsequently, the control device 200 determines whether the count value T2 of the second timer has exceeded the predetermined setting value change time (second time threshold) T2th (for example, 0.5 (sec)) (step S349).

If the count value T2 of the second timer is smaller than the predetermined setting value change time T2th (T2<T2th; No at step S349), the processing at step S349 is repeatedly executed until the count value T2 of the second timer becomes equal to or larger than the predetermined setting value change time T2th (T2≥T2th; Yes at step S349). If the count value T2 of the second timer becomes equal to or larger than the predetermined setting value change time T2th (T2≥T2th; Yes at step S349), the display control circuit 231 of the control device 200 reflects the vertical diffusion degree display value Sy and the Y-direction position display value y0 of the light distribution shape object OBJ, which are acquired in the above-described processing and stored in the first storage region of the storage circuit 223, to display control on the illumination control application screen 400 (step S350). In addition, the transmission-reception circuit 225 of the control device 200 reads the vertical diffusion degree display value Sy stored in the first storage region and transmits the read vertical diffusion degree display value Sy as the first setting information (Sly=Sy) to the illumination device 1 (step S351).

The transmission-reception circuit 111 of the illumination device 1 stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

Referring back to FIG. 24, the control device 200 determines whether the long tap state is continuous (step S310). If the long tap state is not continuous (No at step S310), in other words, if a user's finger has been released from the screen or if the touch detection position is out of the second adjustment region TA2, the process returns to the illumination control processing illustrated in FIG. 20, thereby transitioning to a standby state (step S101). Accordingly, the current vertical diffusion degree display value Sy is finalized with the current vertical diffusion degree display value Sy being reflected in the control state of the vertical diffusion degree of the illumination device 1.

If the long tap state is continuous (Yes at step S310), the process returns to the processing at step S305. When the following conditions are satisfied: the long tap state is continuous (Yes at step S310), the magnitude |ΔSy| of the vertical diffusion degree difference value ΔSy is smaller than the magnitude |LSCy| of the vertical diffusion degree coarse adjustment scale setting value LSCy (No at step S311), and the sign of the vertical diffusion degree difference value ΔSy is “−(negative value)” (No at step S341 in FIG. 26), the processing at steps S305 to S310 including the above-described vertical diffusion degree fine adjustment processing (step S340; FIG. 26) is repeatedly executed at intervals of the predetermined setting value change time (second time threshold) T2th. Accordingly, the vertical diffusion degree display value Sy is finely adjusted in steps of the vertical diffusion degree fine adjustment scale setting value SSCy (second adjustment interval) in a direction in which the vertical diffusion degree display value Sy decreases.

Thereafter, if the magnitude |ΔSy| of the vertical diffusion degree difference value ΔSy becomes smaller than the magnitude |SSCy| of the vertical diffusion degree fine adjustment scale setting value SSCy (Yes at step S309) and the long tap state is canceled (No at step S310), the current vertical diffusion degree display value Sy is finalized with the current vertical diffusion degree display value Sy being reflected in the control state of the vertical diffusion degree of the illumination device 1 in a state in which the Y-direction touch position detection value y′0 in the second adjustment region TA2 matches or substantially matches the Y-direction position display value y0 of the light distribution shape object OBJ (y′0≈y0).

Through the above-described vertical diffusion degree adjustment processing according to the first embodiment, the vertical diffusion degree coarse adjustment processing (FIG. 25) of performing adjustment by a vertical diffusion degree coarse adjustment scale (first adjustment interval) or the vertical diffusion degree fine adjustment processing (FIG. 26) of performing adjustment by a vertical diffusion degree fine adjustment scale (second adjustment interval) is executed in accordance with the touch detection position in the Y direction detected while the user maintains the long tap state in the second adjustment region TA2 on the illumination control application screen 400. Specifically, when the difference (vertical diffusion degree difference value ΔSy) between the target vertical diffusion degree Sy′ and the vertical diffusion degree display value Sy is equal to or larger than the vertical diffusion degree coarse adjustment scale (first adjustment interval) (Yes at step S311 in FIG. 24), the vertical diffusion degree coarse adjustment processing (FIG. 25) is executed. When the difference (vertical diffusion degree difference value ΔSy) between the target vertical diffusion degree Sy′ and the vertical diffusion degree display value Sy is smaller than the vertical diffusion degree coarse adjustment scale (first adjustment interval) (No at step S311 in FIG. 24), the vertical diffusion degree fine adjustment processing (FIG. 26) is executed. For example, when the difference (vertical diffusion degree difference value ΔSy) between the target vertical diffusion degree Sy′ and the vertical diffusion degree display value Sy becomes smaller than the vertical diffusion degree coarse adjustment scale (first adjustment interval) through the vertical diffusion degree coarse adjustment processing (FIG. 25) (No at step S311 in FIG. 24), the process seamlessly transitions to the vertical diffusion degree fine adjustment processing (FIG. 26).

When the user performs a swipe operation while maintaining the long tap state in the second adjustment region TA2 on the illumination control application screen 400, the vertical diffusion degree coarse adjustment processing (FIG. 25) and the vertical diffusion degree fine adjustment processing (FIG. 26) seamlessly transition to each other. For example, when the difference (vertical diffusion degree difference value ΔSy) between the target vertical diffusion degree Sy′ and the vertical diffusion degree display value Sy becomes equal to or larger than the vertical diffusion degree coarse adjustment scale (first adjustment interval) through a swipe operation after the vertical diffusion degree fine adjustment processing (FIG. 26) is executed (Yes at step S311 in FIG. 24), the process seamlessly transitions to the vertical diffusion degree coarse adjustment processing (FIG. 25). For example, when the difference (vertical diffusion degree difference value ΔSy) between the target vertical diffusion degree Sy′ and the vertical diffusion degree display value Sy becomes smaller than the vertical diffusion degree coarse adjustment scale (first adjustment interval) through a swipe operation after the vertical diffusion degree coarse adjustment processing (FIG. 25) is executed (No at step S311 in FIG. 24), the process seamlessly transitions to the vertical diffusion degree fine adjustment processing (FIG. 26).

More specifically, when the magnitude |ΔSy| of the vertical diffusion degree difference value ΔSy becomes equal to or larger than the magnitude |LSCy| of the vertical diffusion degree coarse adjustment scale setting value LSCy (|ΔSy| |LSCy|; Yes at step S311 in FIG. 24), the vertical diffusion degree display value Sy corresponding to the Y-direction position display value y0 of the light distribution shape object OBJ is coarsely adjusted in a direction in which the vertical diffusion degree display value Sy approaches the target vertical diffusion degree Sy′ corresponding to the Y-direction touch position detection value y′0. When the magnitude |ΔSy| of the vertical diffusion degree difference value ΔSy becomes smaller than the magnitude |LSCy| of the vertical diffusion degree coarse adjustment scale setting value LSCy (|ΔSy|<|LSCy|; No at step S311 in FIG. 24), the vertical diffusion degree display value Sy corresponding to the Y-direction position display value y0 of the light distribution shape object OBJ is finely adjusted in a direction in which the vertical diffusion degree display value Sy approaches the target vertical diffusion degree Sy′ corresponding to the Y-direction touch position detection value y′0.

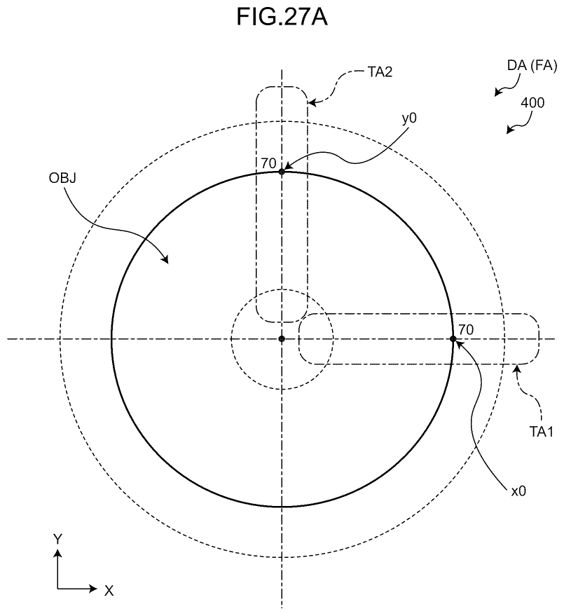

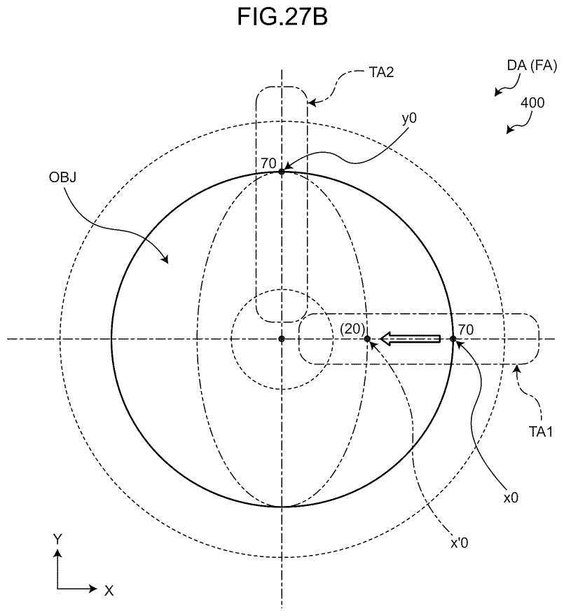

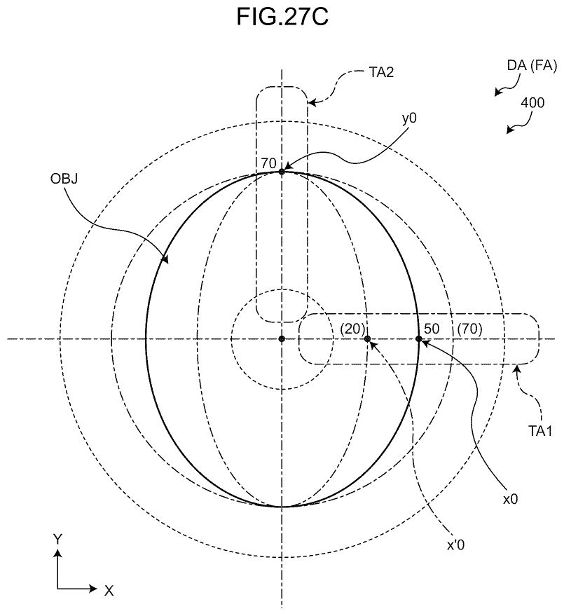

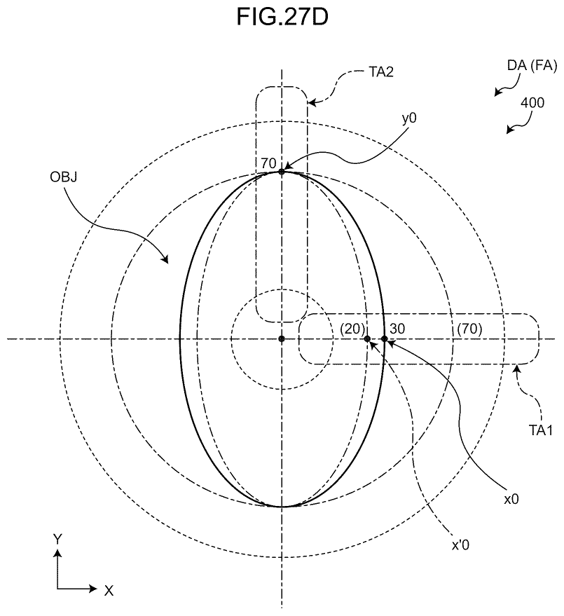

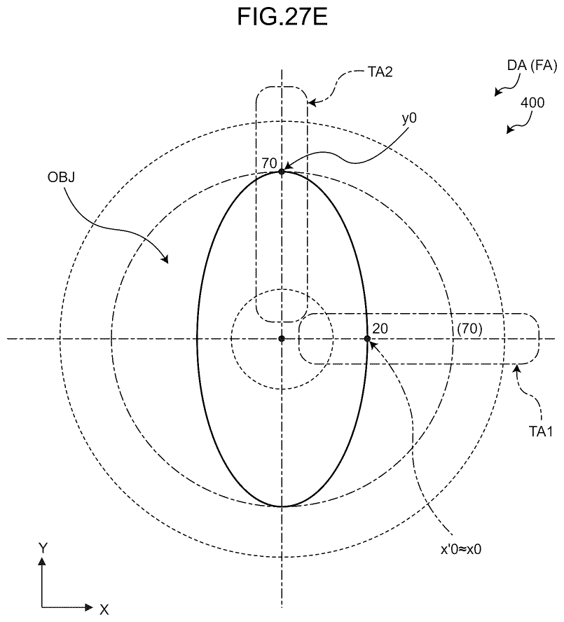

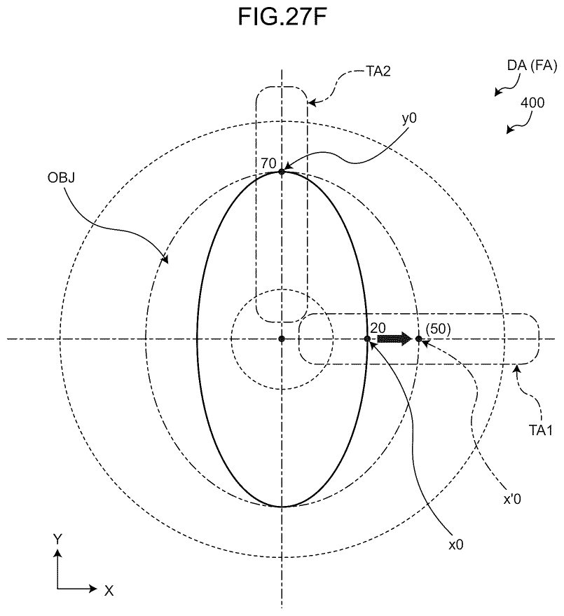

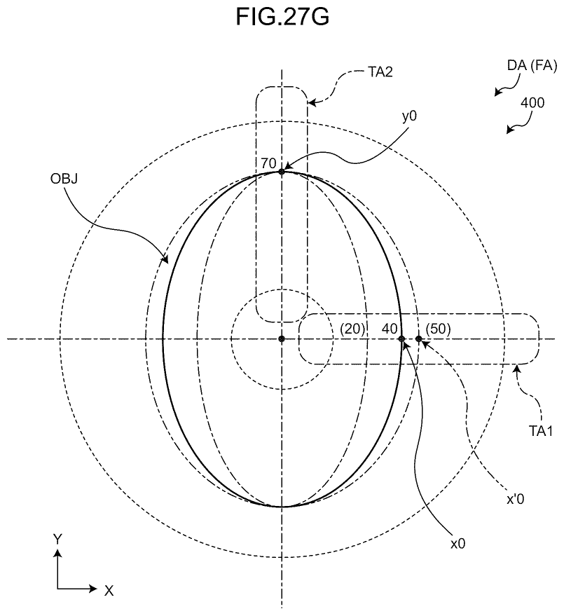

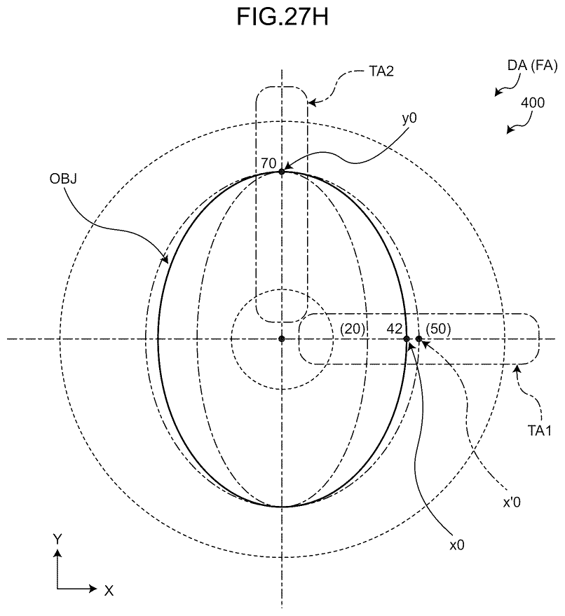

The following describes specific examples of operation on the illumination control application screen 400 of the control device 200 according to the first embodiment. FIGS. 27A, 27B, 27C, 27D, 27E, 27F, 27G, and 27H are diagrams illustrating specific operation examples on the illumination control application screen 400 of the control device 200 according to the first embodiment. Operation of the horizontal diffusion degree adjustment processing is exemplarily described below.

FIG. 27A illustrates an example in which the horizontal diffusion degree display value Sx and the vertical diffusion degree display value Sy are both 70(%) in the standby state (step S101) in FIG. 20. FIG. 27B illustrates an example in which in the standby state illustrated in FIG. 27A, a touch in the first adjustment region TA1 is detected (Yes at step S102 in FIG. 20), transition is made to the horizontal diffusion degree adjustment processing illustrated in FIG. 21 and the long tap state is reached (step S204), and the X-direction touch position detection value x′0 corresponding to the target horizontal diffusion degree Sx′=20(%) is detected in the first adjustment region TA1. In this state, the horizontal diffusion degree difference value ΔSx is −50(%) (ΔSx=Sx′(=20(%))−Sx(=70(%))=−50(%)), the magnitude |ΔSx (=−50(%))| of the horizontal diffusion degree difference value ΔSx is equal to or larger than the magnitude |LSCx (=20(%))| of the horizontal diffusion degree coarse adjustment scale setting value LSCx (|ΔSx|≥|LSCx|; Yes at step S211 in FIG. 21), and the sign of the horizontal diffusion degree difference value ΔSx(=−50(%)) is “− (negative value)” (No at step S221 in FIG. 22). Accordingly, the horizontal diffusion degree of the illumination device 1 is coarsely adjusted in a direction in which the horizontal diffusion degree decreases (arrow direction illustrated in FIG. 27B) until the magnitude |ΔSx| of the horizontal diffusion degree difference value ΔSx becomes smaller than the magnitude |LSCx (=20(%))| of the horizontal diffusion degree coarse adjustment scale setting value LSCx (No at step S211 in FIG. 21).

Specifically, first, in the first cycle of the processing at steps S205 to S210 in the horizontal diffusion degree adjustment processing illustrated in FIG. 21, the X-direction position display value x0 of the light distribution shape object OBJ becomes a position corresponding to the horizontal diffusion degree display value Sx=50(%) as illustrated in FIG. 27C when the count value T2 of the second timer exceeds the predetermined setting value change time (second time threshold) T2th (for example, 0.5 (sec)) (Yes at step S229 in FIG. 22). In the processing of the second cycle, the X-direction position display value x0 of the light distribution shape object OBJ becomes a position corresponding to the horizontal diffusion degree display value Sx=30(%) as illustrated in FIG. 27D.

Then, in the processing of the third cycle, when the horizontal diffusion degree difference value ΔSx becomes −10(%) (ΔSx=Sx′ (=20(%))−Sx(=30(%))=−10(%)) and the magnitude |ΔSx(=−10(%))| of the horizontal diffusion degree difference value ΔSx becomes smaller than the magnitude |LSCx (=20(%))| of the horizontal diffusion degree coarse adjustment scale setting value LSCx (|ΔSx|<|LSCxl; No at step S211 in FIG. 21), the horizontal diffusion degree of the illumination device 1 is finely adjusted in a direction in which the horizontal diffusion degree decreases (arrow direction illustrated in FIG. 27B) until the magnitude |ΔSx| of the horizontal diffusion degree difference value ΔSx becomes smaller than the magnitude |SSCx (=1(%))| of the horizontal diffusion degree fine adjustment scale setting value SSCx (Yes at step S209 in FIG. 21) as illustrated in FIG. 27E. Accordingly, the X-direction touch position detection value x′0 corresponding to the target horizontal diffusion degree Sx′ and the X-direction position display value x0 of the light distribution shape object OBJ become substantially the same (x′0≈x0).

FIG. 27F illustrates an example in which, thereafter, the user performs a swipe operation in the first adjustment region TA1 while the long tap state is maintained (Yes at step S210 in FIG. 21). More specifically, FIG. 27F illustrates an example in which the X-direction touch position detection value x′0 in the first adjustment region TA1 is updated through the swipe operation, the magnitude ΔSx| of the horizontal diffusion degree difference value ΔSx becomes equal to or larger than the magnitude |LSCx(=20(%))| of the horizontal diffusion degree coarse adjustment scale setting value LSCx (|ΔSx| |LSCxl; Yes at step S211 in FIG. 21), and the X-direction touch position detection value x′0 corresponding to the target horizontal diffusion degree Sx′=50(%) is detected in the first adjustment region TA1 (the swipe operation by the user has stopped at the X-direction touch position detection value x′0). In this state, the horizontal diffusion degree difference value ΔSx is 30(%) (ΔSx=Sx′ (=50(%))−Sx (=20(%))=30(%)), the magnitude |ΔSx(=30(%))| of the horizontal diffusion degree difference value ΔSx is equal to or larger than the magnitude |LSCx (=20(%))| of the horizontal diffusion degree coarse adjustment scale setting value LSCx (|ΔSx|≥|LSCx|; Yes at step S211 in FIG. 21), and the sign of the horizontal diffusion degree difference value ΔSx(=30(%)) is “+(positive value)” (Yes at step S221 in FIG. 22). Accordingly, the horizontal diffusion degree of the illumination device 1 is coarsely adjusted in a direction in which the horizontal diffusion degree increases (arrow direction illustrated in FIG. 27F) until the magnitude |ΔSx| of the horizontal diffusion degree difference value ΔSx becomes smaller than the magnitude |LSCx (=20(%))| of the horizontal diffusion degree coarse adjustment scale setting value LSCx (No at step S211 in FIG. 21).

Specifically, first, in the first cycle of the processing at steps S205 to S210 in the horizontal diffusion degree adjustment processing illustrated in FIG. 21, the X-direction position display value x0 of the light distribution shape object OBJ becomes a position corresponding to the horizontal diffusion degree display value Sx=40(%) as illustrated in FIG. 27G when the count value T2 of the second timer exceeds the predetermined setting value change time (second time threshold) T2th (for example, 0.5 (sec)) (Yes at step S244 in FIG. 21).

Then, in the processing of the second cycle, when the horizontal diffusion degree difference value ΔSx becomes 10(%) (ΔSx=Sx′ (=50(%))−Sx(=40(%))=10(%)) and the magnitude |ΔSx(=10(%))| of the horizontal diffusion degree difference value ΔSx becomes smaller than the magnitude |LSCx (=20(%))| of the horizontal diffusion degree coarse adjustment scale setting value LSCx (|ΔSx|<|LSCx|), the horizontal diffusion degree of the illumination device 1 is finely adjusted in a direction in which the horizontal diffusion degree increases (arrow direction illustrated in FIG. 27F). FIG. 27H illustrates an example in which the user has released a finger from the screen at the point in time when the X-direction position display value x0 of the light distribution shape object OBJ becomes a position corresponding to the horizontal diffusion degree display value Sx=42(%) before the X-direction position display value x0 of the light distribution shape object OBJ becomes substantially the same as the X-direction touch position detection value x′0 corresponding to the target horizontal diffusion degree Sx′ (No at step S210 in FIG. 21). Accordingly, the current horizontal diffusion degree display value Sx=42(%) is finalized with the current horizontal diffusion degree display value Sx being reflected in the control state of the horizontal diffusion degree of the illumination device 1.

If the long tap state is continuously maintained at the position (X-direction touch position detection value x′0) corresponding to the target horizontal diffusion degree Sx′=50(%) until the magnitude |ΔSx| of the horizontal diffusion degree difference value ΔSx becomes smaller than the magnitude |SSCx (=1(%))| of the horizontal diffusion degree fine adjustment scale setting value SSCx (Yes at step S209 in FIG. 21), the horizontal diffusion degree of the illumination device 1 is finely adjusted in a direction in which the horizontal diffusion degree increases (arrow direction illustrated in FIG. 27F) until the magnitude |ΔSx| of the horizontal diffusion degree difference value ΔSx becomes smaller than the magnitude |SSCx (=1(%))| of the horizontal diffusion degree fine adjustment scale setting value SSCx (Yes at step S209 in FIG. 21). Accordingly, the X-direction touch position detection value x′0 corresponding to the target horizontal diffusion degree Sx′ (=50(%)) and the X-direction position display value x0 of the light distribution shape object OBJ become the same or substantially the same (x′0≈x0). In this state, when the user has released a finger from the screen (No at step S210 in FIG. 21), the current horizontal diffusion degree display value Sx=50(%) is finalized with the current horizontal diffusion degree display value Sx being reflected in the control state of the horizontal diffusion degree of the illumination device 1.

In the control device 200 for the illumination device 1 according to the first embodiment described above, the horizontal diffusion degree display value Sx is adjusted in steps of the horizontal diffusion degree coarse adjustment scale setting value LSCx (first adjustment interval) when the horizontal diffusion degree difference value ΔSx, which is the difference between the target horizontal diffusion degree Sx′ defined by the X-direction touch position detection value x′0 in the first adjustment region TA1 and the horizontal diffusion degree display value Sx, is equal to or larger than the horizontal diffusion degree coarse adjustment scale setting value LSCx (first adjustment interval). The horizontal diffusion degree display value Sx is adjusted in steps of the horizontal diffusion degree fine adjustment scale setting value SSCx (second adjustment interval), which is smaller than the horizontal diffusion degree coarse adjustment scale setting value LSCx (first adjustment interval), when the horizontal diffusion degree difference value ΔSx is smaller than the horizontal diffusion degree coarse adjustment scale setting value LSCx (first adjustment interval).

Detection of the X-direction touch position detection value x′0 for defining the target horizontal diffusion degree Sx′ is started when the continuation time T1 of a touch in the first adjustment region TA1 has exceeded the predetermined long tap detection time (first time threshold) T1th. The horizontal diffusion degree display value Sx is adjusted at intervals of the predetermined setting value change time (second time threshold) T2th while the touch in the first adjustment region TA1 is continuous.

Accordingly, for example, while adjustment is performed by the horizontal diffusion degree fine adjustment scale (second adjustment interval) at intervals of the setting value change time (second time threshold) T2th, when the user releases a finger from the screen at a timing at which a desired horizontal diffusion degree display value Sx is obtained, the current horizontal diffusion degree display value Sx is finalized with the current horizontal diffusion degree display value Sx being reflected in the control state of the horizontal diffusion degree of the illumination device 1. Thus, a desired horizontal diffusion degree display value Sx can be easily obtained, which facilitates fine adjustment of the horizontal diffusion degree display value Sx.

In the control device 200 for the illumination device 1 according to the first embodiment described above, the vertical diffusion degree display value Sy is adjusted in steps of the vertical diffusion degree coarse adjustment scale setting value LSCy (first adjustment interval) when the vertical diffusion degree difference value ΔSy, which is the difference between the target vertical diffusion degree Sy′ defined by the Y-direction touch position detection value y′0 in the second adjustment region TA2 and the vertical diffusion degree display value Sy, is equal to or larger than the vertical diffusion degree coarse adjustment scale setting value LSCy (first adjustment interval). The vertical diffusion degree display value Sy is adjusted in steps of the vertical diffusion degree fine adjustment scale setting value SSCy (second adjustment interval), which is smaller than the vertical diffusion degree coarse adjustment scale setting value LSCy (first adjustment interval), when the vertical diffusion degree difference value ΔSy is smaller than the vertical diffusion degree coarse adjustment scale setting value LSCy (first adjustment interval).

Detection of the Y-direction touch position detection value y′0 for defining the target vertical diffusion degree Sy′ is started when the continuation time T1 of a touch in the second adjustment region TA2 has exceeded the predetermined long tap detection time (first time threshold) T1th. The vertical diffusion degree display value Sy is adjusted at intervals of the predetermined setting value change time (second time threshold) T2th while the touch in the second adjustment region TA2 is continuous.

Accordingly, for example, while adjustment is performed by the vertical diffusion degree fine adjustment scale (second adjustment interval) at intervals of the setting value change time (second time threshold) T2th, when the user releases a finger from the screen at a timing at which a desired vertical diffusion degree display value Sy is obtained, the current vertical diffusion degree display value Sy is finalized with the current vertical diffusion degree display value Sy being reflected in the control state of the horizontal diffusion degree of the illumination device 1. Thus, a desired vertical diffusion degree display value Sy can be easily obtained, which facilitates fine adjustment of the vertical diffusion degree display value Sy.

### Second Embodiment

The following describes configurations and operation for controlling the light diffusion degree of an illumination device 1a in a control device 200a of an illumination system according to a second embodiment. In the following description, configurations and operation different from those in the first embodiment will be described, and duplicate description is omitted in some cases.

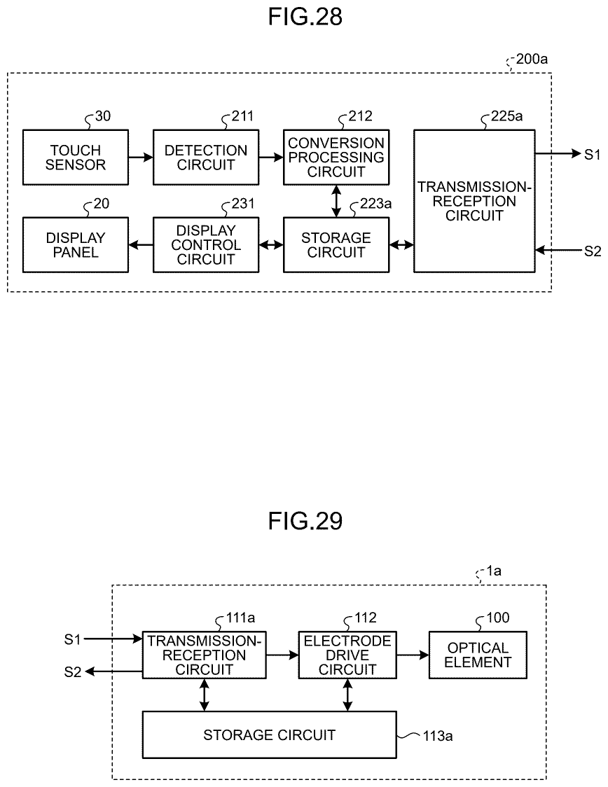

FIG. 28 is a diagram illustrating an example of a control block configuration of the control device 200a according to the second embodiment.

Various parameter values and various setting values that are necessary for operation of an illumination control application according to the second embodiment to be described later are stored in a storage region of a storage circuit 223a according to the second embodiment. The various parameter values and various setting values that are necessary for operation of the illumination control application according to the second embodiment will be described later.

A transmission-reception circuit 225a transmits and receives setting information to and from the illumination device 1a. Specifically, the transmission-reception circuit 225a transmits a light diffusion degree S1 to the illumination device 1a as first setting information in each processing to be described later. The transmission-reception circuit 225a receives second light diffusion degree information (light diffusion degree S2) transmitted from the illumination device 1a.

FIG. 29 is a diagram illustrating an example of a control block configuration of the illumination device 1a according to the second embodiment.

A transmission-reception circuit 111a transmits and receives light diffusion degree information to and from the control device 200a. Specifically, the transmission-reception circuit 111a receives first light diffusion degree information (light diffusion degree S1) transmitted from the control device 200a. The transmission-reception circuit iiia transmits the light diffusion degree S2 stored in a storage circuit 113a to the control device 200a as the second light diffusion degree information.

In the present disclosure, upon activation of the illumination device 1a, the transmission-reception circuit 111a transmits the light diffusion degree S2 stored in the storage circuit 113a to the control device 200a as the second light diffusion degree information and stores, in the storage circuit 113a as the new light diffusion degree S2, the first light diffusion degree information (light diffusion degree S1) transmitted from the control device 200a by each processing of the control device 200a to be described later. In other words, when the first light diffusion degree information is transmitted from the control device 200a to the illumination device 1a, the second light diffusion degree information is updated to the first light diffusion degree information. The illumination device 1a initially does not store the second light diffusion degree information. In this case, the first light diffusion degree information is transmitted from the control device 200a, whereby the second light diffusion degree information is stored.

The following describes specific examples of processing and display aspects of the illumination control application that operates on the control device 200a according to the second embodiment in detail.

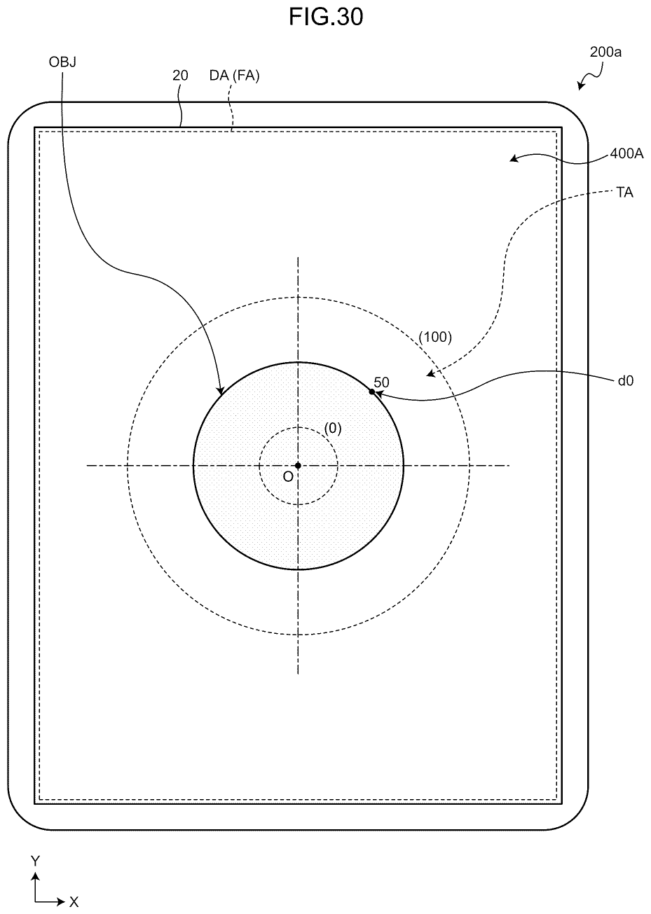

FIG. 30 is a conceptual diagram illustrating an example of the display aspect of an illumination control application screen 400A on the control device 200a according to the second embodiment.

When the illumination control application is activated, the illumination control application screen 400A (adjustment screen) illustrated in FIG. 30 is displayed and pairing processing is executed between the control device 200a and the illumination device 1a registered as a control target device of the control device 200a in advance. A pairing button (not illustrated) may be displayed on the illumination control application screen 400A, and pairing processing may be executed between the control device 200a and the illumination device 1a when the pairing button is touched by a user. At initial activation of the illumination control application, for example, the illumination device 1a activated in a space where pairing is possible may be registered as a control target device.

On the illumination control application screen 400A illustrated in FIG. 30, the X direction is defined as the Dx direction (first direction) in light diffusion degree control of the illumination device 1a, and the Y direction is defined as the Dy direction (second direction) in light diffusion degree control of the illumination device 1a. An XY plane with an origin O(0, 0) at a predetermined position in the display region DA is defined on the illumination control application screen 400A.

The display panel 20 is provided with the display region DA overlapping the detection region FA of the touch sensor 30 in a plan view. In the example illustrated in FIG. 30, a light distribution shape object OBJ having a substantially circular shape with a center point at the origin O(0, 0) of the XY plane on the illumination control application screen 400A is displayed.

In the configuration according to the second embodiment, the shape of the light distribution shape object OBJ on the illumination control application screen 400A changes concentrically in accordance with the diffusion degree.

In the second embodiment, as illustrated in FIG. 30, an adjustment region TA is provided as a region in which the touch detection position for setting the diffusion degree can be acquired. The adjustment region TA is set as a region where the circular light distribution shape is adjustable in the entire range of a minimum value (0(%)) to a maximum value (100(%)). Specifically, in the second embodiment, the adjustment region TA is set to a region between the small and large circles, which is constituted with dotted lines in FIG. 30.

Touch position detection is enabled in the adjustment region TA between the position on the outline of the light distribution shape object OBJ in a case where the diffusion degree is 0(%) (small dotted circle in the drawing) and the position on the outline of the light distribution shape object OBJ in a case where the diffusion degree is 100(%) (large dotted circle in the drawing). In the second embodiment, the diffusion degree in the X and Y directions can be simultaneously adjusted to values that are identical to each other, by detecting the touch position in the adjustment region TA.

On the illumination control application screen 400A of the control device 200a according to the second embodiment, the diffusion degree of the illumination device 1a can be set by a virtual position d0 on the outline of the substantially circular light distribution shape object OBJ.

In the second embodiment, the position d0 on the display region DA in the adjustment region TA is a virtual position on the outline of the light distribution shape object OBJ and corresponding to the diffusion degree of the illumination device 1 in the X and Y directions. In FIG. 30, “50” displayed near the virtual position d0 on the display region DA indicates the diffusion degree (50(%)) of the illumination device 1 in the X and Y directions. The shape of the light distribution shape object OBJ concentrically changes with movement of the virtual position d0 in the display region DA in the adjustment region TA. The virtual position d0 on the display region DA in the adjustment region TA is defined by, for example, distance from the origin O of the XY plane. The relation between the virtual position d0 on the display region DA in the adjustment region TA and a diffusion degree S may be calculated by using an expression, or the correspondence relation between the virtual position d0 and the diffusion degree S may be stored in the storage circuit 223a. The following exemplarily describes an aspect in which the virtual position d0 and the diffusion degree S are mutually calculated by using an expression.

In the present embodiment, the diffusion degree S is a value corresponding to the distance from the origin O(0, 0) of the XY plane on the illumination control application screen 400A to the virtual position d0 on the display region DA in the adjustment region TA. The user can change the size of the light distribution shape by touching the screen with a finger in the adjustment region TA, and the size of the light distribution shape object OBJ is determined based on a distance √(Xa²+Ya²) from the origin O(0, 0) to the touch detection position, where the coordinate of the finger is represented by (Xa, Ya). For example, in a case where the distance √(Xa²+Ya²) from the origin O(0, 0) to the touch detection position corresponds to a diffusion degree equivalent to 50(%), the light distribution shape is a circular shape corresponding to a diffusion degree equivalent to 50(%) when the touch detection position on the detection region FA and the virtual position d0 on the display region DA coincide with each other by diffusion degree adjustment processing according to the second embodiment.

In the second embodiment, when having detected continuation of a touch in the adjustment region TA on the illumination control application screen 400A described above, the control device 200a transitions to diffusion degree adjustment processing. Hereinafter, continuation of a touch in the adjustment region TA is also referred to as a “long tap state”.

In the second embodiment, the “long tap state” means a state in which a continuation time T1 of a touch in the adjustment region TA has exceeded a predetermined long tap detection time (first time threshold) T1th (for example, 2 (sec)).

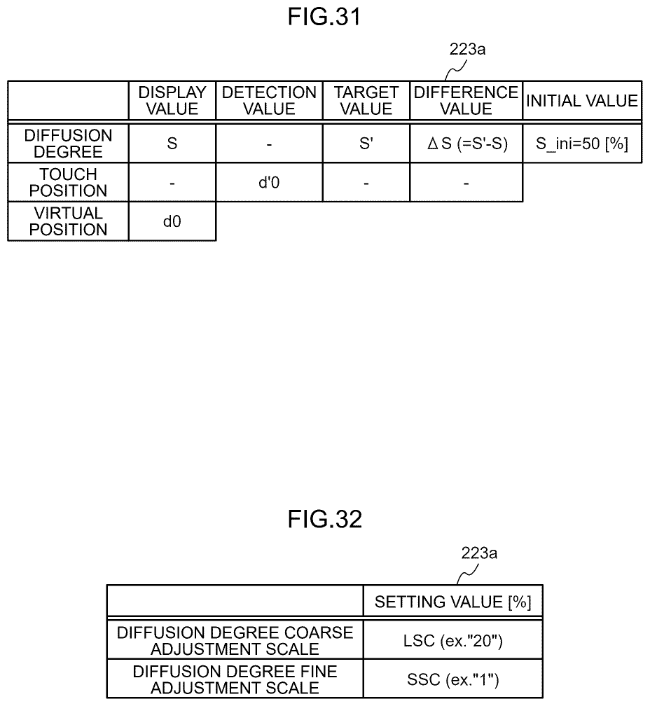

FIG. 31 is a conceptual diagram illustrating an example of a first storage region of the storage circuit 223a in the control device 200a for the illumination device 1a according to the second embodiment. FIG. 32 is a conceptual diagram illustrating an example of a second storage region of the storage circuit 223a in the control device 200a for the illumination device 1a according to the second embodiment. The first storage region stores various parameter values (variables) that are necessary for operation of the illumination control application. The second storage region of the storage circuit 223a stores various setting values of the illumination control application.

In the second embodiment, as illustrated in FIG. 31, the first storage region of the storage circuit 223a stores a diffusion degree display value S on the illumination control application screen 400A, and a virtual position display value d0 of the light distribution shape object OBJ. The diffusion degree display value S indicates a current diffusion degree of the illumination device 1a, which is defined by the virtual position display value d0 of the light distribution shape object OBJ. The first storage region also stores a touch position detection value d′0 in the adjustment region TA, which is detected in illumination control processing according to the second embodiment to be described later, a target diffusion degree S′ calculated based on the touch position detection value d′0, and a diffusion degree difference value ΔS that is the difference value between the target diffusion degree S′ and the diffusion degree display value S. The target diffusion degree S′ is a value calculated from the touch position detection value d′0 in the adjustment region TA or derived based on the correspondence relation. In other words, the target diffusion degree S′ is a value defined by the touch position detection value d′0 in the adjustment region TA.

The horizontal diffusion degree of the illumination device 1a is changed at different adjustment scales in accordance with the magnitude of the diffusion degree difference value ΔS, which is calculated at intervals of the predetermined setting value change time (second time threshold) T2th (for example, 0.5 (sec)) in the illumination control processing according to the second embodiment to be described later.

In the second embodiment, as illustrated in FIG. 32, the second storage region of the storage circuit 223a stores a diffusion degree coarse adjustment scale setting value LSC (first adjustment interval) and a diffusion degree fine adjustment scale setting value SSC (second adjustment interval).

The diffusion degree coarse adjustment scale setting value LSC is set to, for example, 20(%). The diffusion degree fine adjustment scale setting value SSC is set to, for example, 1(%). These adjustment scales are exemplary and not limited to the above description. For example, the diffusion degree coarse adjustment scale setting value LSC may be set to, for example, 10(%) or 30(%), and the diffusion degree fine adjustment scale setting value SSC may be set to, for example, 0.5(%) or 2(%). In the second embodiment, the diffusion degree fine adjustment scale setting value SSC (second adjustment interval) only needs to be an interval (step size) smaller than the diffusion degree coarse adjustment scale setting value LSC (first adjustment interval). The diffusion degree coarse adjustment scale setting value LSC and the diffusion degree fine adjustment scale setting value SSC may be values that the user can set on the illumination control application.

The following describes specific examples of processing by the control device 200a for the illumination device 1a according to the second embodiment described above.

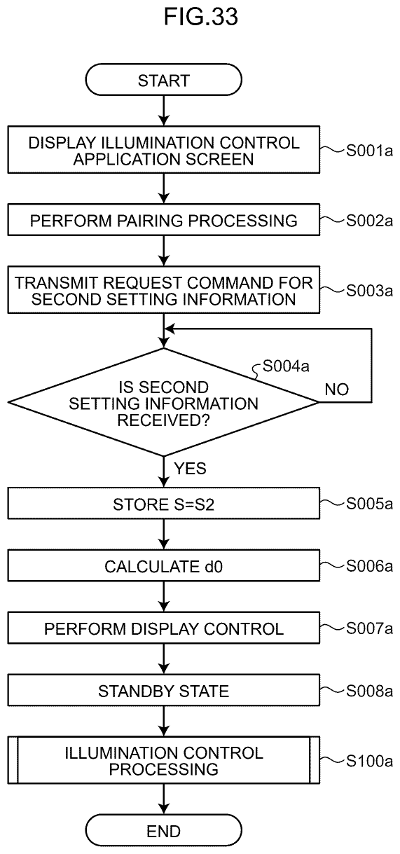

Processing during execution of the above-described illumination control application is achieved by application software executed by, for example, the CPU of a smartphone, a tablet, or the like constituting the control device 200a. FIG. 33 is a flowchart illustrating an example of initial setting processing by the control device 200a for the illumination device 1a according to the second embodiment.

When the illumination control application is activated on the control device 200a, an illumination control application screen 400a illustrated in FIG. 30 is displayed on the display region DA (step S001a).

Before activation of the illumination control application, the illumination device 1a registered in advance in a space where pairing with the control device 200a is possible, is activated.

The transmission-reception circuit 225 of the control device 200a executes pairing processing with the illumination device 1a registered as a control target device in advance and activated in a space where pairing with the control device 200a is possible (step S002a), and transmits a request command for the second setting information to the control target device (illumination device 1) (step S003a).

The transmission-reception circuit 111a of the illumination device 1a reads the second setting information stored in the storage circuit 113a and transmits the second setting information to the control device 200a. The electrode drive circuit 112 of the illumination device 1a supplies drive voltage corresponding to the second setting information to the drive electrodes 10 and 13 of each liquid crystal cell 2 of the optical element 100.

The transmission-reception circuit 225a of the control device 200a determines whether the second setting information is received from the illumination device 1a (step S004a). If the second setting information is not received from the illumination device 1a (No at step S004a), the processing at step S004a is repeatedly executed.

If the second setting information is received from the illumination device 1a (Yes at step S004a), the transmission-reception circuit 225a stores the light diffusion degree S2 in the second setting information of the illumination device 1a in the first storage region of the storage circuit 223a illustrated in FIG. 31 as the diffusion degree display value S (step S005a).

A diffusion degree initial value S_ini (for example, 50(%)) is stored in the first storage region. For example, after the initial activation of the illumination device 1a or after the illumination device 1a activated in a space where pairing is possible is registered as a control target device, the following processing may be performed in which, in place of the above-described processing at steps S003a to S005a, the diffusion degree initial value S_ini (for example, 50(%) illustrated in FIG. 31) is set as the diffusion degree display value S, and the diffusion degree display value S is transmitted as the first setting information (S1) to the registered illumination device 1a. In this case, the transmission-reception circuit 111a of the illumination device 1a stores, in the storage circuit 113a, the first setting information (S1) received from the control device 200a as the second setting information (S2). In addition, the electrode drive circuit 112 of the illumination device 1a supplies drive voltage corresponding to the second setting information to the drive electrodes 10 and 13 of each liquid crystal cell 2 of the optical element 100.

The control device 200a calculates the virtual position display value d0 on the outline of the light distribution shape object OBJ based on the diffusion degree display value S stored in the first storage region of the storage circuit 223a (step S006a), and stores the virtual position display value d0 in the first storage region.

The display control circuit 231 of the control device 200a reflects the diffusion degree display value S and the virtual position display value d0 on the outline of the light distribution shape object OBJ, which are acquired in the above-described processing and stored in the first storage region of the storage circuit 223a, to display control on the illumination control application screen 400A (step S007a).

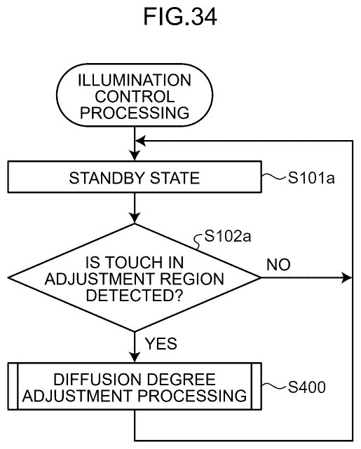

After the processing up to step S007a ends, the process transitions to a standby state (step S008a), thereby transitioning the illumination control processing illustrated in FIG. 34 (step S100a). FIG. 34 is a flowchart illustrating an example of the overall flow of the illumination control processing by the control device 200a for the illumination device 1a according to the second embodiment.

In the standby state illustrated in FIG. 34 (step S101a), the control device 200a executes touch detection processing in the adjustment region TA (step S102a).

Specifically, for example, if no touch is detected in the adjustment region TA (No at step S102a), the control device 200a returns to the standby state at step S101a to repeatedly execute the processing at steps S101a to S102a.

The execution interval of the processing at steps S101a to S102a is, for example, 10 (ms).

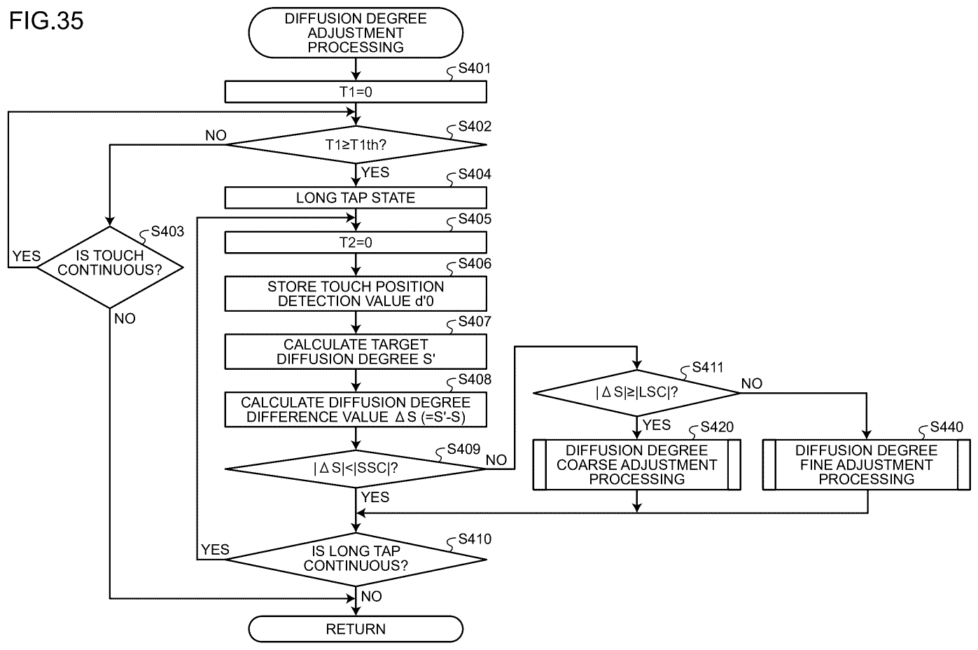

If a touch is detected in the adjustment region TA (Yes at step S102a), transition is made to diffusion degree adjustment processing illustrated in FIG. 35 (step S400).

FIG. 35 is a flowchart illustrating an example of the diffusion degree adjustment processing by the control device 200a for the illumination device 1a according to the second embodiment.

After having transitioned to the diffusion degree adjustment processing illustrated in FIG. 35, the control device 200a resets a count value T1 of a first timer that counts the continuation time of a touch in the adjustment region TA (T1=0; step S401).

Subsequently, the control device 200a determines whether the count value T1 of the first timer has exceeded a predetermined long tap detection time (first time threshold) T1th (for example, 2 (sec)) (step S402). The long tap detection time (first time threshold) T1th is set to, for example, 200 counts (T1th=200) when 10 (ms) is defined as one count. The long tap detection time (first time threshold) T1th is not limited to 2 (sec) (=200).

If the count value T1 of the first timer is smaller than the predetermined long tap detection time T1th (T1<T1th; No at step S402), the control device 200a subsequently determines whether the touch state in the adjustment region TA is continuous (step S403). If the touch state in the adjustment region TA is not continuous (No at step S403), in other words, if a user's finger has been released from the screen or if the touch detection position is out of the adjustment region TA, the process returns to the illumination control processing illustrated in FIG. 34, thereby transitioning to a standby state without adjustment of the control state of the diffusion degree of the illumination device 1a (step S101a).

If the touch state in the adjustment region TA is continuous (Yes at step S403), the processing at steps S402 to S403 is repeatedly executed until the count value T1 of the first timer exceeds the predetermined long tap detection time T1th (Yes at step S402).

If the count value T1 of the first timer exceeds the predetermined long tap detection time T1th (Yes at step S402), the control device 200a determines that the touch state is the long tap state (step S404), resets a count value T2 of a second timer that counts the predetermined setting value change time (second time threshold) T2th (T2=0; step S405), detects the touch position in the adjustment region TA, stores the touch position in the first storage region of the storage circuit 223a illustrated in FIG. 17 as the touch position detection value d′0 (step S406), calculates the target diffusion degree S′ corresponding to the touch position detection value d′0 (step S407), and stores the target diffusion degree S′ in the first storage region illustrated in FIG. 17. The touch position detection value d′0 in the adjustment region TA is different from the position display value d0 of the light distribution shape object OBJ.

Then, the control device 200a reads the diffusion degree display value S and the target diffusion degree S′ from the first storage region, calculates the diffusion degree difference value ΔS (ΔS=S′−S; step S408), and determines whether the magnitude |ΔS| of the diffusion degree difference value ΔS is smaller than the magnitude |SSC| of the diffusion degree fine adjustment scale setting value SSC (second adjustment interval) (step S409).

If the magnitude |ΔS| of the diffusion degree difference value ΔS is equal to or larger than the magnitude |SSC| of the diffusion degree fine adjustment scale setting value SSC (No at step S409), the control device 200a subsequently determines whether the magnitude |ΔS| of the diffusion degree difference value ΔS is equal to or larger than the magnitude |LSC| of the diffusion degree coarse adjustment scale setting value LSC (step S411).

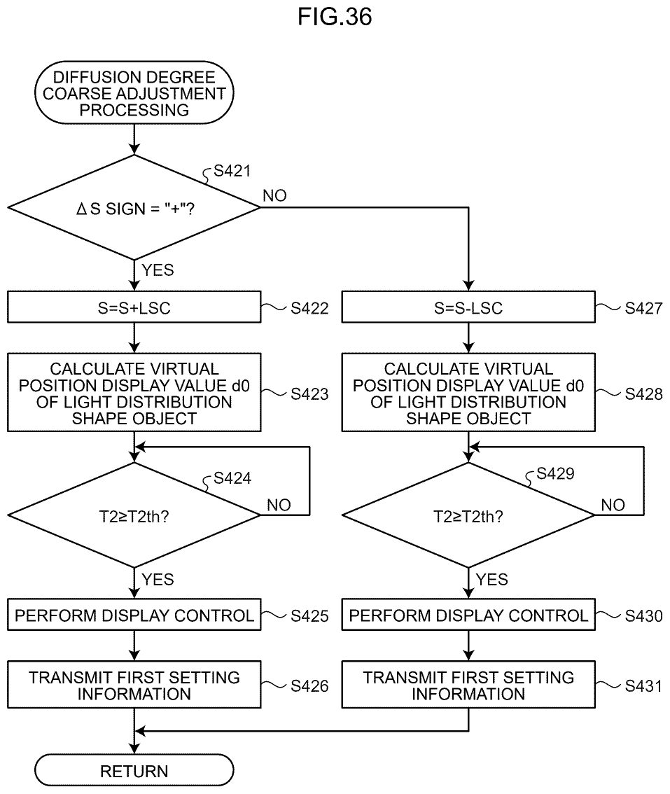

If the magnitude |ΔS| of the diffusion degree difference value ΔS is equal to or larger than the magnitude |LSC| of the diffusion degree coarse adjustment scale setting value LSC (Yes at step S411), diffusion degree coarse adjustment processing illustrated in FIG. 36 is executed. FIG. 36 is a flowchart illustrating an example of the diffusion degree coarse adjustment processing by the control device 200 of the illumination device 1a according to the second embodiment.

The control device 200a reads the sign of the diffusion degree difference value ΔS and determines the adjustment direction of the diffusion degree display value S with respect to the target diffusion degree S′. Specifically, the control device 200a determines whether the sign of the diffusion degree difference value ΔS is “+(positive value)” (step S421).

If the sign of the diffusion degree difference value ΔS is “+(positive value)” (Yes at step S421), it is indicated that the adjustment direction of the diffusion degree display value S with respect to the target diffusion degree S′ is a direction in which the diffusion degree of the illumination device 1a increases. In this case, the control device 200a adds the diffusion degree coarse adjustment scale setting value LSC (first adjustment interval) to the diffusion degree display value S (step S422), thereby updating the diffusion degree display value S. In addition, the control device 200a calculates the virtual position display value d0 of the light distribution shape object OBJ, which corresponds to the diffusion degree display value S (step S423), and stores the virtual position display value d0 in the first storage region of the storage circuit 223a illustrated in FIG. 17.

Subsequently, the control device 200a determines whether the count value T2 of the second timer has exceeded the predetermined setting value change time (second time threshold) T2th (for example, 0.5 (sec)) (step S424). The setting value change time (second time threshold) T2th is set to, for example, 50 counts (T2th=50) when 10 (ms) is defined as one count. The setting value change time (second time threshold) T2th is not limited to 0.5 (sec) (=50).

If the count value T2 of the second timer is smaller than the predetermined setting value change time T2th (T2<T2th; No at step S424), the processing at step S424 is repeatedly executed until the count value T2 of the second timer becomes equal to or larger than the predetermined setting value change time T2th (T2≥T2th; Yes at step S424). If the count value T2 of the second timer becomes equal to or larger than the predetermined setting value change time T2th (T2≥T2th; Yes at step S424), the display control circuit 231 of the control device 200a reflects the diffusion degree display value S and the virtual position display value d0 of the light distribution shape object OBJ, which are acquired in the above-described processing and stored in the first storage region of the storage circuit 223a, to display control on the illumination control application screen 400 (step S425). In addition, the transmission-reception circuit 225a of the control device 200a reads the diffusion degree display value S stored in the first storage region and transmits the read diffusion degree display value S as the first setting information (S1=S) to the illumination device 1a (step S426).

The transmission-reception circuit 111 of the illumination device 1a stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

Referring back to FIG. 35, the control device 200a determines whether the long tap state is continuous (step S410). If the long tap state is not continuous (No at step S410), in other words, if a user's finger has been released from the screen or if the touch detection position is out of the adjustment region TA, the process returns to the illumination control processing illustrated in FIG. 34, thereby transitioning to a standby state (step S101a). Accordingly, the current diffusion degree display value S is finalized with the current diffusion degree display value S being reflected in the control state of the diffusion degree of the illumination device 1a.

If the long tap state is continuous (Yes at step S410), the process returns to the processing at step S405. When the following conditions are satisfied: the long tap state is continuous (Yes at step S410), the magnitude |ΔS| of the diffusion degree difference value ΔS is equal to or larger than the magnitude |LSC| of the diffusion degree coarse adjustment scale setting value LSC (Yes at step S411), and the sign of the diffusion degree difference value ΔS is “+(positive value)” (Yes at step S421), the processing at steps S405 to S410 including the above-described diffusion degree coarse adjustment processing (step S420; FIG. 36) is repeatedly executed at intervals of the predetermined setting value change time (second time threshold) T2th until the magnitude |ΔS| of the diffusion degree difference value ΔS becomes smaller than the magnitude |LSC| of the diffusion degree coarse adjustment scale setting value LSC (No at step S411). Accordingly, the diffusion degree display value S is coarsely adjusted in steps of the diffusion degree coarse adjustment scale setting value LSC (first adjustment interval) in a direction in which the diffusion degree display value S increases.

Referring back to FIG. 36, if the sign of the diffusion degree difference value ΔS is “−(negative value)” (No at step S421), it is indicated that the adjustment direction of the diffusion degree display value S with respect to the target diffusion degree S′ is a direction in which the diffusion degree of the illumination device 1a decreases. In this case, the control device 200a subtracts the diffusion degree coarse adjustment scale setting value LSC (first adjustment interval) from the diffusion degree display value S (step S427), thereby updating the diffusion degree display value S. In addition, the control device 200a calculates the virtual position display value d0 of the light distribution shape object OBJ, which corresponds to the diffusion degree display value S (step S428), and stores the virtual position display value d0 in the first storage region of the storage circuit 223a illustrated in FIG. 17.

Subsequently, the control device 200a determines whether the count value T2 of the second timer has exceeded the predetermined setting value change time (second time threshold) T2th (for example, 0.5 (sec)) (step S429).

If the count value T2 of the second timer is smaller than the predetermined setting value change time T2th (T2<T2th; No at step S429), the processing at step S429 is repeatedly executed until the count value T2 of the second timer becomes equal to or larger than the predetermined setting value change time T2th (T2≥T2th; Yes at step S429). If the count value T2 of the second timer becomes equal to or larger than the predetermined setting value change time T2th (T2≥T2th; Yes at step S429), the display control circuit 231 of the control device 200a reflects the diffusion degree display value S and the virtual position display value d0 of the light distribution shape object OBJ, which are acquired in the above-described processing and stored in the first storage region of the storage circuit 223a, to display control on the illumination control application screen 400 (step S430). In addition, the transmission-reception circuit 225a of the control device 200a reads the diffusion degree display value S stored in the first storage region and transmits the read diffusion degree display value S as the first setting information (S1=S) to the illumination device 1a (step S431).

The transmission-reception circuit 111 of the illumination device 1a stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

Referring back to FIG. 35, the control device 200a determines whether the long tap state is continuous (step S410). If the long tap state is not continuous (No at step S410), in other words, if a user's finger has been released from the screen or if the touch detection position is out of the adjustment region TA, the process returns to the illumination control processing illustrated in FIG. 34, thereby transitioning to a standby state (step S101a). Accordingly, the current diffusion degree display value S is finalized with the current diffusion degree display value S being reflected in the control state of the diffusion degree of the illumination device 1a.

If the long tap state is continuous (Yes at step S410), the process returns to the processing at step S405. When the following conditions are satisfied: the long tap state is continuous (Yes at step S410), the magnitude |ΔS| of the diffusion degree difference value ΔS is equal to or larger than the magnitude |LSC| of the diffusion degree coarse adjustment scale setting value LSC (Yes at step S411), and the sign of the diffusion degree difference value ΔS is “− (negative value)” (No at step S421 in FIG. 36), the processing at steps S405 to S410 including the above-described diffusion degree coarse adjustment processing (step S420; FIG. 36) is repeatedly executed at intervals of the predetermined setting value change time (second time threshold) T2th until the magnitude |ΔS| of the diffusion degree difference value ΔS becomes smaller than the magnitude |LSC| of the diffusion degree coarse adjustment scale setting value LSC (No at step S411). Accordingly, the diffusion degree display value S is coarsely adjusted in steps of the diffusion degree coarse adjustment scale setting value LSC (first adjustment interval) in a direction in which the diffusion degree display value S decreases.

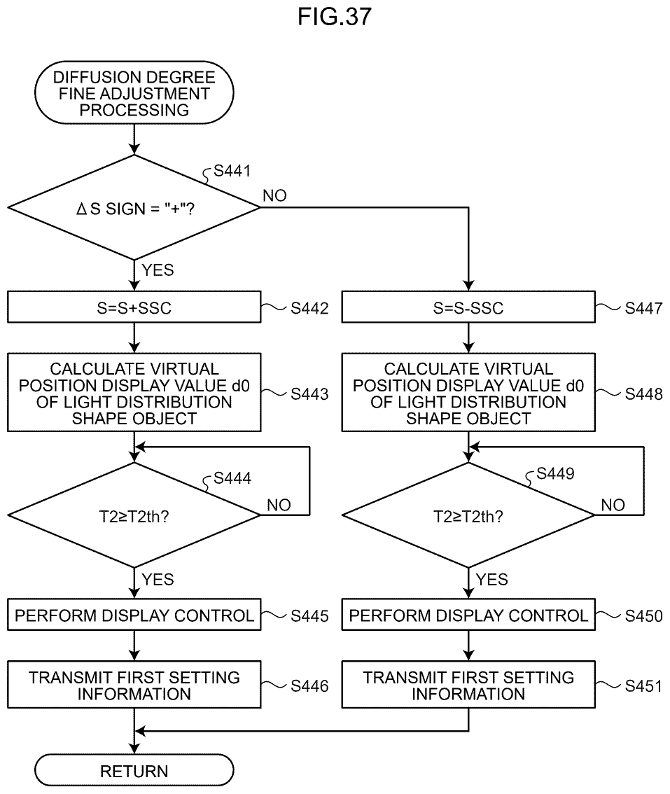

If the magnitude |ΔS| of the diffusion degree difference value ΔS becomes smaller than the magnitude |LSC| of the diffusion degree coarse adjustment scale setting value LSC (No at step S411), diffusion degree fine adjustment processing illustrated in FIG. 37 is executed. FIG. 37 is a flowchart illustrating an example of the diffusion degree fine adjustment processing by the control device 200a for the illumination device 1a according to the second embodiment.

The control device 200a reads the sign of the diffusion degree difference value ΔS and determines the adjustment direction of the diffusion degree display value S with respect to the target diffusion degree S′. Specifically, the control device 200a determines whether the sign of the diffusion degree difference value ΔS is “+(positive value)” (step S441).

If the sign of the diffusion degree difference value ΔS is “+(positive value)” (Yes at step S441), it is indicated that the adjustment direction of the diffusion degree display value S with respect to the target diffusion degree S′ is a direction in which the diffusion degree of the illumination device 1a increases. In this case, the control device 200a adds the diffusion degree fine adjustment scale setting value SSC (second adjustment interval) to the diffusion degree display value S (step S442), thereby updating the diffusion degree display value S. In addition, the control device 200a calculates the virtual position display value d0 of the light distribution shape object OBJ, which corresponds to the diffusion degree display value S (step S443), and stores the virtual position display value d0 in the first storage region of the storage circuit 223a illustrated in FIG. 17.

Subsequently, the control device 200a determines whether the count value T2 of the second timer has exceeded the predetermined setting value change time (second time threshold) T2th (for example, 0.5 (sec)) (step S444).

If the count value T2 of the second timer is smaller than the predetermined setting value change time T2th (T2<T2th; No at step S444), the processing at step S444 is repeatedly executed until the count value T2 of the second timer becomes equal to or larger than the predetermined setting value change time T2th (T2≥T2th; Yes at step S444). If the count value T2 of the second timer becomes equal to or larger than the predetermined setting value change time T2th (T2≥T2th; Yes at step S444), the display control circuit 231 of the control device 200a reflects the diffusion degree display value S and the virtual position display value d0 of the light distribution shape object OBJ, which are acquired in the above-described processing and stored in the first storage region of the storage circuit 223a, to display control on the illumination control application screen 400 (step S445). In addition, the transmission-reception circuit 225a of the control device 200a reads the diffusion degree display value S stored in the first storage region of the storage circuit 223a and transmits the read diffusion degree display value S as the first setting information (S1=S) to the illumination device 1a (step S446).

The transmission-reception circuit 111 of the illumination device 1a stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

Referring back to FIG. 35, the control device 200a determines whether the long tap state is continuous (step S410). If the long tap state is not continuous (No at step S410), in other words, if a user's finger has been released from the screen or if the touch detection position is out of the adjustment region TA, the process returns to the illumination control processing illustrated in FIG. 34, thereby transitioning to a standby state (step S101a). Accordingly, the current diffusion degree display value S is finalized with the current diffusion degree display value S being reflected in the control state of the diffusion degree of the illumination device 1a.

If the long tap state is continuous (Yes at step S410), the process returns to the processing at step S405. When the following conditions are satisfied: the long tap state is continuous (Yes at step S410), the magnitude |ΔS| of the diffusion degree difference value ΔS is smaller than the magnitude |LSC| of the diffusion degree coarse adjustment scale setting value LSC (No at step S411), and the sign of the diffusion degree difference value ΔS is “+(positive value)” (Yes at step S441 in FIG. 37), the processing at steps S405 to S410 including the above-described diffusion degree fine adjustment processing (step S440; FIG. 37) is repeatedly executed at intervals of the predetermined setting value change time (second time threshold) T2th. Accordingly, the diffusion degree display value S is finely adjusted in steps of the diffusion degree fine adjustment scale setting value SSC (second adjustment interval) in a direction in which the diffusion degree display value S increases.

Thereafter, if the magnitude |ΔS| of the diffusion degree difference value ΔS becomes smaller than the magnitude |SSC| of a diffusion degree fine adjustment scale setting value SSC (Yes at step S409) and the long tap state is canceled (No at step S410), the current diffusion degree display value S is finalized with the current diffusion degree display value S being reflected in the control state of the diffusion degree of the illumination device 1a in a state in which the touch position detection value d′0 in the adjustment region TA substantially matches the virtual position display value d0 of the light distribution shape object OBJ (d′0≈d0).

Referring back to FIG. 37, if the sign of the diffusion degree difference value ΔS is “− (negative value)” (No at step S441), it is indicated that the adjustment direction of the diffusion degree display value S with respect to the target diffusion degree S′ is a direction in which the diffusion degree of the illumination device 1a decreases. In this case, the control device 200a subtracts the diffusion degree fine adjustment scale setting value SSC (second adjustment interval) from the diffusion degree display value S (step S447), thereby updating the diffusion degree display value S. In addition, the control device 200a calculates the virtual position display value d0 of the light distribution shape object OBJ, which corresponds to the diffusion degree display value S (step S448), and stores the virtual position display value d0 in the first storage region of the storage circuit 223a illustrated in FIG. 17.

Subsequently, the control device 200a determines whether the count value T2 of the second timer has exceeded the predetermined setting value change time (second time threshold) T2th (for example, 0.5 (sec)) (step S449).

If the count value T2 of the second timer is smaller than the predetermined setting value change time T2th (T2<T2th; No at step S449), the processing at step S449 is repeatedly executed until the count value T2 of the second timer becomes equal to or larger than the predetermined setting value change time T2th (T2≥T2th; Yes at step S449). If the count value T2 of the second timer becomes equal to or larger than the predetermined setting value change time T2th (T2≥T2th; Yes at step S449), the display control circuit 231 of the control device 200a reflects the diffusion degree display value S and the virtual position display value d0 of the light distribution shape object OBJ, which are acquired in the above-described processing and stored in the first storage region of the storage circuit 223a, to display control on the illumination control application screen 400 (step S450). In addition, the transmission-reception circuit 225a of the control device 200a reads the diffusion degree display value S stored in the first storage region and transmits the read diffusion degree display value S as the first setting information (S1=S) to the illumination device 1a (step S451).

The transmission-reception circuit 111 of the illumination device 1a stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

Referring back to FIG. 35, the control device 200a determines whether the long tap state is continuous (step S410). If the long tap state is not continuous (No at step S410), in other words, if a user's finger has been released from the screen or if the touch detection position is out of the adjustment region TA, the process returns to the illumination control processing illustrated in FIG. 34, thereby transitioning to a standby state (step S101a). Accordingly, the current diffusion degree display value S is finalized with the current diffusion degree display value S being reflected in the control state of the diffusion degree of the illumination device 1a.

If the long tap state is continuous (Yes at step S410), the process returns to the processing at step S405. When the following conditions are satisfied: the long tap state is continuous (Yes at step S410), the magnitude |ΔS| of the diffusion degree difference value ΔS is smaller than the magnitude |LSC| of the diffusion degree coarse adjustment scale setting value LSC (No at step S411), and the sign of the diffusion degree difference value ΔS is “−(negative value)” (No at step S441 in FIG. 37), the processing at steps S405 to S410 including the above-described diffusion degree fine adjustment processing (step S440; FIG. 37) is repeatedly executed at intervals of the predetermined setting value change time (second time threshold) T2th. Accordingly, the diffusion degree display value S is finely adjusted in steps of the diffusion degree fine adjustment scale setting value SSC (second adjustment interval) in a direction in which the diffusion degree display value S decreases.

Thereafter, if the magnitude |ΔS| of the diffusion degree difference value ΔS becomes smaller than the magnitude |SSC| of the diffusion degree fine adjustment scale setting value SSC (Yes at step S409) and the long tap state is canceled (No at step S410), the current diffusion degree display value S is finalized with the current diffusion degree display value S being reflected in the control state of the diffusion degree of the illumination device 1a in a state in which the touch position detection value d′0 in the adjustment region TA matches or substantially matches the virtual position display value d0 of the light distribution shape object OBJ (d′0≈d0).

Through the above-described diffusion degree adjustment processing according to the second embodiment, the diffusion degree coarse adjustment processing (FIG. 36) of performing adjustment by a diffusion degree coarse adjustment scale (first adjustment interval) or the diffusion degree fine adjustment processing (FIG. 37) of performing adjustment by a diffusion degree fine adjustment scale (second adjustment interval) is executed in accordance with the touch detection position detected while the user maintains the long tap state in the adjustment region TA on the illumination control application screen 400A. Specifically, when the difference (diffusion degree difference value ΔS) between the target diffusion degree S′ and the diffusion degree display value S is equal to or larger than the diffusion degree coarse adjustment scale (first adjustment interval) (Yes at step S411 in FIG. 35), the diffusion degree coarse adjustment processing (FIG. 36) is executed. When the difference (diffusion degree difference value ΔS) between the target diffusion degree S′ and the diffusion degree display value S is smaller than the diffusion degree coarse adjustment scale (first adjustment interval) (No at step S411 in FIG. 35), the diffusion degree fine adjustment processing (FIG. 37) is executed. For example, when the difference (diffusion degree difference value ΔS) between the target diffusion degree S′ and the diffusion degree display value S becomes smaller than the diffusion degree coarse adjustment scale (first adjustment interval) through the diffusion degree coarse adjustment processing (FIG. 36) (No at step S411 in FIG. 35), the process seamlessly transitions to the diffusion degree fine adjustment processing (FIG. 37).

When the user performs a swipe operation while maintaining the long tap state in the adjustment region TA on an illumination control application screen 400A, the diffusion degree coarse adjustment processing (FIG. 36) and the diffusion degree fine adjustment processing (FIG. 37) seamlessly transition to each other. For example, when the difference (diffusion degree difference value ΔS) between the target diffusion degree S′ and the diffusion degree display value S becomes equal to or larger than the diffusion degree coarse adjustment scale (first adjustment interval) through a swipe operation after the diffusion degree fine adjustment processing (FIG. 37) is executed (Yes at step S411 in FIG. 35), the process seamlessly transitions to the diffusion degree coarse adjustment processing (FIG. 36). For example, when the difference (diffusion degree difference value ΔS) between the target diffusion degree S′ and the diffusion degree display value S becomes smaller than the diffusion degree coarse adjustment scale (first adjustment interval) through a swipe operation after the diffusion degree coarse adjustment processing (FIG. 36) is executed (No at step S411 in FIG. 35), the process seamlessly transitions to the diffusion degree fine adjustment processing (FIG. 37).

More specifically, when the magnitude |ΔS| of the diffusion degree difference value ΔS becomes equal to or larger than the magnitude |LSC| of the diffusion degree coarse adjustment scale setting value LSC (|ΔS| |LSC|; Yes at step S411 in FIG. 35), the diffusion degree display value S corresponding to the virtual position display value d0 of the light distribution shape object OBJ is coarsely adjusted in a direction in which the diffusion degree display value S approaches the target diffusion degree S′ corresponding to the touch position detection value d′0. When the magnitude |ΔS| of the diffusion degree difference value ΔS becomes smaller than the magnitude |LSC| of the diffusion degree coarse adjustment scale setting value LSC (|ΔS|<|LSC|; No at step S411 in FIG. 35), the diffusion degree display value S corresponding to the virtual position display value d0 of the light distribution shape object OBJ is finely adjusted in a direction in which the diffusion degree display value S approaches the target diffusion degree S′ corresponding to the touch position detection value d′0.

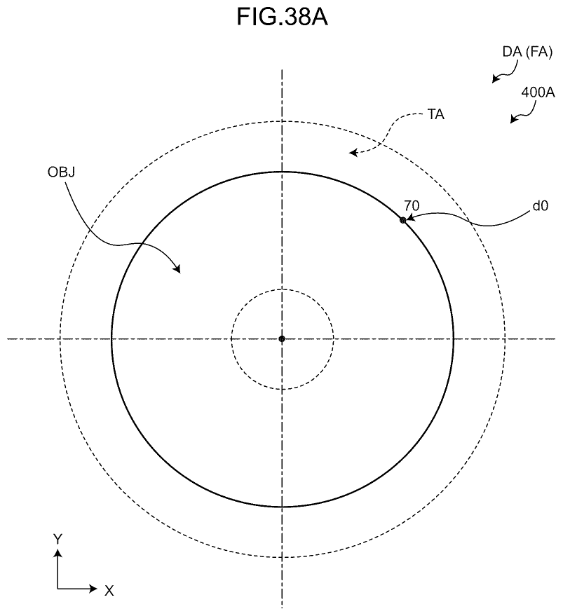

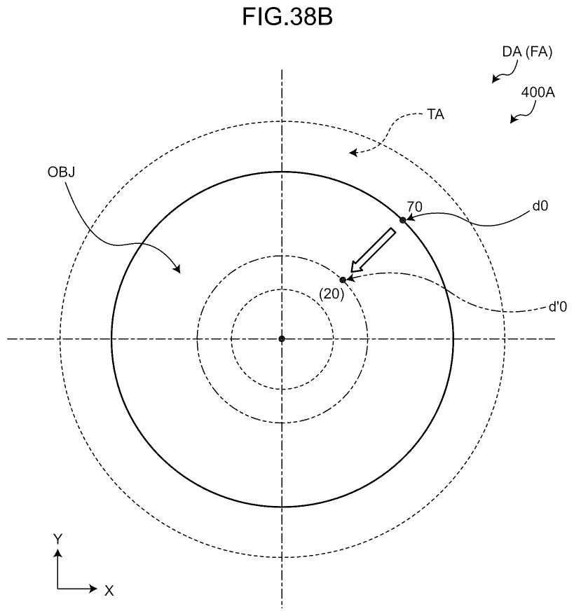

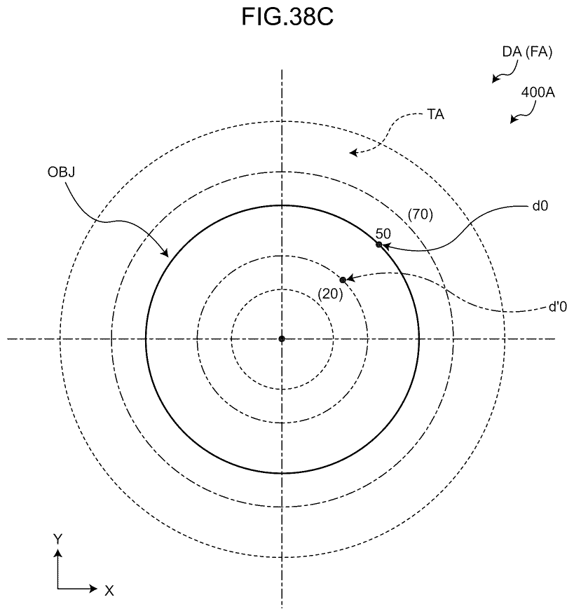

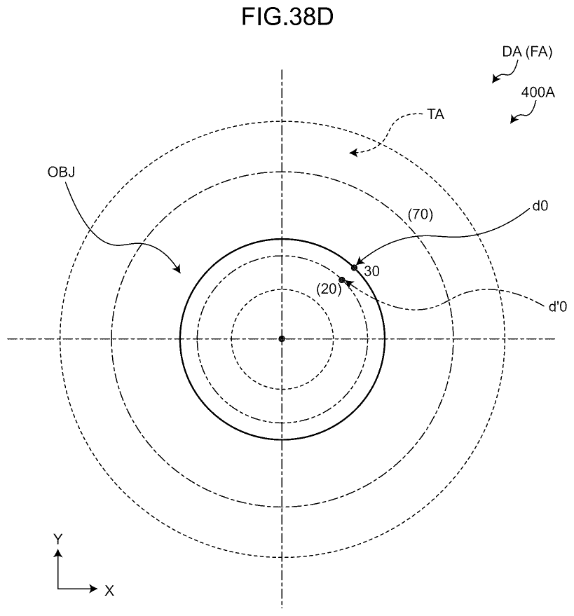

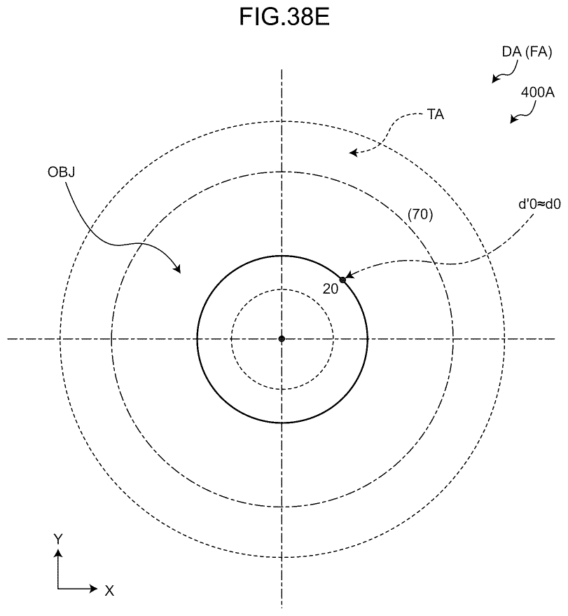

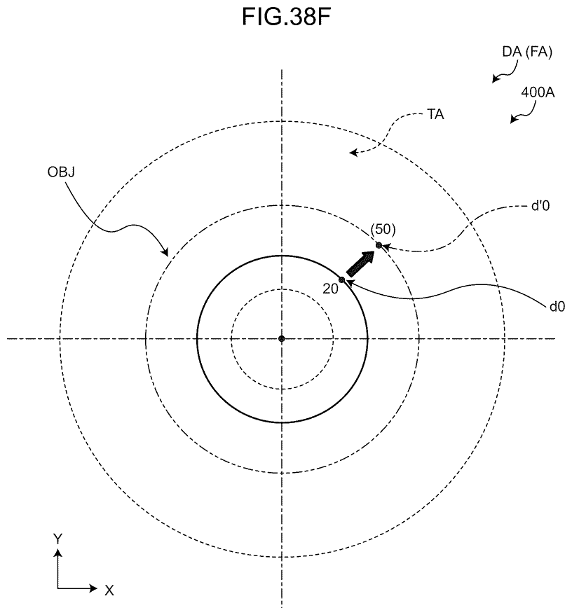

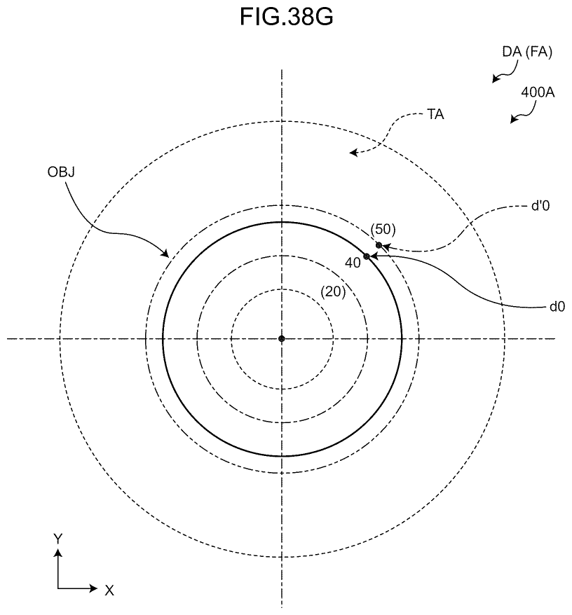

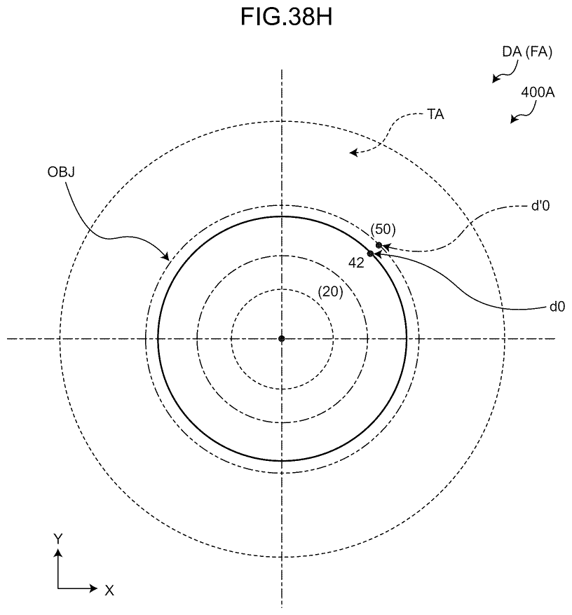

The following describes specific examples of operation on the illumination control application screen 400A of the control device 200a according to the second embodiment. FIGS. 38A, 38B, 38C, 38D, 38E, 38F, 38G, and 38H are diagrams illustrating specific operation examples on the illumination control application screen 400A of the control device 200a according to the second embodiment.

FIG. 38A illustrates an example in which the diffusion degree display value S is 70(%) in the standby state (step S101a) in FIG. 34. FIG. 38B illustrates an example in which in the standby state illustrated in FIG. 38A, a touch in the adjustment region TA is detected (Yes at step S102a in FIG. 34), transition is made to the diffusion degree adjustment processing illustrated in FIG. 35 and the long tap state is reached (step S404), and the touch position detection value d′0 corresponding to the target diffusion degree S′=20(%) is detected in the adjustment region TA. In this state, the diffusion degree difference value ΔS is −50(%) (ΔS=S′(=20)−S(=70(%))=−50(%)), the magnitude |ΔS(=−50(%))| of the diffusion degree difference value ΔS is equal to or larger than the magnitude |LSC(=20(%))| of the diffusion degree coarse adjustment scale setting value LSC (|ΔS|≥|LSC|; Yes at step S411 in FIG. 35), and the sign of the diffusion degree difference value ΔS(=−50(%)) is “− (negative value)” (No at step S421 in FIG. 36). Accordingly, the diffusion degree of the illumination device 1a is coarsely adjusted in a direction in which the diffusion degree decreases (arrow direction illustrated in FIG. 38B) until the magnitude |ΔS| of the diffusion degree difference value ΔS becomes smaller than the magnitude |LSC(=20(%))| of the diffusion degree coarse adjustment scale setting value LSC (No at step S411 in FIG. 35).

Specifically, first, in the first cycle of the processing at steps S405 to S410 in the diffusion degree adjustment processing illustrated in FIG. 35, the virtual position display value d0 of the light distribution shape object OBJ becomes a position corresponding to the diffusion degree display value S=50(%) as illustrated in FIG. 38C when the count value T2 of the second timer exceeds the predetermined setting value change time (second time threshold) T2th (for example, 0.5 (sec)) (Yes at step S429 in FIG. 36). In the processing of the second cycle, the virtual position display value d0 of the light distribution shape object OBJ becomes a position corresponding to the diffusion degree display value S=30(%) as illustrated in FIG. 38D.

Then, in the processing of the third cycle, if the diffusion degree difference value ΔS becomes −10(%) (ΔS=S′(=20(%))−S(=30(%))=−10(%)) and the magnitude |ΔS(=−10(%))| of the diffusion degree difference value ΔS becomes smaller than the magnitude |LSC(=20(%))| of the diffusion degree coarse adjustment scale setting value LSC (|ΔS|<|LSC|; No at step S411 in FIG. 35), the diffusion degree of the illumination device 1a is finely adjusted in a direction in which the diffusion degree decreases (arrow direction illustrated in FIG. 38B) until the magnitude |ΔS| of the diffusion degree difference value ΔS becomes smaller than the magnitude |SSC(=1(%))| of the diffusion degree fine adjustment scale setting value SSC (Yes at step S409 in FIG. 35) as illustrated in FIG. 38E. Accordingly, the touch position detection value d′0 corresponding to the target diffusion degree S′ and the virtual position display value d0 of the light distribution shape object OBJ become substantially the same (d′0≈d0).

FIG. 38F illustrates an example in which, thereafter, the user performs a swipe operation in the adjustment region TA while the long tap state is maintained (Yes at step S410 in FIG. 35). More specifically, FIG. 38F illustrates an example in which the touch position detection value d′0 in the adjustment region TA is updated through the swipe operation, the magnitude |ΔS| of the diffusion degree difference value ΔS becomes equal to or larger than the magnitude |LSC(=20(%))| of the diffusion degree coarse adjustment scale setting value LSC (|ΔS| |LSC|; Yes at step S411 in FIG. 35), and the touch position detection value d′0 corresponding to the target diffusion degree S′=50(%) is detected in the adjustment region TA (the swipe operation by the user has stopped at the touch position detection value d′0). In this state, the diffusion degree difference value ΔS is 30(%) (ΔS=S′(=50(%))−S(=20(%))=30(%)), the magnitude |ΔS(=30(%))| of the diffusion degree difference value ΔS is equal to or larger than the magnitude |LSC(=20(%))| of the diffusion degree coarse adjustment scale setting value LSC (|ΔS|≥|LSC|; Yes at step S411 in FIG. 35), and the sign of the diffusion degree difference value ΔS(=30(%)) is “+(positive value)” (Yes at step S421 in FIG. 36).

Accordingly, the diffusion degree of the illumination device 1a is coarsely adjusted in a direction in which the diffusion degree increases (arrow direction illustrated in FIG. 38F) until the magnitude |ΔS| of the diffusion degree difference value ΔS becomes smaller than the magnitude |LSC (=20(%))| of the diffusion degree coarse adjustment scale setting value LSC (No at step S411 in FIG. 35).

Specifically, first, in the first cycle of the processing at steps S405 to S410 in the diffusion degree adjustment processing illustrated in FIG. 35, the virtual position display value d0 of the light distribution shape object OBJ becomes a position corresponding to the diffusion degree display value S=40(%) as illustrated in FIG. 38G when the count value T2 of the second timer exceeds the predetermined setting value change time (second time threshold) T2th (for example, 0.5 (sec)) (Yes at step S424 in FIG. 36).

Then, in the processing of the second cycle, when the diffusion degree difference value ΔS becomes 10(%) (ΔS=S′(=50(%))−S(=40(%))=10(%)) and the magnitude |ΔS(=10(%))| of the diffusion degree difference value ΔS becomes smaller than the magnitude |LSC(=20(%))| of the diffusion degree coarse adjustment scale setting value LSC (|ΔS1<|LSC|; No at step S411 in FIG. 35), the diffusion degree of the illumination device 1a is finely adjusted in a direction in which the diffusion degree increases (arrow direction illustrated in FIG. 38F). FIG. 38H illustrates an example in which the user has released a finger from the screen at the point in time when the virtual position display value d0 of the light distribution shape object OBJ becomes a position corresponding to the diffusion degree display value S=42(%) before the virtual position display value d0 of the light distribution shape object OBJ becomes substantially the same as the touch position detection value d′0 corresponding to the target diffusion degree S′ (No at step S410 in FIG. 35). Accordingly, the current diffusion degree display value S=42(%) is finalized with the current diffusion degree display value S being reflected in the control state of the diffusion degree of the illumination device 1a.

If the long tap state is continuously maintained at the position (touch position detection value d′0) corresponding to the target diffusion degree S′=50(%) until the magnitude |ΔS| of the diffusion degree difference value ΔS becomes smaller than the magnitude |SSC(=1(%))| of the diffusion degree fine adjustment scale setting value SSC (Yes at step S409 in FIG. 35), the diffusion degree of the illumination device 1a is finely adjusted in a direction in which the diffusion degree increases (arrow direction illustrated in FIG. 38F) until the magnitude |ΔS| of the diffusion degree difference value ΔS becomes smaller than the magnitude SSC(=1(%))| of the diffusion degree fine adjustment scale setting value SSC (Yes at step S409 in FIG. 35). Accordingly, the touch position detection value d′0 corresponding to the target diffusion degree S′ (=50(%)) and the virtual position display value d0 of the light distribution shape object OBJ become the same or substantially the same (d′0≈d0). In this state, when the user has released a finger from the screen (No at step S410 in FIG. 35), the current diffusion degree display value S=50(%) is finalized with the current diffusion degree display value S being reflected in the control state of the diffusion degree of the illumination device 1a.

In the control device 200a for the illumination device 1a according to the second embodiment described above, the diffusion degree display value S is adjusted in steps of the diffusion degree coarse adjustment scale setting value LSC (first adjustment interval) when the diffusion degree difference value ΔS, which is the difference between the target diffusion degree S′ defined by the touch position detection value d′0 in the adjustment region TA and the diffusion degree display value S, is equal to or larger than the diffusion degree coarse adjustment scale setting value LSC (first adjustment interval). The diffusion degree display value S is adjusted in steps of the diffusion degree fine adjustment scale setting value SSC (second adjustment interval), which is smaller than the diffusion degree coarse adjustment scale setting value LSC (first adjustment interval), when the diffusion degree difference value ΔS is smaller than the diffusion degree coarse adjustment scale setting value LSC (first adjustment interval).

Detection of the touch position detection value d′0 for defining the target diffusion degree S′ is started when the continuation time T1 of a touch in the adjustment region TA has exceeded the predetermined long tap detection time (first time threshold) T1th. The diffusion degree display value S is adjusted at intervals of the predetermined setting value change time (second time threshold) T2th while the touch in the adjustment region TA is continuous.

Accordingly, for example, while adjustment is performed in steps of the diffusion degree fine adjustment scale (second adjustment interval) at intervals of the setting value change time (second time threshold) T2th, when the user releases a finger from the screen at a timing at which a desired diffusion degree display value S is obtained, the current diffusion degree display value S is finalized with the current diffusion degree display value S being reflected in the control state of the horizontal diffusion degree of the illumination device 1a. Thus, a desired diffusion degree display value S can be easily obtained, which facilitates fine adjustment of the diffusion degree display value S.

The preferable embodiments of the present disclosure are described above, but the present disclosure is not limited to the embodiments. Contents disclosed in the embodiments are merely exemplary and may be modified in various kinds of manners without departing from the scope of the present disclosure. For example, in a case where an illumination device of the present disclosure is capable of adjusting not only the light distribution shape but also brightness and light color, the configuration of the present disclosure may be used to coarsely and finely adjust the brightness and light color. Appropriate modifications made without departing from the scope of the present disclosure naturally belong to the technical scope of the present disclosure.

What is claimed is:

1. A control device for an illumination device, the control device being configured to control a plurality of illumination devices each capable of setting a light distribution shape of light emitted onto a virtual plane in two directions of a first direction and a second direction intersecting the first direction, by adjusting a diffusion degree of light emitted from a light source, the control device comprising:
a touch sensor having a detection region provided with a plurality of detection elements; and
a display panel provided with a display region that overlaps the detection region of the touch sensor in a plan view and configured to display, in the display region, an adjustment screen for a diffusion degree of each of the illumination devices, wherein
the adjustment screen is provided with an adjustment region for adjusting the diffusion degree of the illumination device,
when a difference between a target diffusion degree defined by a touch detection position in the adjustment region and a current diffusion degree of the illumination device is equal to or larger than a first adjustment interval, the diffusion degree of the illumination device is adjusted in steps of the first adjustment interval, and
when the difference between the target diffusion degree and the current diffusion degree of the illumination device is smaller than the first adjustment interval, the diffusion degree of the illumination device is adjusted in steps of a second adjustment interval smaller than the first adjustment interval.

2. The control device for an illumination device according to claim 1, wherein the adjustment screen is defined with an X direction corresponding to the first direction, a Y direction corresponding to the second direction, and an XY plane having an origin at a predetermined position on the adjustment screen and is provided with a light distribution shape object having a center point at the origin of the XY plane.

3. The control device for an illumination device according to claim 2, wherein the adjustment region includes
a first adjustment region that includes a region overlapping an X axis of the XY plane and with which the light distribution shape is adjustable in the X direction, and
a second adjustment region that includes a region overlapping a Y axis of the XY plane and with which the light distribution shape is adjustable in the Y direction.

4. The control device for an illumination device according to claim 3, wherein a position on the X axis corresponding to the current diffusion degree of the illumination device in the first direction, and a position on the Y axis corresponding to the current diffusion degree of the illumination device in the second direction are overlap an outline of the light distribution shape object, and the light distribution shape object changes into a circular or elliptical shape in accordance with a change in the current diffusion degree of the illumination device in the first direction and a change in the current diffusion degree of the illumination device in the second direction.

5. The control device for an illumination device according to claim 4, wherein
a target diffusion degree in the first direction is defined by a touch detection position in the first adjustment region,
a target diffusion degree in the second direction is defined by a touch detection position in the second adjustment region,
when a difference between the target diffusion degree in the first direction and the current diffusion degree of the illumination device in the first direction is equal to or larger than a first adjustment interval, the diffusion degree of the illumination device in the first direction is adjusted in steps of the first adjustment interval,
when the difference between the target diffusion degree in the first direction and the current diffusion degree of the illumination device in the first direction is smaller than the first adjustment interval, the diffusion degree of the illumination device in the first direction is adjusted in steps of a second adjustment interval smaller than the first adjustment interval,
when the difference between the target diffusion degree in the second direction and the current diffusion degree of the illumination device in the second direction is equal to or larger than a first adjustment interval, the diffusion degree of the illumination device in the second direction is adjusted in steps of the first adjustment interval, and
when the difference between the target diffusion degree in the second direction and the current diffusion degree of the illumination device in the second direction is smaller than the first adjustment interval, the diffusion degree of the illumination device in the second direction is adjusted in steps of a second adjustment interval smaller than the first adjustment interval.

6. The control device for an illumination device according to claim 5, wherein
when a continuation time of a touch in the first adjustment region exceeds a predetermined first time threshold, detection of a touch position in the X direction for defining the target diffusion degree in the first direction is started, and
when a continuation time of a touch in the second adjustment region exceeds the first time threshold, detection of a touch position in the Y direction for defining the target diffusion degree in the second direction is started.

7. The control device for an illumination device according to claim 6, wherein
when a touch in the first adjustment region is continuous, the diffusion degree of the illumination device in the first direction is adjusted at intervals of a predetermined second time threshold different from the first time threshold, and
when a touch in the second adjustment region is continuous, the diffusion degree of the illumination device in the second direction is adjusted at intervals of the second time threshold.

8. The control device for an illumination device according to claim 2, wherein the adjustment region is provided in a region of a figure including, on an outline, a position corresponding to a maximum diffusion degree of the illumination device.

9. The control device for an illumination device according to claim 8, wherein a position corresponding to a current diffusion degree of the illumination device overlaps an outline of the light distribution shape object, and the light distribution shape object scales up or down in accordance with a change in the current diffusion degree of the illumination device while maintaining an outer shape.

10. The control device for an illumination device according to claim 9, wherein when a continuation time of a touch in the adjustment region exceeds a predetermined first time threshold, detection of a touch position for defining the target diffusion degree is started.

11. The control device for an illumination device according to claim 10, wherein when a touch in the adjustment region is continuous, the diffusion degree of the illumination device is adjusted at intervals of a predetermined second time threshold different from the first time threshold.
